(19) United States
(12) Patent Application Publication
(10) Pub. No.: US 2026/0272611 A1
(43) Pub. Date: Sep. 17, 2026

(54) SYSTEMS AND METHODS FOR PRECISE MOVEMENT OF TEETH

(71) Applicant: Celebrace Inc., Colleyville, TX (US)

(72) Inventor: Mehdi Peikar, Colleyville, TX (US)

(73) Assignee: Celebrace Inc., Colleyville, TX (US)

(21) Appl. No.: 19/671,071

(22) Filed: May 7, 2026

Related U.S. Application Data
(63) Continuation-in-part of application No. 18/915,313, filed on Oct. 14, 2024.
(60) Provisional application No. 63/544,478, filed on Oct. 17, 2023.
(60) Provisional application No. 63/987,575, filed on Feb. 20, 2026.

(51) Int. Cl. A61C 7/14; A61C 7/20

(52) U.S. Cl. CPC A61C 7/146; A61C 7/20

(57) ABSTRACT

A system can include at least one bracket including a first surface and a second surface, the second surface having a shape matching an outer surface of the at least one tooth of the patient, where the at least one bracket is formed from a metallic material via additive manufacturing. The system can include a wire extending along a plane, the wire to directly couple to the at least one bracket along the first surface, where a portion of the wire in direct contact with the at least one bracket has a first thickness in a first direction along the plane. The system can include at least one treatment member coupled to and continuous with the wire and extending along the plane, where the wire and the at least one treatment member have a same thickness in a second direction perpendicular to the plane.

### CROSS-REFERENCE TO RELATED APPLICATIONS

This application claims the benefit and priority to U.S. Provisional Patent Application No. 63/987,575, filed Feb. 20, 2026, and is a continuation-in-part of U.S. patent application Ser. No. 18/915,313, filed Oct. 14, 2024, which claims the benefit of and priority to U.S. Provisional Patent Application No. 63/544,478, filed Oct. 17, 2023, which are incorporated herein by reference in their entirety.

### TECHNICAL FIELD

The present implementations relate generally to precise movement of teeth, specifically an orthodontic system to achieve precise movement of teeth.

### BACKGROUND

Some orthodontic systems offer limited customization of force, movement, and/or direction applied to individual teeth. For example, hooks, which can be used for teeth alignment, are typically manually added to a wire or brackets (e.g., on the teeth, etc.). This can limit force, movement, and/or direction orthodontists and dentists can apply to the teeth. In addition, some orthodontic systems may use standardized brackets and wires that are not customized to the individual anatomy of a patient's teeth, which can result in suboptimal force application and longer treatment times.

### SUMMARY

The systems and methods as described herein can allow for precise movement of teeth of a patient, such as transitioning teeth from an overjet treatment arch (OTA) to a final treatment arch (FTA). Each tooth of the patient can have an ideal position to achieve both functional and aesthetic purposes. For example, molars on an upper arch (e.g., top row of teeth, etc.) and molars on a lower arch (e.g., bottom row of teeth, etc.) should be aligned to balance pressure induced by biting and mitigate stress on individual teeth or a jaw of the patient. Teeth in a non-ideal position may be moved to the ideal position by the systems and methods of the present disclosure.

The precise movement of teeth can be achieved through an orthodontic system (e.g., system, etc.) of the systems and methods of the present disclosure. The orthodontic system can include a plurality of brackets, a wire, and a plurality of treatment members. The wire and the plurality of treatment members can be a monolithic apparatus. The wire and the plurality of treatment members may be located on a same plane, and can have a same thickness in a direction perpendicular to the plane. A location of the plurality of treatment members along the wire can be determined based on desired tooth movement within the teeth of the patient. A type of the plurality of treatment members can also be determined based on the desired tooth movement. The wire and the plurality of treatment members can be integrated into a monolithic apparatus to allow for precise teeth movement by applying specific force based on the respective teeth of the patient. The wire and the plurality of treatment members can also mitigate unnecessary tooth movement to reduce a risk of root resorption and shorten an orthodontic treatment time. Moreover, the brackets can be shaped such that a surface of the bracket in direct contact with teeth match an outer surface of the teeth, and can be formed from metallic material via additive manufacturing.

At least one aspect relates to a system. The system can include at least one bracket including a first surface and a second surface opposite the first surface. The second surface can be directly coupled to at least one tooth of a patient. The second surface can have a shape matching an outer surface of the at least one tooth of the patient. The at least one bracket can be formed from a metallic material via additive manufacturing. The system can include a wire extending along a plane. The wire can directly couple to the at least one bracket along the first surface. A portion of the wire in direct contact with the at least one bracket can have a first thickness in a first direction along the plane corresponding to a force applied by the wire onto the at least one tooth to align the at least one tooth with the wire. Other portions of the wire can have thicknesses different from the first thickness. The system can include at least one treatment member coupled to and continuous with the wire and extending along the plane. The wire and the at least one treatment member can have a same thickness in a second direction perpendicular to the plane.

In some implementations, the outer surface is at least one of a labial or lingual side of the at least one tooth. In some implementations, the wire is a first wire to couple to the at least one bracket coupled to at least one upper tooth on an upper row of teeth of the patient, the plane is a first plane, and the at least one treatment member is at least one first treatment member. In some implementations, the system can include a second wire extending along a second plane, the second wire to directly couple to the at least one bracket coupled to at least one lower tooth on a lower row of teeth of the patient. In some implementations, the system can include at least one second treatment member coupled to and continuous with the second wire and extending along the second plane. In some implementations, the second wire and the at least one second treatment member can have a same thickness in a third direction perpendicular to the second plane. In some implementations, the at least one first treatment member comprises at least one first tab extending from the first wire and the at least one second treatment member comprises at least two second tabs extending from the second wire.

In some implementations, the system can include a first indicator coupled to and extending from a first side of the first wire. In some implementations, the system can include a second indicator coupled to and extending from a second side of the second wire. In some implementations, the first side and the second side are aligned. In some implementations, the wire comprises a first end and a second end opposite the first end. In some implementations, the system can include an identifier removably coupled to the second end, the identifier extending along the plane and having a same thickness as the wire and the at least one treatment member in the second direction perpendicular to the plane.

In some implementations, the at least one bracket comprises a third surface contiguous with the first surface and the second surface. In some implementations, the third surface at least partially faces a distal surface of the at least one tooth and gingiva. In some implementations, the at least one bracket can include a label corresponding to the at least one tooth located on the third surface. In some implementations, the wire continues to extend along the plane prior to and after being coupled to the at least one bracket. In some implementations, the at least one bracket is a plurality of brackets and the at least one tooth is a plurality of teeth, the plurality of brackets to couple to at least a subset of the plurality of teeth. In some implementations, the wire includes a plurality of thicknesses in the first direction, each of the thicknesses corresponding to a respective force to align the at least the subset of the plurality of teeth with the wire. In some implementations, the wire and the at least one treatment member are a monolithic apparatus. In some implementations, the second surface defines a plurality of grooves.

At least one aspect relates to a system. The system can include a plurality of brackets each including a first surface and a second surface opposite the first surface. The second surface can be directly coupled to a respective tooth of a plurality of teeth of a patient. The second surface can have a shape matching an outer surface of the respective tooth of the patient. The plurality of brackets can be formed from a metallic material. The system can include a wire extending along a plane. The wire can directly couple to at least a subset of the plurality of brackets along the first surface. The wire can have a same thickness in a direction perpendicular to the plane. The wire can include a first thickness in a first direction along the plane at a first location corresponding to a first tooth of the plurality of teeth. The wire can include a second thickness in the direction along the plane at a second location corresponding to a second tooth of the plurality of teeth. The first thickness can correspond to a first force to align the first tooth with the wire. The second thickness can correspond to a second force to align the second tooth with the wire. The first thickness and the second thickness can be different.

In some implementations, the system can include at least one treatment member coupled to and continuous with the wire and extending along the plane. In some implementations, the wire and the at least one treatment member can have the same thickness in a second direction perpendicular to the plane. In some implementations, the wire comprises a first end and a second end opposite the first end. In some implementations, the system can include an identifier removably coupled to the second end, the identifier extending along the plane and having a same thickness as the wire and the at least one treatment member in the second direction perpendicular to the plane. In some implementations, the plurality of brackets are formed via additive manufacturing and the outer surface is at least one of a labial or lingual side of the respective tooth. In some implementations, the wire continues to extend along the plane prior to and after being coupled to the at least the subset of the plurality of brackets. In some implementations, the second surface defines a plurality of grooves. In some implementations, each of the plurality of brackets comprises a third surface contiguous with the first surface and the second surface. In some implementations, the third surface at least partially faces a distal surface of the respective tooth and gingiva. In some implementations, each of the plurality of brackets can include a label corresponding to the respective tooth located on the third surface.

At least one aspect is related to a method. The method can include depositing, using a three-dimensional printer, a metallic material to form a structure. The structure can include a base having a first surface and a second surface opposite the first surface. The structure can include a bracket removably coupled to the second surface. The bracket can have a first surface and a second surface opposite the first surface. The second surface can have a shape that matches an outer surface of a respective tooth of a patient. The method can include polishing the structure. The method can include removing the bracket from the structure.

In some implementations, the base has a first end and a second end opposite the first end. In some implementations, the structure can include a first indicator located on the first end indicating a row and side of teeth the plurality of brackets are to couple to. In some implementations, the structure can include a second indicator located on the second end indicating the patient. In some implementations, the structure comprises a plurality of structures. In some implementations, the method can include polishing the plurality of structures after bending the plurality of structures.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

These and other aspects and features of the present implementations will become apparent to those ordinarily skilled in the art upon review of the following description of specific implementations in conjunction with the accompanying figures, wherein:

FIG. 1 is a schematic diagram of an example system, in accordance with some implementations of the present disclosure.

FIG. 2 is a top view of an example wire, in accordance with some implementations of the present disclosure.

FIG. 3 is a perspective view of the wire of FIG. 2, in accordance with some implementations of the present disclosure.

FIG. 4 is a top view of an example wire, in accordance with some implementations of the present disclosure.

FIG. 5 is a perspective view of the wire of FIG. 4, in accordance with some implementations of the present disclosure.

FIG. 6 is a top view of an example wire, in accordance with some implementations of the present disclosure.

FIG. 7 is a perspective view of the wire of FIG. 6, in accordance with some implementations of the present disclosure.

FIG. 8 is a top view of an example wire, in accordance with some implementations of the present disclosure.

FIG. 9 is a perspective view of the wire of FIG. 8, in accordance with some implementations of the present disclosure.

FIG. 10 is a top view of an example wire, in accordance with some implementations of the present disclosure.

FIG. 11 is a perspective view of the wire of FIG. 10, in accordance with some implementations of the present disclosure.

FIG. 12 is a top view of an example wire, in accordance with some implementations of the present disclosure.

FIG. 13 is a top view of the wire of FIG. 12 including a plurality of rings, in accordance with some implementations of the present disclosure.

FIG. 14 is a closeup view of the wire of FIG. 12, in accordance with some implementations of the present disclosure.

FIG. 15 is a top view of an example wire, in accordance with some implementations of the present disclosure.

FIG. 16 is a top view of example wire expansions, in accordance with some implementations of the present disclosure.

FIG. 17 is a side view of an example bracket, in accordance with some implementations of the present disclosure.

FIG. 18 is a perspective view of the bracket of FIG. 17, in accordance with some implementations of the present disclosure.

FIG. 19 is a top view of example wires, in accordance with some implementations of the present disclosure.

FIG. 20 is a top view of example wires, in accordance with some implementations of the present disclosure.

FIG. 21 is a top view of example wires, in accordance with some implementations of the present disclosure.

FIG. 22 is a top view of example wires, in accordance with some implementations of the present disclosure.

FIG. 23 is a top view of example wires where a first wire defines a cavity, in accordance with some implementations of the present disclosure.

FIG. 24 is a top view of example wires where a first wire defines a cavity, in accordance with some implementations of the present disclosure.

FIG. 25 is a top view of example wires where a first wire defines a cavity, in accordance with some implementations of the present disclosure.

FIG. 26 is a top view of example wires where a first wire defines a cavity, in accordance with some implementations of the present disclosure.

FIG. 27 is a top view of example wires, in accordance with some implementations of the present disclosure.

FIG. 28 is a top view of example wires, in accordance with some implementations of the present disclosure.

FIG. 29 is a top view of an example wire including a treatment member, in accordance with some implementations of the present disclosure.

FIG. 30 is a close-up view of the wire including a treatment member of FIG. 29, in accordance with some implementations of the present disclosure.

FIG. 31 is a top view of an example wire including a plurality of treatment members, in accordance with some implementations of the present disclosure.

FIG. 32 is a top view of an example wire including a plurality of treatment members, in accordance with some implementations of the present disclosure.

FIG. 33 is a top view of example wires, in accordance with some implementations of the present disclosure.

FIG. 34 is a top view of example wires, in accordance with some implementations of the present disclosure.

FIG. 35 is a top view of example wires, in accordance with some implementations of the present disclosure.

FIG. 36 is a top view of an example wire including a treatment member, in accordance with some implementations of the present disclosure.

FIG. 37 is a top view of an example wire including a plurality of treatment members, in accordance with some implementations of the present disclosure.

FIG. 38 is a top view of an example wire, in accordance with some implementations of the present disclosure.

FIG. 39 is a top view of example wires, in accordance with some implementations of the present disclosure.

FIG. 40 is a top view of an example wire including a plurality of treatment members, in accordance with some implementations of the present disclosure.

FIG. 41 is a close-up view of the example wire of FIG. 40, in accordance with some implementations of the present disclosure.

FIG. 42 is a front view of example brackets, in accordance with some implementations of the present disclosure.

FIG. 43 is an example method, in accordance with some implementations of the present disclosure.

FIG. 44 is a top view of an example wire with a plurality of treatment members, in accordance with some implementations of the present disclosure.

FIG. 45 is a top view of an example wire with a plurality of treatment members, in accordance with some implementations of the present disclosure.

FIG. 46 is a top view of an example wire with a plurality of treatment members, in accordance with some implementations of the present disclosure.

FIG. 47 is a top view of an example first wire with a plurality of treatment members, in accordance with some implementations of the present disclosure.

FIG. 48 is a top view of an example second wire with a plurality of treatment members, in accordance with some implementations of the present disclosure.

FIG. 49 is a top view of an example bracket on a tooth, in accordance with some implementations of the present disclosure.

FIG. 50 is a perspective view of a plurality of example brackets on a plurality of teeth, in accordance with some implementations of the present disclosure.

FIG. 51 is a schematic of example torques and tips along with a plurality of example brackets on a plurality of teeth, in accordance with some implementations of the present disclosure.

FIG. 52 is a comparison of example brackets compared to other brackets positioning applying force, in accordance with some implementations of the present disclosure.

FIG. 53 is a top view of positioning of example brackets, in accordance with some implementations of the present disclosure.

FIG. 54 is a perspective view of a plurality of example brackets coupled to a plurality of teeth, in accordance with some implementations of the present disclosure.

FIG. 55 is a top view of a plurality of example brackets coupled to a plurality of teeth, in accordance with some implementations of the present disclosure.

FIG. 56 is a close-up view of a plurality of example brackets coupled to a plurality of teeth, in accordance with some implementations of the present disclosure.

FIG. 57 is a perspective view of a plurality of example brackets coupled to a plurality of teeth, in accordance with some implementations of the present disclosure.

FIG. 58 is a back view of a plurality of example brackets, in accordance with some implementations of the present disclosure.

FIG. 59 is a cross-sectional view of an example bracket, in accordance with some implementations of the present disclosure.

FIG. 60 is a perspective view of an example bracket, in accordance with some implementations of the present disclosure.

FIG. 61 is a perspective view of an example bracket, in accordance with some implementations of the present disclosure.

FIG. 62 is a perspective view of an example bracket, in accordance with some implementations of the present disclosure.

FIG. 63 is a perspective view of an example bracket, in accordance with some implementations of the present disclosure.

FIG. 64 is a perspective view of an example bracket, in accordance with some implementations of the present disclosure.

FIG. 65 is a perspective view of an example system, in accordance with some implementations of the present disclosure.

FIG. 66 is a top view of an example wire, in accordance with some implementations of the present disclosure.

FIG. 67 is a top view of an example connector, in accordance with some implementations of the present disclosure.

FIG. 68 is a top view of an example connector and example bonding tray, in accordance with some implementations of the present disclosure.

FIG. 69 is a top view of an example system including bite blocks, in accordance with some implementations of the present disclosure.

FIG. 70 is a perspective view of an example system including bite blocks, in accordance with some implementations of the present disclosure.

FIG. 71 is a top view of an example system including an expander, in accordance with some implementations of the present disclosure.

FIG. 72 is a flow diagram of an example method for forming and coupling an example system onto a plurality of teeth, in accordance with some implementations of the present disclosure.

FIG. 73 is a perspective view of an example structure for manufacturing example brackets, in accordance with some implementations of the present disclosure.

FIG. 74 is a side view of an example structure for manufacturing example brackets, in accordance with some implementations of the present disclosure.

FIG. 75 is a side view of an example structure for manufacturing example brackets, in accordance with some implementations of the present disclosure.

FIG. 76 is a side view of an example structure for manufacturing example brackets, in accordance with some implementations of the present disclosure.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations will be described, and detailed descriptions of other portions of such known components will be omitted so as not to obscure the present implementations. Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

Orthodontic systems can include brackets, wires, and other components to align teeth of a patient. The brackets can be coupled to teeth of the patient. The wires can extend along an arch and couple to the brackets. The wires can apply force to the teeth through the brackets to move the teeth toward a desired alignment. Some orthodontic systems can include brackets that have a standardized shape and size. The brackets can be coupled to teeth regardless of variations in tooth geometry among different patients. In addition, such systems can exhibit limitations in precision and efficiency of tooth movement. The standardized brackets may not conform to individual tooth surfaces, which can result in inconsistent force application across different teeth. The wires in such systems can have uniform dimensions along a length, which can limit the ability to apply tooth-specific forces. The uniform wire dimensions can mitigate customized force application to individual teeth based on the desired movement for each tooth, thereby leading to potentially longer treatment times and suboptimal alignment outcomes.

The systems and methods of the present disclosure address such technical challenges, among others, by providing an orthodontic system in which brackets and wires are customized based on data corresponding to a patient. The system can include brackets with surfaces shaped to match outer surfaces of specific teeth of the patient. The system can include wires with varying thicknesses along a plane that the wire extends along to apply different forces to different teeth. The brackets and wires can be formed using additive manufacturing processes based on the data corresponding to the patient. The wire can directly couple to the bracket and the system can include treatment members that are coupled to and continuous with the wire. The treatment members and the wire can be a monolithic apparatus, and can extend along a plane. Thicknesses of the wire and the treatment members can differ in a direction along the plane, and a thickness of the wire and the treatment members in a direction perpendicular to the plane can be the same. The wire and the treatment members can remain extending along the plane before and after coupling to the bracket.

Consequently, the systems and methods of the present disclosure can provide improved precision in orthodontic treatment compared to other systems. The bracket with a surface shaped to match the outer surface of the tooth can provide consistent contact and maintain the contact between the bracket and the tooth. The consistent contact can result in more predictable force transfer from the wire to the tooth. The wire with varying thicknesses can apply different forces to different teeth based on the desired movement for each tooth. The varying thicknesses can allow for customized force application without different wire sizes or manual adjustments during treatment. The formation of the bracket and wire using additive manufacturing based on patient-specific data can reduce treatment time compared to systems with standardized components. The customized components can provide more efficient tooth movement and can reduce repositioning or replacing components during treatment.

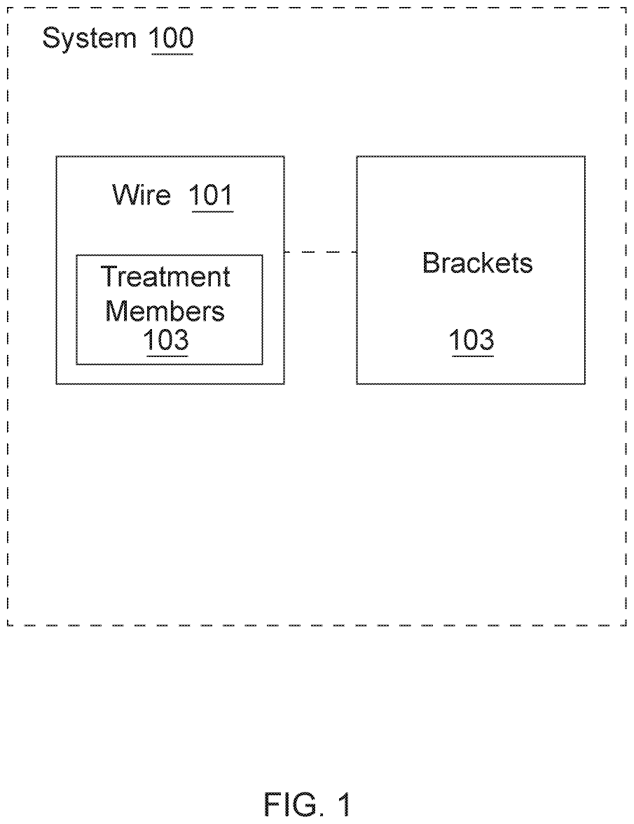

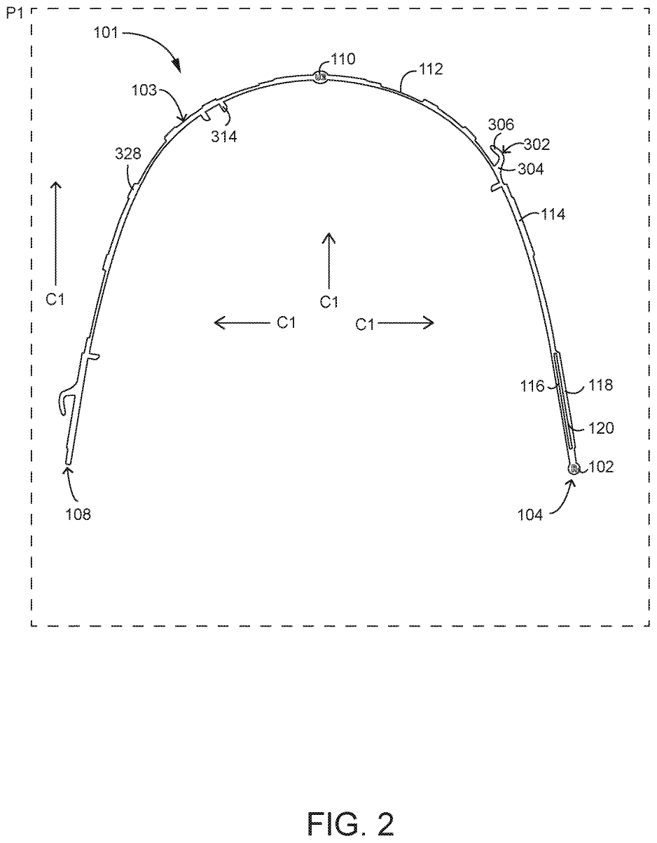

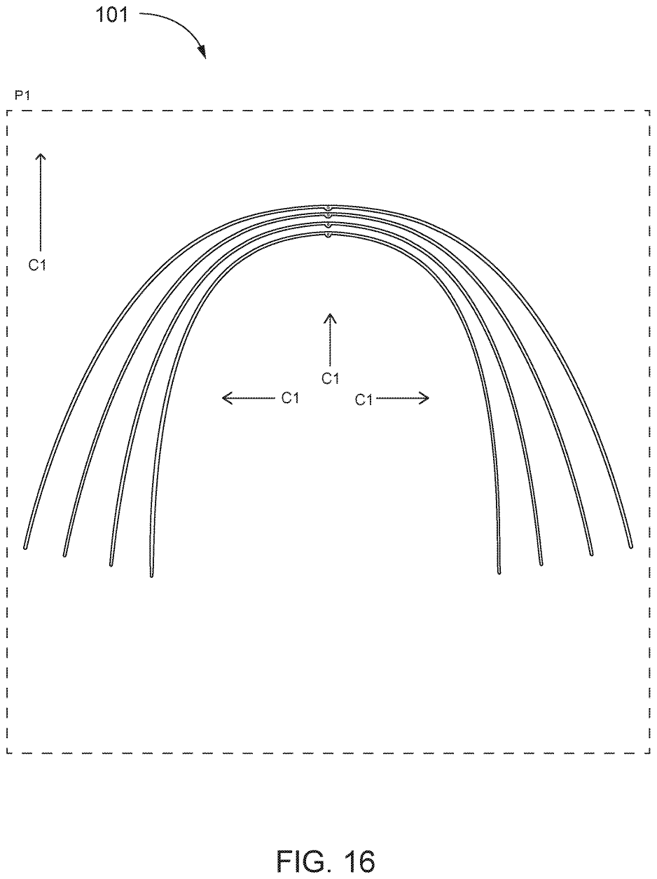

FIG. 1 shows a system 100. The system 100 includes a wire 101. The wire 101 can be configured to align with a plurality of teeth of a patient. The wire 101 can be placed on an upper arch (e.g., upper dental arch, maxillary arch, top row of teeth, etc.) or lower arch (e.g., lower dental arch, mandibular arch, bottom row of teeth, etc.) of the patient. The dental arch can refer to a U-shaped arrangement along the upper and lower jaws where the plurality of teeth are aligned along the dental arch. As shown in FIG. 16, the wire 101 can be expanded (e.g., stretched, bent, etc.) to align with the plurality of teeth. For example, a width of the plurality of teeth may be different for various patients. To accommodate variations in the width, the wire 101 can be expanded. The wire 101 can have different diameters and dimensions dependent on the plurality of teeth. For example, the wire 101 can have a circular and/or a rectangular cross section. The diameter of the wire 101 as well as the thickness and/or the width of the wire 101 can vary along a length of the wire 101. A greater thickness of the wire 101 can correspond to a greater force imparted on the plurality of teeth. The wire 101 can be arch-shaped as seen in, for example, FIG. 2. In some implementations, the wire 101 extends at least partially along an arch. The wire 101 can include a material. The material can be a flexible material. The material can be a flexible, metallic material. The material can be nickel titanium (NiTi). The material can also be stainless steel. The material can be a shape memory alloy.

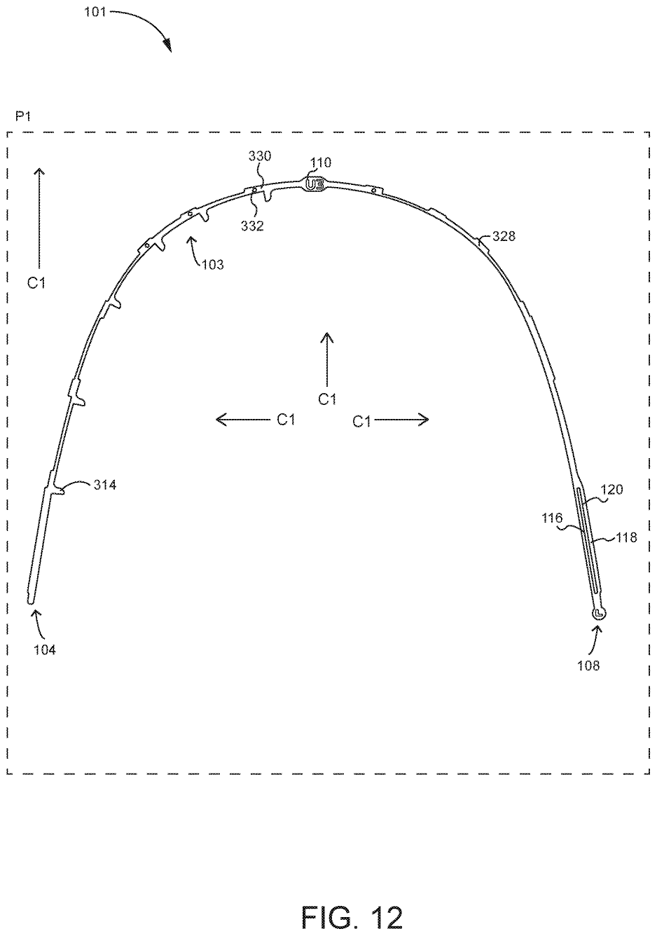

Referring now to FIGS. 2-15, the wire 101 can include a plurality of identifiers (e.g., labels, indicators, etc.). The plurality of identifiers can assist, for example, an orthodontist in inserting the wire 101 into a mouth of the patient. For example, the plurality of identifiers can identify the wire 101 as being for the upper arch or the lower arch. The wire 101 can include, as shown in FIGS. 2 and 12, a first identifier 102. The first identifier 102 can be located at a first end 104 of the wire 101. The first end 104 can correspond to a right hand side of the plurality of teeth of the patient. The right hand side of the plurality of teeth can be the right hand side of the patient. For example, the first identifier 102 can correspond to a molar of the plurality of teeth on the right hand side of the patient. The wire can also include a second identifier 106. The second identifier 106 can be located at a second end 108 of the wire 101. The second end 108 can correspond to a left hand side of the plurality of teeth of the patient. For example, the second identifier 106 can correspond to a molar of the plurality of teeth on the left hand side of the patient. The wire 101 can also include a third identifier 110. The third identifier 110 can be located at a midpoint on the wire 101 between the first end 104 and the second end 108. The third identifier 110 can correspond to a center (e.g., midline, etc.) of the plurality of teeth of the patient. The midline of the plurality of teeth can be an imaginary vertical line that passes through the central incisors (e.g., two upper, front teeth, etc.). For example, the third identifier 110 can be located between central incisors of the plurality of teeth. The third identifier 110 can be used to identify whether the wire 101 corresponds to the upper or lower arch of the patient. The third identifier 110 can also include a number.

The wire 101 can have various thicknesses (e.g., dimensions, etc.) in one or more directions C1 (e.g., first direction, etc.) extending along the plane. The direction C1 can point towards and extend along any direction along the plane, such as the first plane P1. For example, the wire 101 can have a first thickness at a first location 112 (e.g., point, portion, etc.) and a second thickness at a second location 114. The first thickness and the second thickness can be different. A thickness of the wire 101 can determine an amount of torque (e.g., force, etc.) applied to the plurality of teeth (e.g., to rotate and/or move the teeth, etc.). The thickness of the wire 101 can also determine an amount of force and moment applied to the plurality of teeth (e.g., to move the teeth, etc.). The applied force can cause the plurality of teeth to align with each other and the wire 101. For example, the first thickness can be greater than the second thickness. In this case, the force applied at the first location 112 is greater than the second location 114. As a result, over time, movement and/or rotation of the tooth at the first location 112 can be greater than movement and/or rotation of the tooth at the second location 114. The thickness of the wire 101 can control movement and alignment of the plurality of teeth. The thickness of the wire 101 can vary (e.g., be different, etc.) between any two adjacent teeth or groups of teeth (e.g., three or more teeth, etc.). The wire 101 can have a same (e.g., uniform, etc.) thickness in a direction D2 (e.g., second thickness, etc.) perpendicular to the plane.

In some implementations, the thickness of the wire 101 corresponds to a force that the wire 101 applies onto teeth once the wire 101 is coupled to the teeth. For example, as the thickness of the wire increases, a force the wire 101 applies can increase as well. The wire 101 can align the teeth with adjacent teeth, with the wire 101, or with an arch corresponding to or aligned with a jaw. Consequently, the wire 101 can have different thicknesses corresponding to different forces to align the teeth with each other and the wire 101.

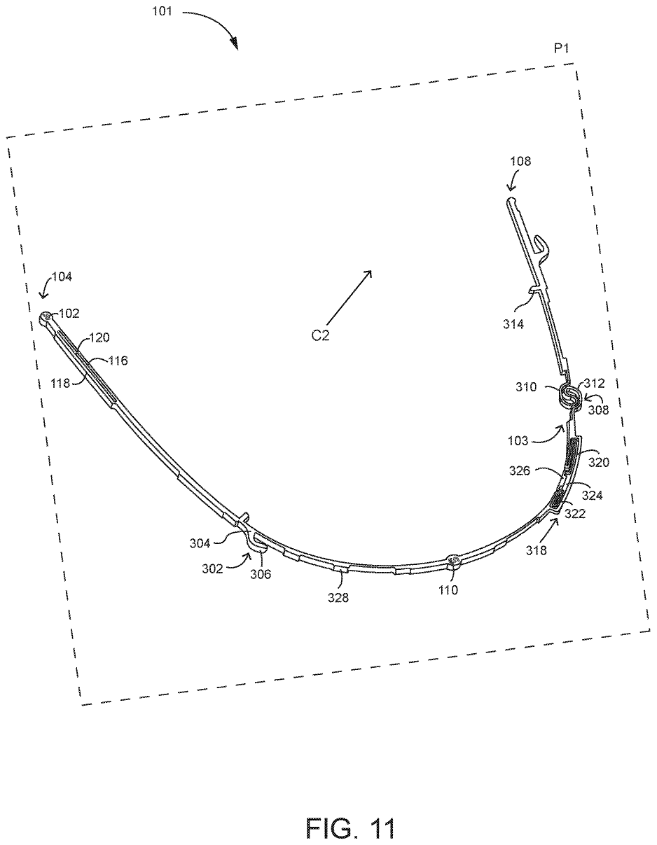

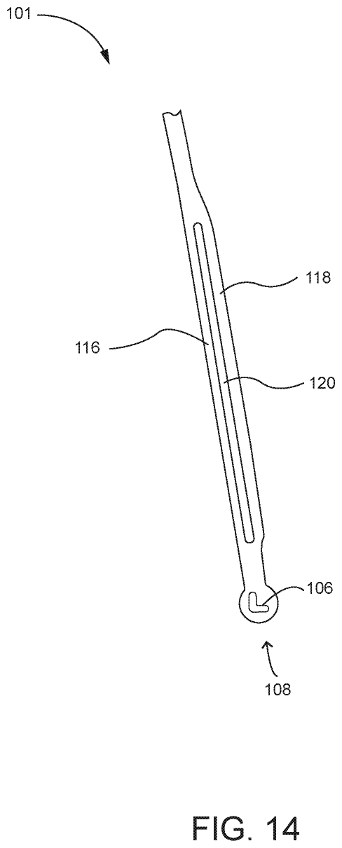

In some implementations, the wire 101 includes a plurality of bars (e.g., segments, etc.) as seen in FIG. 14, for example. The wire 101 can include a first bar 116 and a second bar 118. The first bar 116 and the second bar 118 can increase a thickness of the wire 101 to impart a greater, for example, force to the plurality of teeth. The second bar 118 can be parallel to the first bar 116. The wire 101 can also include an aperture 120 located between the first bar 116 and the second bar 118. The first bar 116 and the second bar 118 can be continuous (e.g., integrated, etc.) with the wire 101. The first bar 116 and the second bar 118 can be located closer to the second identifier 106 than the third identifier 110 as seen in, for example, FIG. 11. The first bar 116 and the second bar 118 can be used to align teeth. For example, the second bar 118 can extend to a misaligned tooth while the first bar 116 stabilizes the wire 101 to ensure that an extension of the second bar 118 does not move the wire 101.

Referring further to FIG. 1, the wire 101 and/or the system 100 can include a plurality of treatment members 103 (e.g., orthodontic accessories, attachments, etc.) as described further herein. The plurality of treatment members 103 can extend from and/or be continuous with the wire 101. The plurality of treatment members 103 can be configured to align the plurality of teeth with the wire 101. The wire 101 can be located on or extend along a plane P1. The wire 101 can be formed from a sheet material defined by two parallel planes. In some implementations, the treatment members 103 are coupled to and continuous with the wire 101 and in other implementations, the treatment members 103 are integral with the wire 101. For example, the treatment members 103 can be formed along with the wire 101. The treatment members 103 can include one or more force-application members, force-limiting or stabilizing members, or instructional or placement indicators or members, among others.

The plurality of treatment members 103 can also be located on the plane P1. The plane P1 can be an imaginary plane. The plurality of treatment members 103 can be configured to align the plurality of teeth with the wire 101, the dental arch, and/or each other. The plurality of treatment members 103 can be continuous (e.g., seamless, etc.) with the wire 101. The plurality of treatment members 103 can extend from the wire 101 on the plane P1. The wire 101 and the plurality of treatment members 103 can be a monolithic apparatus (e.g., integrated, unitary structure, etc.). The monolithic apparatus can be formed from a single sheet of the material, where the sheet is defined by two planes and a thickness in the z-direction, the thickness being the distance between the two planes P1. For example, the wire 101 and the plurality of treatment members 103 can be laser cut, water jet cut, stamped, or electric discharge machined from the single sheet. In various implementations, the wire 101 and the plurality of treatment members 103 can also be formed from investment casting, additive manufacturing (3D printing), or shape forming, among others. For example, the wire 101 and the treatment members 103 can be formed by 3D printing a material, such as a metallic material. The treatment members 103 can be formed from a same material as the wire 101. In some implementations, the wire 101 and the treatment members 103 are formed from different materials, such as a first metallic material like stainless steel and a second metallic material like a shape memory alloy. The wire 101 being a monolithic apparatus with the treatment members 103 allows for elimination of solder and welded joints, reduces sharp edges, mitigates detachment, and facilitates manufacturing efficiency and reproducibility.

The wire 101 and the treatment members 103 may have the same thickness in the z-direction (e.g., second direction, C2, etc.). For example, the wire 101 and the treatment members 103 are formed from a sheet having a uniform thickness (e.g., dimension, height, etc.) in the z-direction, and may have different thicknesses (e.g., dimension, width, etc.) extending along a plane P1 (defined by the x-y directions) (e.g., first direction C1, etc.). The thickness in the z-direction is perpendicular to the plane P1 defined in the x-y directions. For example, the wire 101 and the treatment members 103 can have different thickness in the first direction C1 corresponding to a direction along the plane P1, and can have a same thickness in the second direction C2 corresponding to the z-direction perpendicular to the plane P1. A first surface of the monolithic apparatus can lie on a first plane and an opposite second surface of the monolithic apparatus can lie on a second plane, parallel to the first plane. The thickness in the z-direction is a distance between the first plane and the second plane. Either the first or second plane can be referred to as the plane P1. In some implementations, the system 100 includes the treatment members 103, and the treatment members 103 are coupled to and otherwise continuous with the wire 101. The treatment members 103 can extend from portions of the wire 101.

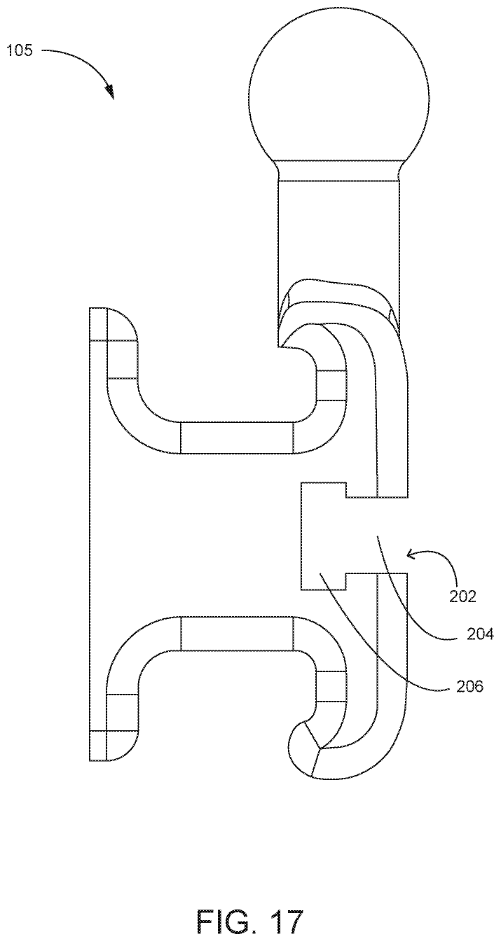

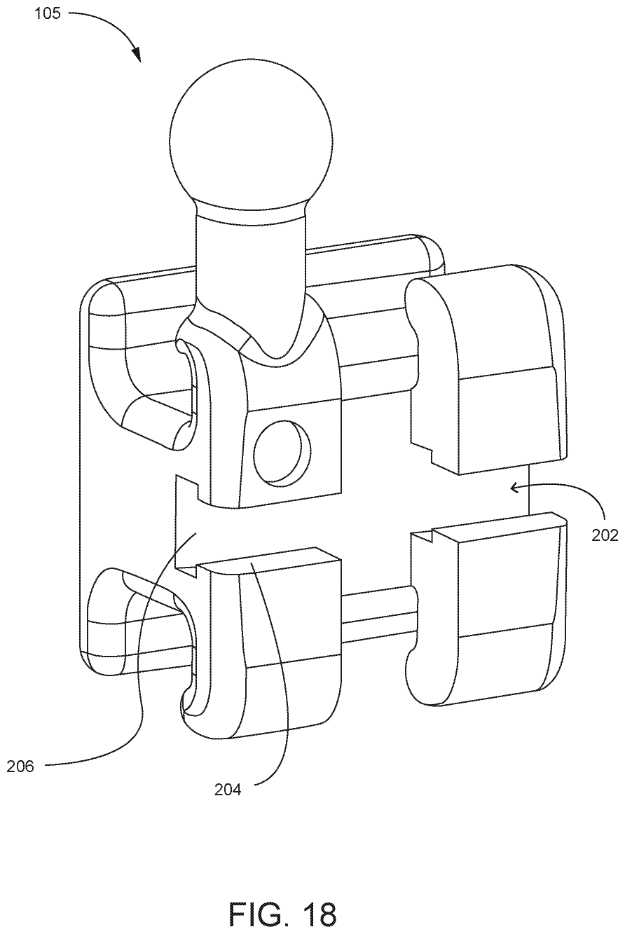

The system 100 can further include at least one bracket 105, seen in FIGS. 17-18. In some implementations, the system 100 includes a plurality of brackets 105. The plurality of brackets 105 can be located on the plurality of teeth (e.g., teeth 4902, etc.). Each of the plurality of brackets 105 can be located on a respective one of the plurality of teeth. In some implementations, each of the brackets 105 are located on a subset of the teeth. The plurality of brackets 105 can be coupled to the plurality of teeth. The plurality of brackets 105 can be coupled to the plurality of teeth via an adhesive. The wire 101 can be coupled to the plurality of brackets 105. In some implementations, at least one of the plurality of treatment members 103 can be coupled to at least one of the plurality of brackets 105. The wire 101 can be configured to align with and be coupled to the plurality of brackets 105. For example, the wire 101 can be expanded to align with the plurality of brackets 105.

The wire 101 can be directly coupled to the brackets 105. For example, the wire 101 can include a plurality of portions, and a subset of the portions can be directly in contact with and coupled to the brackets 105. In some implementations, the wire 101 continues to extend along the plane P1 prior to and following coupling to the brackets 105. For example, the wire 101 remains entirely extending along the plane P1 prior to being coupled to the brackets 105, and following being directly coupled to the brackets 105. The wire 101 can be bent out of the plane P1 following coupling to the brackets 105. In some implementations, a subset of portions of the wire 101 includes, is continuous with, or is otherwise in direct contact with at least one treatment member 103 and a subset of portions of the wire 101 does not include a treatment member 103. In some implementations, the subset of portions of the wire 101 without the treatment members 103 are in direct contact with the brackets 105 and in other implementations, at least a portion of the treatment member 103 is in direct contact with the brackets 105.

In some implementations, the brackets 105 couple to at least a subset of the plurality of teeth. The wire 101 can have a plurality of thicknesses in the first direction (e.g., along the plane P1, C1, etc.). Each of the thicknesses can correspond to a respective force to align the at least the subset of the teeth that the brackets 105 are coupled to with the wire 101 and each other (e.g., adjacent teeth, etc.). For example, the wire 101 while coupled to the brackets 105 can align the teeth with each other, along the maxilla and maxillary arch or mandible and mandibular arch, and/or with the wire 101. Consequently, for a first tooth at a distance further from, for example, but not limited to, the maxillary arch than a second tooth where both teeth have brackets 105 directly coupled to them, a first thickness of a first portion (e.g., first location, etc.) of the wire 101 directly coupled to a first bracket 105 on the first tooth can be different from a second thickness of a second portion (e.g., second location, etc.) of the wire 101 directly coupled to a second bracket 105 on the second tooth. For example, the first thickness is greater than the second thickness. The first thickness can correspond to a first force and the second thickness can correspond to a second force, the first force greater than the second force. Thus, the first portion can apply a greater force onto the first tooth to align the first tooth with the wire 101, other teeth, and the maxillary arch compared to the second portion of the wire 101.

The brackets 105 can be formed from one or more manufacturing processes, such as, but not limited to additive manufacturing. For example, the brackets 105 can be formed from 3D printing. The brackets 105 can be formed from a material including at least one of a polymeric, metallic, ceramic, or any other material. For example, the brackets 105 are formed from a metallic material including at least one of titanium, stainless steel, steel, or any other metallic material. The bracket 105 can be formed from a metallic material via additive manufacturing such as 3D printing. Consequently, the bracket 105 can be formed from 3D printing the metallic material.

The plurality of brackets 105 includes a plurality of slots 202 (e.g., receiving space) as seen in FIGS. 17-18. The plurality of slots 202 can be rectangular shaped. The plurality of slots 202 can have a width and a height. The height can range from 0.012 to 0.022 inches, inclusive. In some implementations, the height is greater than 0.022 inches or less than 0.012 inches. For example, the height can be 0.0187 inches. Each of the plurality of brackets 105 can include at least one of the plurality of slots 202. The plurality of slots 202 can include a first portion 204 and a second portion 206. The second portion 206 can extend from the first portion 204. The first portion 204 can have a first height while the second portion 206 can have a second height. The second height can be greater than the first height. The plurality of slots 202 can hold the wire 101. The plurality of slots 202 can hold various sizes, diameters, and/or thicknesses of the wire 101. O-rings (e.g., elastic rings) and/or the metallic ligatures (e.g., wires) may maintain (e.g., secure) the wire 101 within the plurality of slots 202. In some implementations, the plurality of brackets 105 can tighten to secure the wire 101 within the plurality of slots 202. The first portion 204 and the second portion 206 can correspond to different thicknesses or widths of the wire 101. For example, responsive to the second thickness being greater than the first thickness, a portion of the wire 101 at the second location 114 is located within the second portion 206 while a portion of the wire 101 at the first location 112 is located within the first portion 204.

In some embodiments, the plurality of slots 202 are angled. For example, the plurality of slots 202 can be centered on a plane as seen in FIG. 17. The plurality of slots 202 can be angled relative to the plane. Angling the plurality of slots 202 can allow torque to be imparted on the tooth of an angled slot 202 to rotate the tooth. The plurality of slots 202 can have an angle ranging between 5 to 70 degrees, inclusive. In some implementations, at least a subset or a portion of the treatment members 103 are located partially within the slots 202. In some implementations, the treatment members 103 can limit movement of the wire 101 relative to the brackets 105.

The thickness of the wire 101 can vary between the plurality of brackets 105. For example, the first location 112 can be located within the plurality of slots 202 while the second location 114 can be located on the wire 101 between the plurality of brackets 105. Both the first location 112 and the second location 114 can be directly in contact with the brackets 105. The first thickness at the first location 112 can be different than the second thickness at the second location 114. In some implementations, the first thickness can determine an amount of torque applied to the tooth and the second thickness can determine an amount of force and moment applied to the teeth. A portion of the wire 101 between the plurality of brackets 105 (e.g., interbracket segments, the second location 114, corresponding to the second thickness) can include springs and/or apertures to adjust the force and moment applied to the teeth.

In some implementations, the brackets 105 corresponding to the portions of the wire 101 with different thicknesses may have varying slot 202 sizes. For example, brackets 105 that are to couple to portions of the wire 101 with a greater thickness than other portions of the wire 101 can have a greater slot 202 size, such as 0.0187 compared to 0.012 inches to accommodate the wire 101. In addition, in some implementations, the slot 202 size can determine force coupling and transfer from the wire 101 to the teeth such that the wire 101 can either be coupled such that the bracket 105 mitigates movement or coupled such that the wire 101 maintains contact while allowing sliding or movement. For example, a greater force or torque can be applied by the wire 101 in response to being coupled to the bracket 105 such that movement is mitigated compared to being coupled to the bracket 105 that allows movement. In some implementations, the slots 202 can be angled or otherwise varied to vary a space that the wire 101 occupies within the slot 202 to determine and adjust the force applied by the wire 101. For example, the wire 101 can apply a greater amount of force in response to occupying a greater volume within the slot 202. In addition, the thicknesses of the portions of the wire 101 between brackets 105 can affect translation, spring, or moment and portions of the wires directly coupled to and in contact with the brackets 105 can affect torque and force applied to the teeth. Thus, the variation in thickness of the wire 101 allows for customization and precise control of teeth movement.

In some implementations, the plurality of slots 202 does not include the first portion 204 and the second portion 206. In this case, the plurality of slots 202 can have a rectangular shape. The plurality of slots 202 can have a height. The height can range from 0.015 to 0.025 inches, inclusive. For example, the plurality of slots 202 can have a height of 0.018 inches. The height of the plurality of slots 202 can correspond to a thickness of the wire 101.

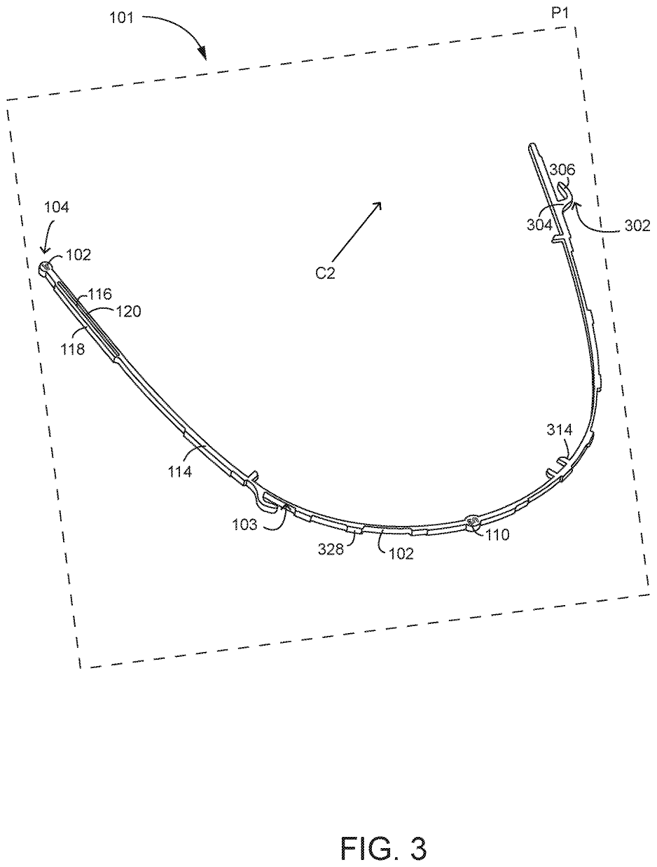

Referring now to FIGS. 2-3, the plurality of treatment members 103 can include one or more hooks 302 (e.g., elastic attachments). The hook 302 can extend from (e.g., be integrated with) the wire 101 on the plane P1. The hook 302 can extend from the wire 101 along the plane P1. For example, a first surface of the wire 101 and the hook 302 can lie on a first plane and a second surface of the wire 101 and the hook 302 can lie on a second plane parallel to the first plane. Either the first plane or the second plane can be the plane P1. The hook 302 can be used to connect elastic (e.g., rubber, etc.) bands. The elastic bands can be used to connect an upper arch (e.g., the plurality of teeth on an upper jaw, etc.) and a lower arch (e.g., the plurality of teeth on a lower jaw, etc.) to correct overbites, underbites, and/or crossbites. For example, the hook 302 may be placed on both the upper arch and the lower arch and the elastic band may stretch from the upper arch to the lower arch. The elastic bands can apply force to move the teeth and jaw into proper alignment. The hook 302 can be used to engage the elastic bands at mesial (e.g., side of tooth that faces the midline, etc.), distal (e.g., a side of the tooth that faces away from the midline, etc.), or both the mesial and distal sides. The hook 302 placed on the mesial side may guide teeth to the midline while the hook 302 placed on the distal side may guide the teeth toward the molars. The hook 302 placed on both the mesial and distal sides may allow for movement in multiple directions.

The hook 302, as seen in FIGS. 2-3, can include a first portion 304 (e.g., segment, part, etc.) extending from the wire 101. The first portion 304 can extend at a first angle between 30 to 80 degrees, inclusive, relative to the wire 101. The first portion 304 can be located on the plane P1. The hook 302 can include a second portion 306 extending from the first portion 304 at a second angle between 30 to 90 degrees, inclusive, relative to the first portion 304. The second portion 306 can be on the plane P1. A length and a width of the first portion 304 can be equal to a length and a width of the second portion 306. In some implementations, at least one of a length and a width of the first portion 304 is greater than the length and/or the width of the second portion 306. In some implementations, at least one of a length and a width of the first portion 304 is less than the length and/or the width of the second portion 306. A thickness of the first portion 304 can be different from a thickness of the second portion 306. In some implementations, the hook 302 can be bent out of the plane P1.

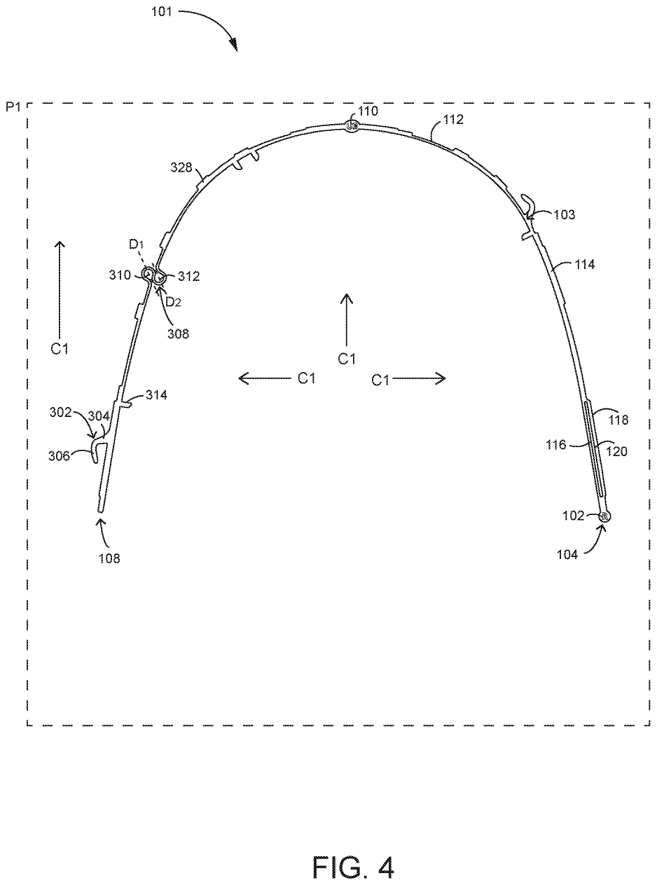

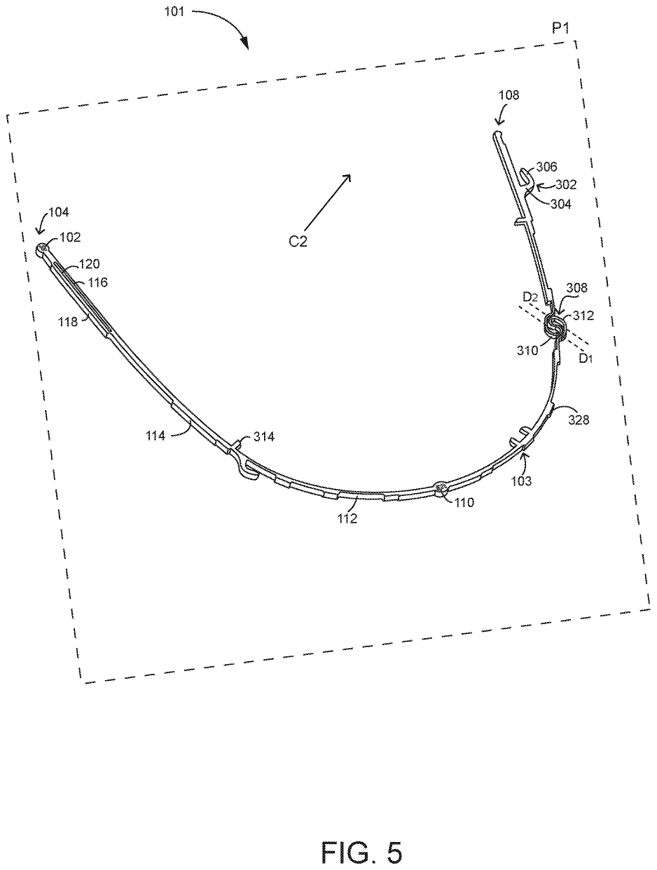

Referring now to FIGS. 4-5, the plurality of treatment members 103 can include one or more loops 308 (e.g., springs, etc.). The loop 308 can be continuous with (e.g., integrated with, etc.) the wire 101 and on the plane P1. For example, a first surface of the wire 101 and the loop 308 can lie on a first plane and a second surface of the wire 101 and the loop 308 can lie on a second plane parallel to the first plane. Either the first plane or the second plane can be the plane P1. The loop 308 can decrease or increase a space (e.g., gap, etc.) between adjacent teeth. The loop 308 can also maintain the space between adjacent teeth. The loop 308 can be used to move teeth in a direction, such as the mesial direction.

The loop 308 can include a first curved portion 310 (e.g., curved segment, rounded portion, etc.). The first curved portion 310 can extend from the wire 101 in a first direction D1 on the plane P1. The loop 308 can include a second curved portion 312 extending in a second direction D2. The second direction D2 can be opposite the first direction D1. Both the first curved portion 310 and the second curved portion 312 can extend from the wire 101. The second curved portion 312 can extend from (e.g., be continuous with, etc.) the first curved portion 310. In some implementations, the second direction D2 is angled relative to the first direction D1.

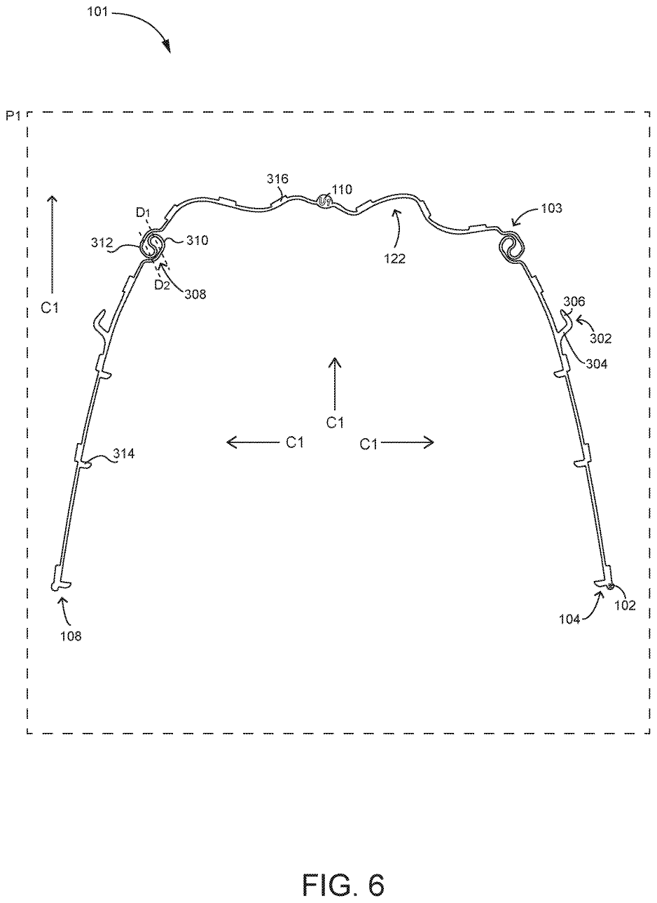

Referring now to FIGS. 6-9, the plurality of treatment members 103 can include one or more first protrusions 314 (e.g., extensions, projections, etc.) and one or more second protrusions 316. The first protrusions 314 and the second protrusions 316 can be on the plane P1 and mitigate round tripping (e.g., teeth moving back and forth, etc.). The first protrusions 314 and the second protrusions 316 can mitigate the plurality of teeth from moving from a first position, to a second position, and back to the first position. The first protrusions 314 and the second protrusions 316 can mitigate movement of the plurality of teeth. The first protrusions 314 and the second protrusions 316 can have a thickness equal to the wire 101. The first protrusions 314 and the second protrusions 316 can have a thickness different from the wire 101.

The first protrusions 314 can extend from the wire 101 on the plane P1. The first protrusions 314 can face the plurality of teeth. For example, the first protrusion 314 can be located on a lingual side of the plurality of teeth (e.g., side of teeth facing the tongue, etc.). The second protrusions 316 can extend from the wire 101 on the plane P1. The second protrusions 316 can face away from the plurality of teeth. For example, the second protrusions 316 are located on a buccal side (e.g., side of teeth facing inside of cheeks, etc.) of the plurality of teeth. The first protrusions 314 and the second protrusions 316 can face opposite directions. In some implementations, the first protrusions 314 and the second protrusions 316 are angled relative to the wire 101. The first protrusions 314 can be in contact with the plurality of teeth. The first protrusions 314 can be located in the space between adjacent teeth. The second protrusions 316 can be located within the plurality of slots 202. The second protrusions 316 can have a thickness equal to or less than the height of the plurality of slots 202. As seen in, for example, FIG. 6, the second protrusions 316 may be located closer to the third identifier 110 while the first protrusions 314 are located closer to the first identifier 102 and/or the second identifier 106.

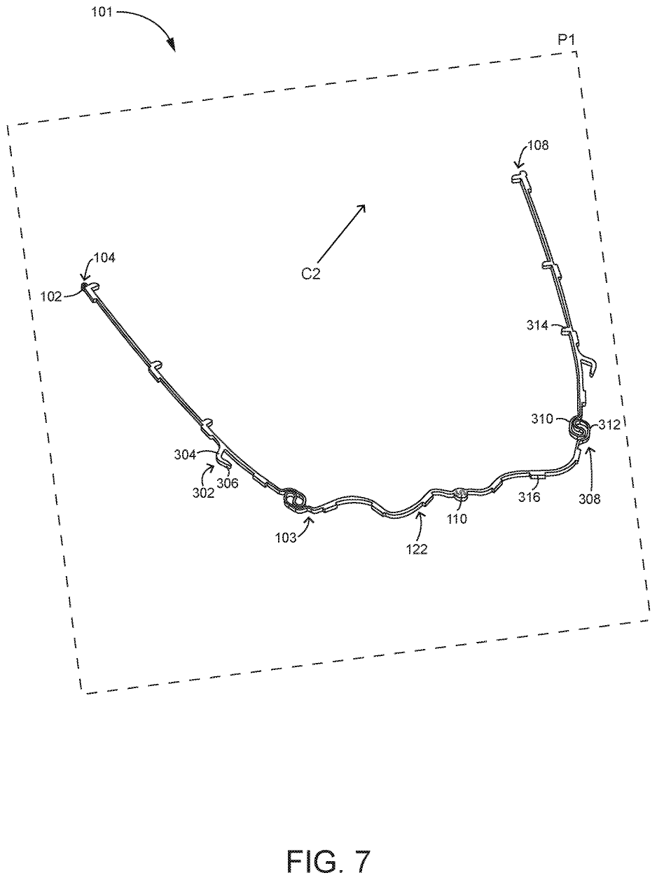

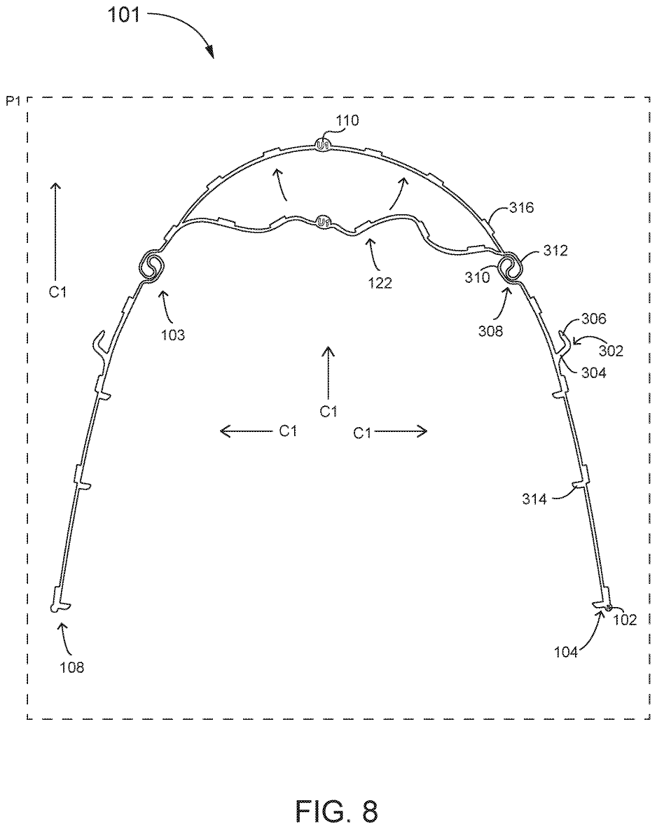

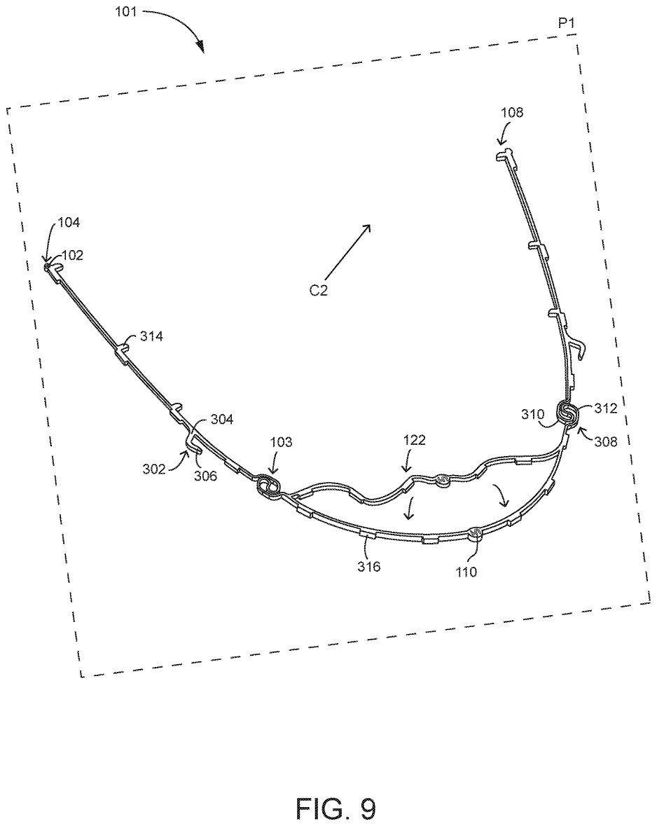

In some implementations, as seen in FIGS. 6-7, to mitigate round tripping, the wire 101 can include one or more curved segments (e.g., curved portions, rounded segments, etc.) 122. The wire 101 can be curved based on a degree of misalignment of the plurality of teeth. For example, a degree at which the curved segments 122 curve can increase responsive to the plurality of teeth being more misaligned from the dental arch. The curved segments 122 can align with the plurality of teeth. For example, a tooth, such as a premolar, may be extracted prior to aligning anterior (e.g., back of mouth, etc.) teeth (e.g., molars, etc.). In this case, the wire 101 can be placed on the plurality of brackets 105 to maintain a position of the teeth (e.g., including the anterior teeth, etc.). This can allow for an extraction space (e.g., where the premolar was located, etc.) to close without round tripping of the anterior teeth. The wire 101 may be placed passively (e.g., not tightened within the plurality of slots 202, etc.) in the plurality of brackets 105 to mitigate round tripping. In this case, the wire 101 may not enact a force on the plurality of teeth. The first protrusions 314 can provide a larger area (e.g., compared to the wire 101, etc.) for the plurality of brackets 105 to passively hold. For example, the first protrusions 314 may have a width equal to the width of the plurality of slots 202 while the wire 101 has a width less than the width of the plurality of slots 202. The first protrusions 314 can have a thickness equal to or less than the height of the plurality of slots 202. The curved segments 122 may align with the plurality of teeth to maintain a position of the plurality of teeth. Once the extraction space has closed, the wire 101 can be straightened (e.g., the curved segments 122 removed, etc.) as seen in FIGS. 8-9. The wire 101 being straightened can allow the wire 101 to provide force to the plurality of teeth.

In some implementations, the first protrusions 314 can move the teeth in a mesial or distal direction or mitigate mesial or distal movement. The first protrusions 314 can be smooth. The first protrusions 314 can be located on the mesial, distal, or both sides of the plurality of brackets 105. The first protrusions 314 can contact the plurality of brackets 105 to move the teeth in a direction responsive to the first protrusion 314 being located on the mesial or distal side. The first protrusions 314 can also contact the plurality of brackets 105 to mitigate movement of the teeth responsive to the first protrusion being located on both the mesial and distal side, as seen in, for example, FIG. 4.

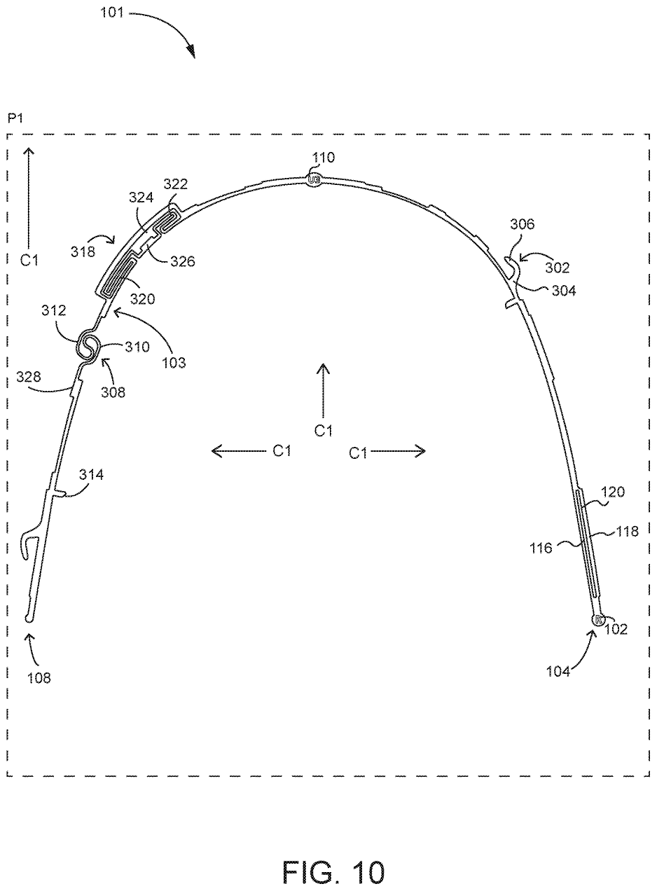

Referring now to FIGS. 10-11, the plurality of treatment members 103 can include one or more aligners 318 (e.g., piggyback, supplemental wiring, tandem, etc.). The aligner 318 can align teeth such as high buccal canines (e.g., canine positioned above the dental arch, etc.). The aligner 318 can pull (e.g., move, etc.) teeth to the dental arch and align the teeth with the wire 101. To do this, the aligner 318 can include one or more segments. A first segment (e.g., stabilizing part, etc.) can be continuous with the wire 101 while a second segment (e.g., moving part, etc.) can connect to a misaligned tooth to guide the misaligned tooth to the dental arch and towards the wire 101. The first segment and the second segment can ensure that a stability of the wire 101 is maintained (e.g., wire 101 does not move, etc.) while moving the misaligned tooth. The second segment can connect to the misaligned tooth via the bracket 105 on the misaligned tooth.

The aligner 318 can be continuous with the wire 101. The aligner 318, as shown in FIGS. 10-11 can include a first curved portion 320 on the plane P1. The aligner 318 can also include a second curved portion 322. The first curved portion 320 and the second curved portion 322 can be the first segment. The second curved portion 322 can be continuous with the first curved portion 320 on the plane P1. The first curved portion 320 and the second curved portion 322 can have a serpentine shape. The first curved portion 320 and the second curved portion 322 can define a receiving space 324 (e.g., aperture, etc.). The receiving space 324 can include a protrusion 326. The receiving space 324 can be the second segment. The receiving space 324 can be moved to the misaligned tooth and the protrusions 326 can be placed within the slot 202 of the bracket 105 on the misaligned tooth. An O-ring, for example, can secure the protrusion 326 within the slot 202. The receiving space 324 can receive at least one of the plurality of teeth. The first curved portion 320 and the second curved portion 322 can be configured to extend to the at least one of the plurality of teeth (e.g., the misaligned tooth, high buccal canine, etc.). The first curved portion 320 and the second curved portion 322 can maintain the stability of the wire 101 while extending to allow the protrusion 326 to be attached to the bracket 105 of the misaligned tooth. To attach to the misaligned tooth, the aligner 318 can be extended out of the plane P1. The first curved portion 320 and the second curved portion 322 can also increase a gap between two of the teeth to allow the aligner 318 to pull the misaligned tooth to be positioned between the two of the teeth. At least a portion of the aligners 318 can directly couple to at least one bracket 105.

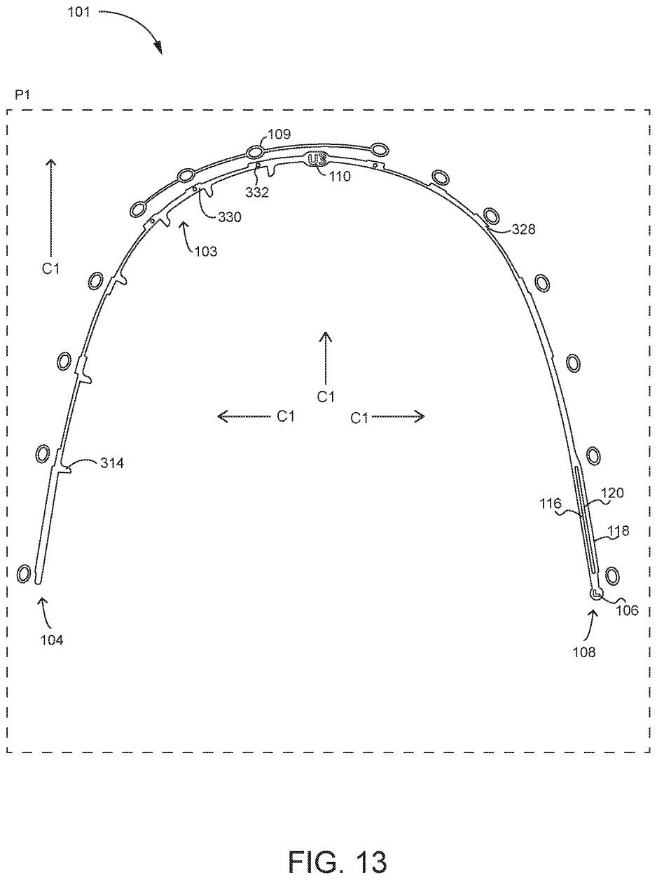

Referring now to FIGS. 12-13, the plurality of treatment members 103 can include one or more first markers 328 (e.g., extensions, protrusions, etc.) and one or more second markers 330. In some implementations, the system 100 includes the first markers 328 and the second markers 330, and the first markers 328 and the second markers 330 extend from the wire 101. The first markers 328 and the second markers 330 can align with the plurality of brackets 105. The first markers 328 and the second markers 330 can signify placement of O-rings 107 or power chains 109 on the plurality of brackets 105. For example, the first markers 328 can indicate to, for example, an orthodontist, to place O-rings 107 on the plurality of brackets 105 aligned with the first markers 328. The second markers 330 can indicate to place power chains 109 on the plurality of brackets 105 aligned with the second markers 330. The first markers 328 can be continuous with the wire 101.

In some implementations, the first markers 328 are thicker than the wire 101. In some implementations, the first marker 328 being continuous with portions of the wire 101 allows the portions of the wire 101 continuous with the first marker 328 to have a thickness greater than portions of the wire 101 without the first marker 328. In some implementations, the first markers 328 directly couple to the brackets 105 such that the first markers 328 are to be located in the slots 202. In some implementations the first markers 328 extend from the wire 101 and face away from the plurality of teeth. In some implementations, the first markers 328 are in direct contact with a subset of the treatment members 103. For example, the first markers 328 can be in direct contact with the aligners 318. The second markers 330 can extend from the wire 101 and face away from the plurality of teeth. The second markers 330 can include apertures 332 to signify placement of the power chain 109.

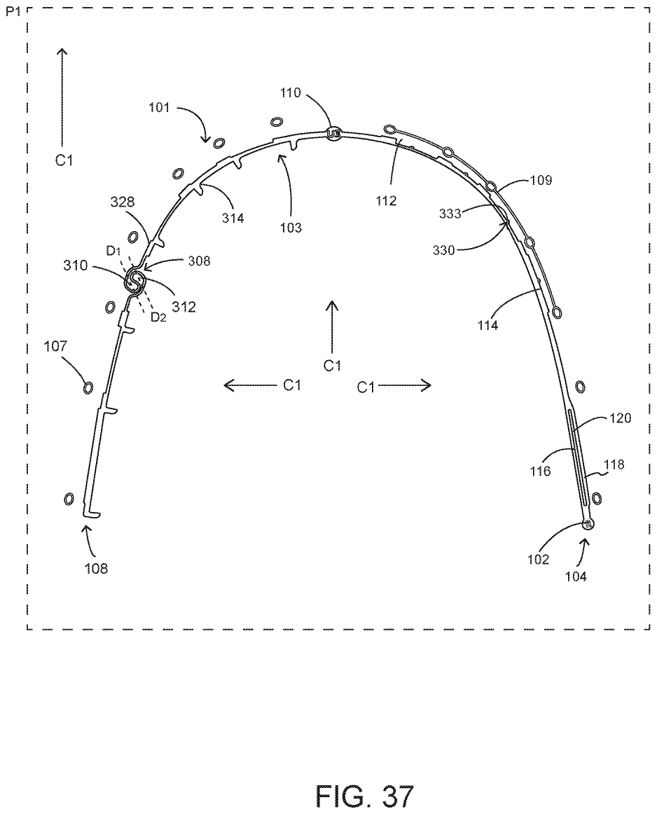

In some embodiments, the second markers 330 do not include apertures 332 and instead, include protrusions 333 as seen in FIG. 37. The protrusions 333 can replace the apertures 332 as the second markers 330. The protrusions 333 may be in contact with the power chain 109. The protrusions 333 may be located along the wire between the first markers 328. For example, to signify placement of the O-rings 107, the wire 101 may not include the second markers 330 and only include the first markers 328. To signify placement of the power chains 109, the wire 101 may include both the second markers 330 and the first markers 328. The first markers 328 may be aligned with the plurality of brackets 105 for the power chain 109 and/or the O-rings 107 to be in contact with while the second markers 330 are located between the first markers 328 to signify placement of the power chain 109.

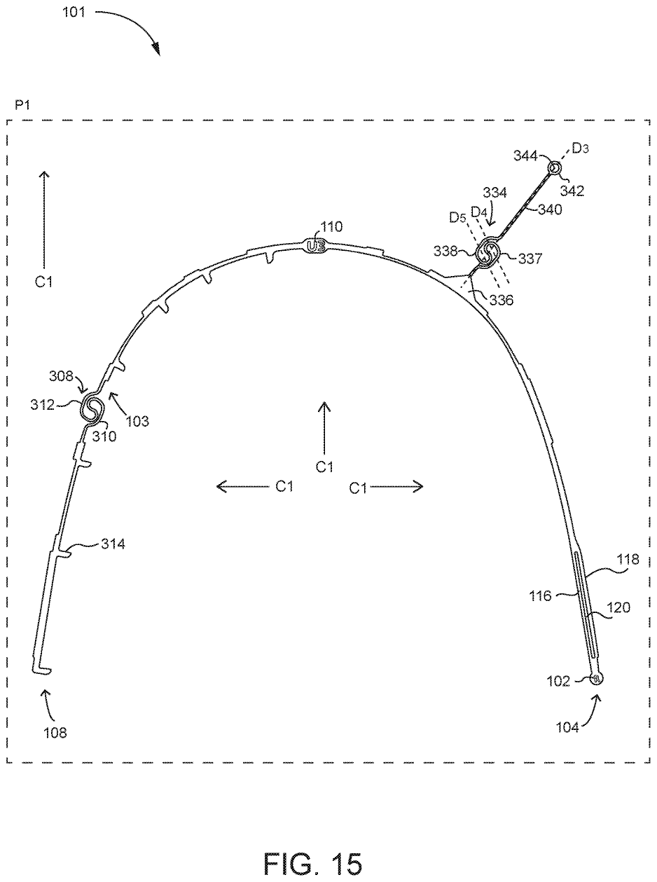

Referring now to FIG. 15, the plurality of treatment members 103 can include one or more links 334 (e.g., connector, etc.). The first markers 328 can be in direct contact with the links 334. At least a portion of the links 334 can directly couple to at least one bracket 105. Canine teeth within the plurality of teeth can be impacted (e.g., fail to properly erupt, remain within a gum of the mouth of the patient, etc.). The canine tooth can be aligned with the dental arch using the link 334. The link 334 can pull (e.g., move, etc.) the canine tooth to align with the plurality of teeth. The link 334 can move the canine tooth towards the upper arch to align with the wire 101. The link 334 can attach to the bracket 105 on the canine tooth to move the canine tooth to the upper arch.

The link 334 can include a protrusion 336 extending from the wire 101 in a third direction D3 on the plane P1. The protrusion 336 can maintain the stability of the wire 101 while the link 334 is enacting force on the canine tooth to align the canine tooth. The protrusion 336 can have a triangle shape. The link 334 can include a first curved portion 337 extending from the protrusion 336 in a fourth direction D4 on the plane P1. The link 334 can also include a second curved portion 338 extending from the first curved portion 337 in a fifth direction D5. The fifth direction D5 can be opposite the fourth direction D4. In some implementations, the link 334 can include the loop 308. The link 334 can further include a straight portion 340 (e.g., segment, etc.) extending from the second curved portion 338. The straight portion 340 can extend in the third direction D3. The link 334 can also include a circular portion 342 extending from the straight portion 340. The circular portion 342 can connect to at least one of the plurality of brackets 105. The circular portion 342 can extend around an aperture 344. The aperture 344 can be coupled to the bracket 105 located on the canine. For example, the circular portion 342 can extend around the bracket 105 or be located within the slot 202 of the bracket 105. The link 334 can be bent out of the plane P1 to extend to the canine. The first curved portion 337 and the second curved portion 338 can provide force to close a distance (e.g., space, etc.) between the wire 101 and the canine.

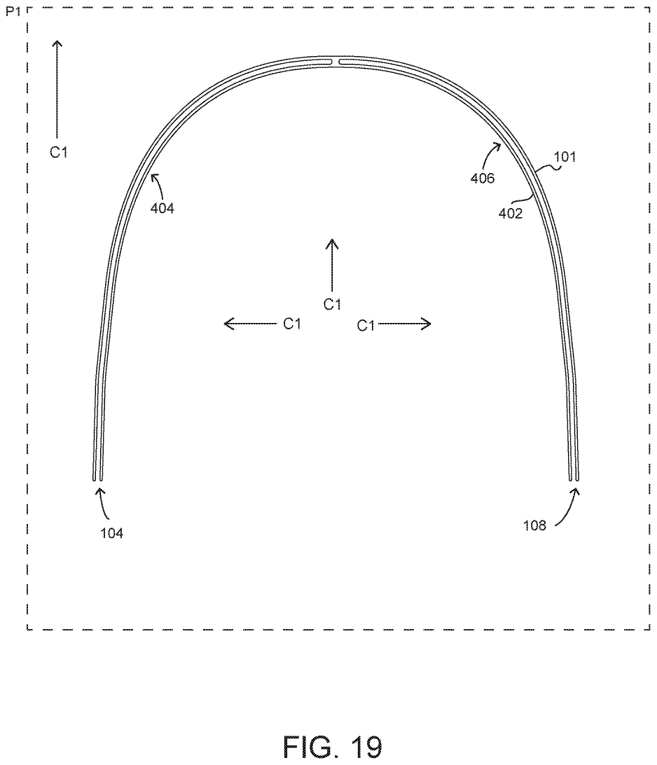

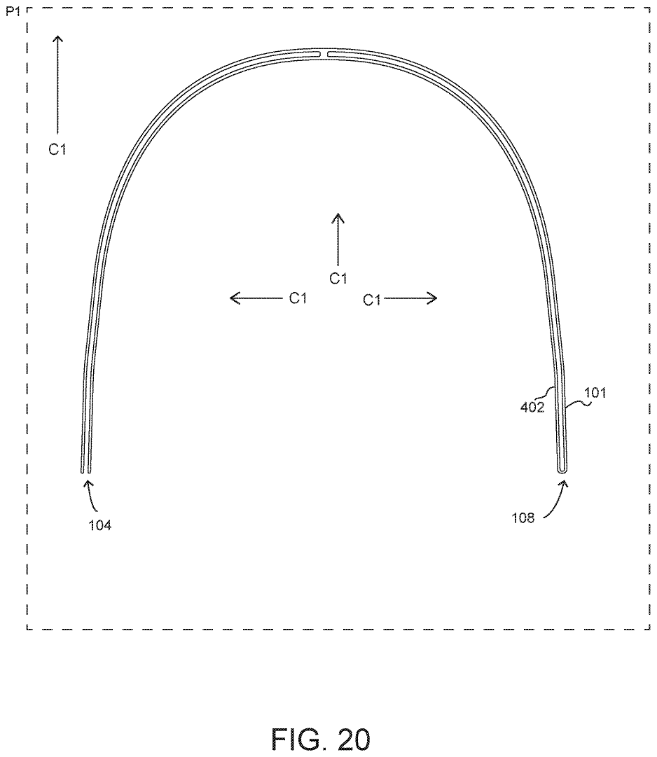

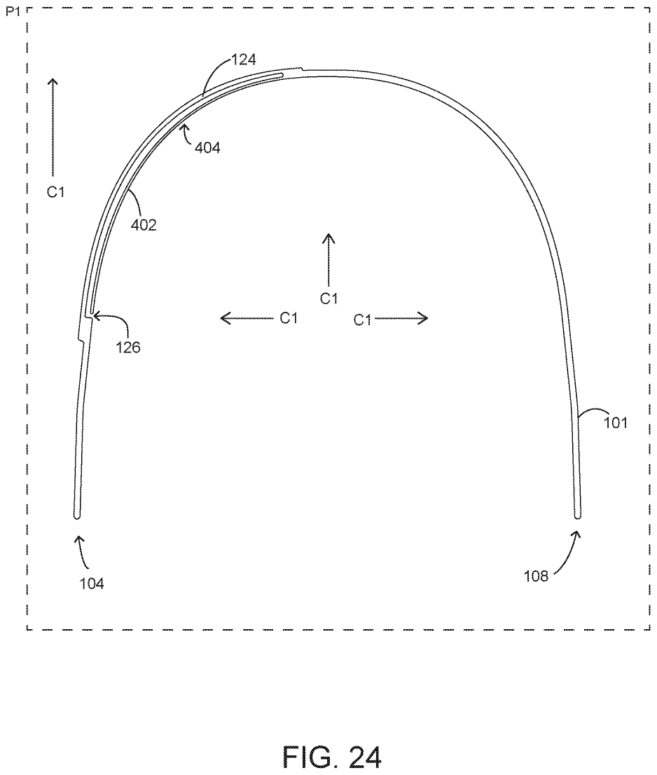

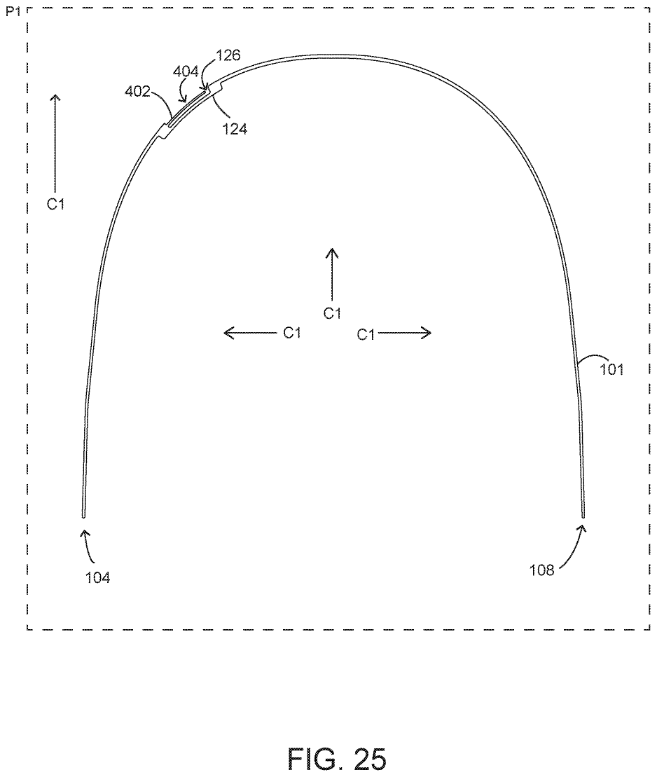

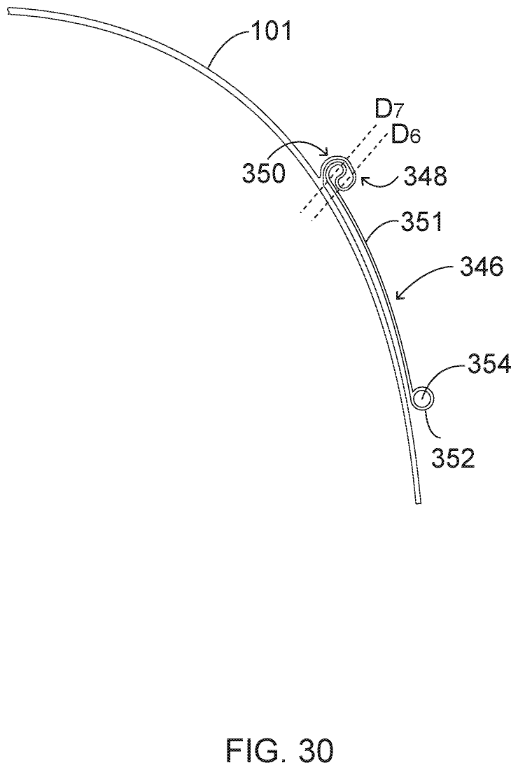

In some embodiments, the wire 101 is a first wire 101. As seen in FIGS. 19-35, the system 100 can include a second wire 402. The second wire 402 can also be arched-shaped. The second wire 402 can extend along the plane P1. The second wire 402 can include the material. The material can be a flexible material. The material can be a flexible, metallic material. The material can be nickel titanium (NiTi). The material can also be stainless steel. The material can be a shape memory alloy. The first wire 101 and the second wire 402 can be coupled. For example, the first wire 101 and the second wire 402 can be coupled at the midpoint (e.g., middle, center, etc.) of the first wire 101 and the second wire 402 as seen in FIG. 19. The first wire 101 and the second wire 402 can also be coupled at any point along the first wire 101. The first wire 101 and the second wire 402 can also be coupled at the first end 104 and/or the second end 108 of the first wire 101 as seen in, for example, FIG. 20. The first wire 101 can be a stabilizing wire and the second wire 402 can align teeth to the first wire 101. For example, the first wire 101 can be coupled to teeth within the dental arch while the second wire 402 is coupled to the teeth within the dental arch and teeth not in the dental arch (e.g., misaligned teeth, etc.). The first wire 101 can mitigate movement of the teeth within the dental arch while the second wire 402 moves teeth towards the dental arch. In this case, the first wire 101 can be thicker than the second wire 402. In some embodiments, the second wire 402 is the stabilizing wire and the first wire 101 aligns teeth to the second wire 402.

In some embodiments, the second wire 402 is in contact with the bracket 105. In some embodiments, the second wire 402 is in contact with the plurality of teeth and not in contact with the bracket 105. In some embodiments, the second wire 402 has a thickness equal to a thickness of the first wire 101. In some embodiments, the thickness of the second wire 402 is different than the thickness of the first wire 101.

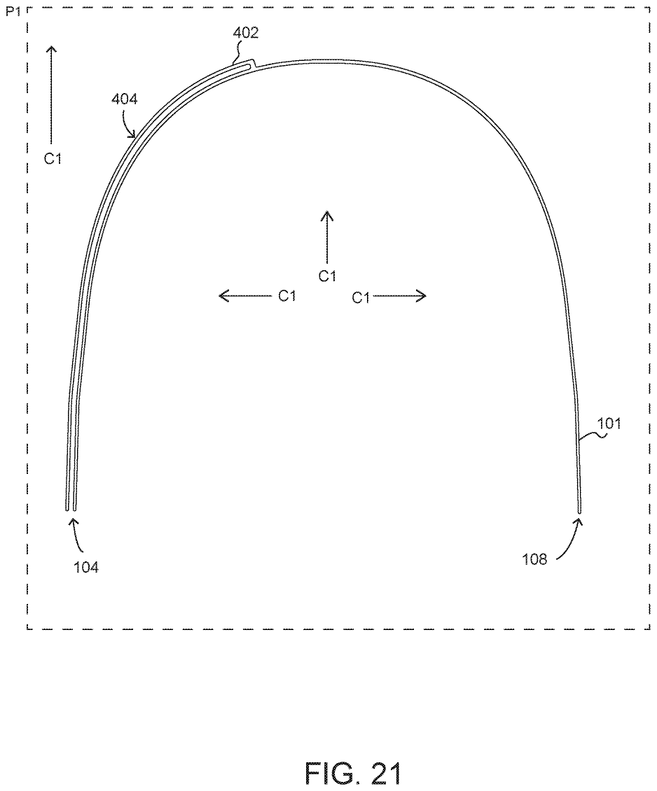

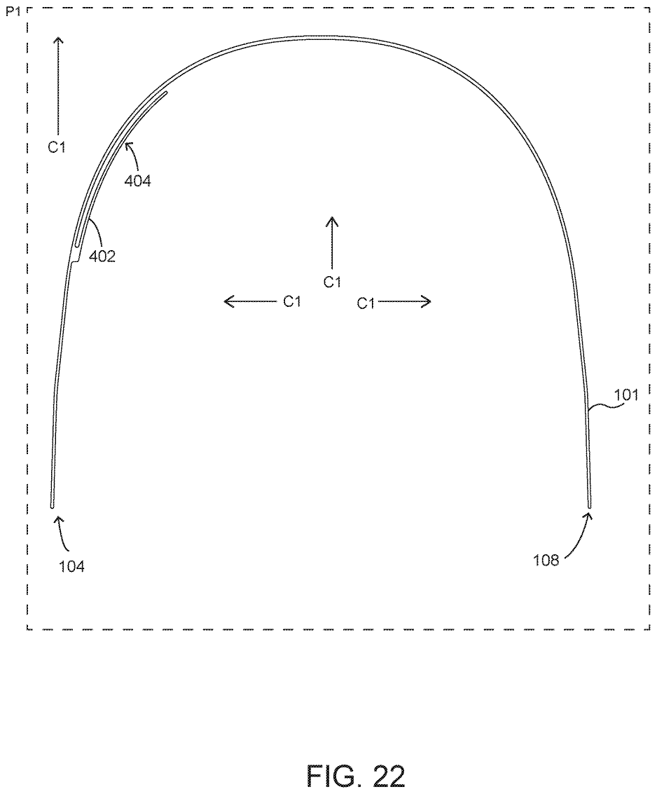

In some embodiments, the second wire 402 includes a first portion 404 (e.g., part, segment, etc.) and a second portion 406. The first portion 404 can correspond to a length of the first wire 101 from the first end 104 to the midpoint. The second portion 406 can correspond to a length of the first wire 101 from the midpoint to the second end 108. The first portion 404 can be coupled to the first wire 101. The first portion 404 can be coupled to the first wire 101 between the first end 104 and the midpoint and extend towards the first end 104, as seen in FIG. 21. The first portion 404 can also extend towards the midpoint, as seen in FIG. 22. The first portion 404 can have a length less than the length of the first wire 101 from the first end 104 to the midpoint. The first portion 404 can have a length equal to the length of the first wire 101 from the first end 104 to the midpoint. In some embodiments, the first portion 404 extends on a side of the first wire 101 in contact with the plurality of teeth. In some embodiments, the first portion 404 extends on a side of the first wire 101 not in contact with the plurality of teeth.

In some embodiments, the second portion 406 is coupled to the first wire 101. The second portion 406 can be coupled to the first wire 101 between the second end 108 and the midpoint and extend towards the second end 108. The second portion 406 can also extend towards the midpoint. The second portion 406 can have a length less than the length of the first wire 101 from the second end 108 to the midpoint. The second portion 406 can have a length equal to the length of the first wire 101 from the second end 108 to the midpoint. In some embodiments, the second portion 406 extends on a side of the first wire 101 in contact with the plurality of teeth. In some embodiments, the second portion 406 extends on a side of the first wire 101 not in contact with the plurality of teeth.

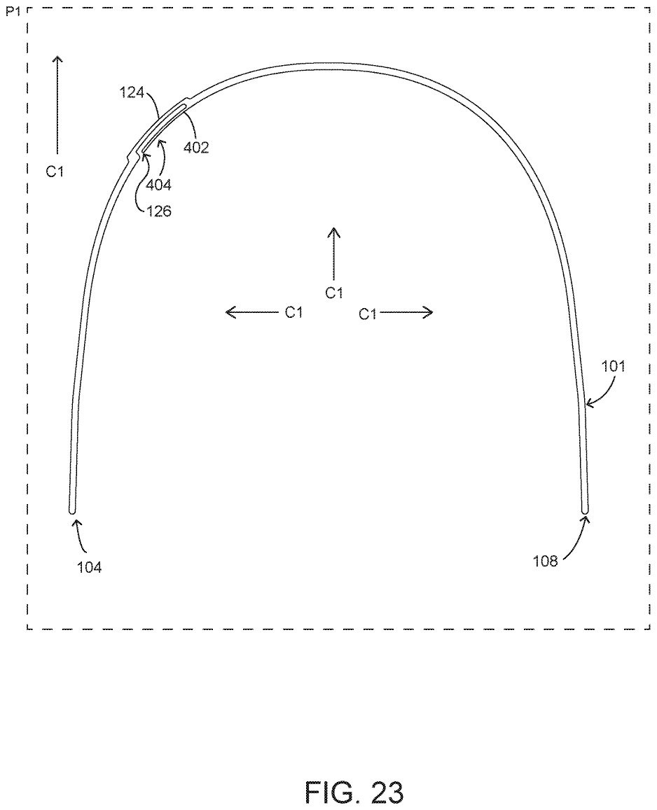

In some embodiments, as seen the first wire 101 can include a bent portion 124 (e.g., angled segment, etc.) as seen in FIGS. 23-26. The bent portion 124 can be located between the first end 104 and the midpoint and/or between the second end 108 and the midpoint. The bent portion 124 can be integrated with and continuous to the first wire 101. The bent portion 124 can be located at any point along the first wire 101. The bent portion 124 may correspond to a tooth of the plurality of teeth. The bent portion 124 can be a plurality of bent portions 124. The bent portion 124 can be continuous with (e.g., integrated with, etc.) the wire 101. The bent portion 124 can extend away from the plurality of teeth or extend towards the plurality of teeth. The bent portion 124 can define a cavity 126. The cavity 126 can face away from the plurality of teeth or extend towards the plurality of teeth. The second wire 402 (e.g., the first portion 404 or the second portion 406, etc.) can be coupled to the first wire 101 and extend within the cavity 126. The second wire 402 can be coupled to the bent portion 124. In this case, a length of the second wire 402 can be less than a length of the cavity 126. The second wire 402 can extend towards the midpoint or the first end 104. The second wire 402 can also extend towards the second end 108. The length of the bent portion 124 can be less than the length of the first portion 404 and the second portion 406. The length of the bent portion 124 can be less than the length of the first wire 101.

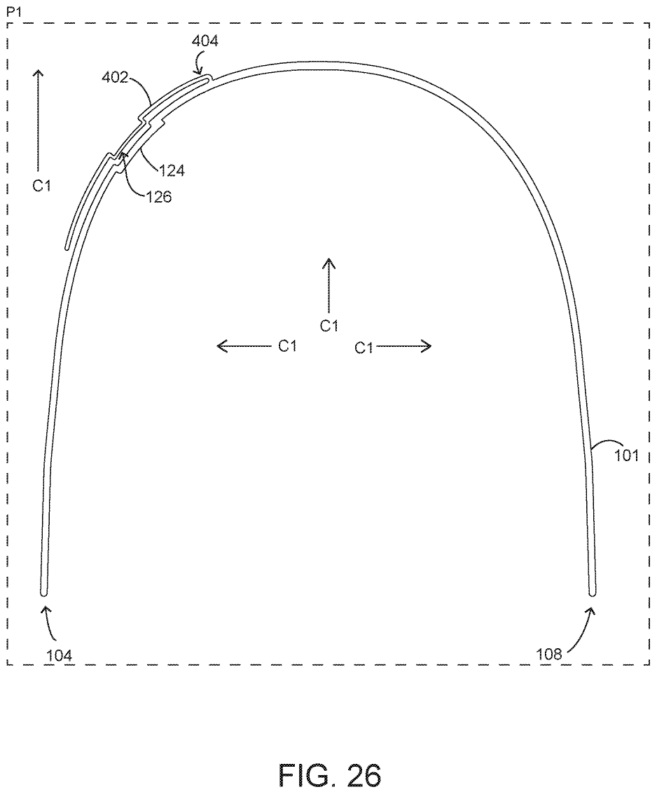

In some embodiments, the length of the second wire 402 is greater than the length of the cavity 126. For example, as seen in FIG. 26, the second wire 402 can be coupled to the first wire 101 between the first end 104 and the midpoint and extend towards the first end 104 and along the cavity 126. In this case, the second wire 402 can also include a bent portion 408. The bent portion 408 can be congruent with the cavity 126.

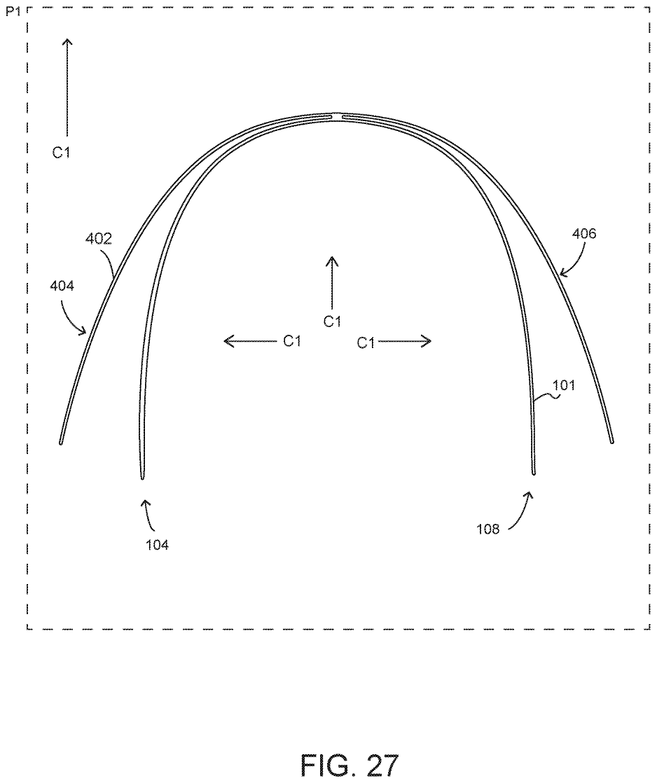

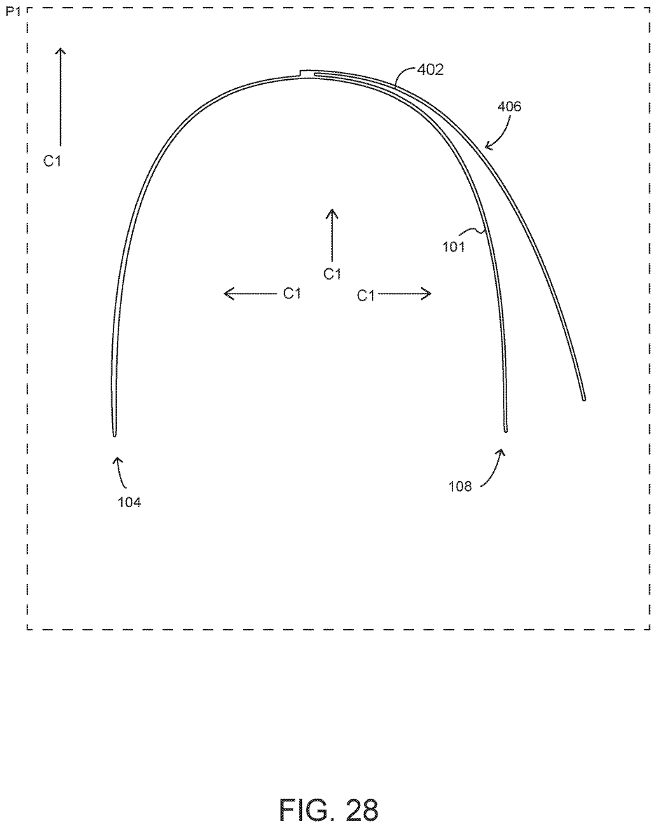

In some embodiments, as seen in FIGS. 27-28, the second wire 402 can have a width greater than the first wire 101. The second wire 402 can be expandable. The second wire 402 can have a different curvature than the first wire 101. The second wire 402 can be coupled to the first wire 101 and expand further away from the plurality of teeth than the first wire 101. In some embodiments, as seen in FIG. 28, the first portion 404 or the second portion 406 can be coupled to the first wire 101. The first portion 404 can be coupled at the midpoint of the first wire 101 and extend towards the first end 104. The first portion 404 can have a width greater than the first wire 101 (e.g., extends away from the first wire 101, etc.). The first portion 404 can be expandable. The second portion 406 can be coupled at the midpoint of the first wire 101 and extend towards the second end 108, as seen in FIG. 28. The second portion 406 can have a width greater than the first wire 101 (e.g., extends away from the first wire 101, etc.). The second portion 406 can be expandable.

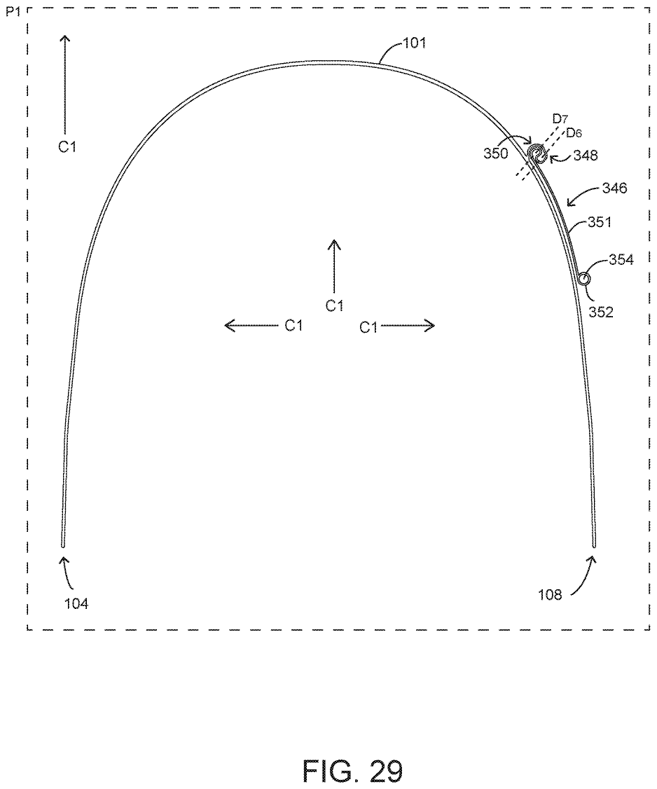

In some embodiments, as seen in FIGS. 29-32, the wire 101 can include a closing spring 346 (e.g., space closer, etc.). The closing spring 346 can extend across at least one tooth and close (e.g., decrease, etc.) a gap between adjacent teeth. The closing spring 346 can maintain a force (e.g., spring force, etc.) to close the gap between adjacent teeth. The closing spring 346 can extend from the wire 101 and face away from the plurality of teeth. The closing spring 346 can include a first curved portion 348 extending in a sixth direction D6. The closing spring 346 can include a second curved portion 350 extending in a seventh direction D7. The seventh direction D7 can be opposite of the sixth direction D6. The second curved portion 350 can extend from the first curved portion 348. In some implementations, the closing spring 346 can include the loop 308.

The closing spring 346 can also include a connection portion 351 (e.g., connector, connector wire, etc.) extending along the wire 101 from the second curved portion 350. The closing spring 346 can include a circular portion 352 extending around an aperture 354. The circular portion 352 can extend from the connection portion 351. The aperture 354 can be coupled to the bracket 105 located on tooth. For example, the circular portion 352 can extend around the bracket 105 or be located within the slot 202 of the bracket 105. The first curved portion 348 and the second curved portion 350 can provide a force to close a distance (e.g., space, etc.) between the teeth that the closing spring 346 is coupled to. The connection portion 351 can extend across at least one tooth. For example, the first curved portion 348 and the second curved portion 350 can be located at a first tooth. The circular portion 352 can be located at a second tooth with the aperture 354 coupled to the bracket 105 on the second tooth. There can be at least one tooth between the first tooth and the second tooth. The connection portion 351 can extend from the first tooth to the second tooth. A length of the connection portion 351 can determine a force of the closing spring 346. For example, a greater length of the connection portion 351 can correspond to a greater force imparted on the teeth by the closing spring 346. A thickness of the closing spring 346 may also increase as the length of the connection portion 351 increases.

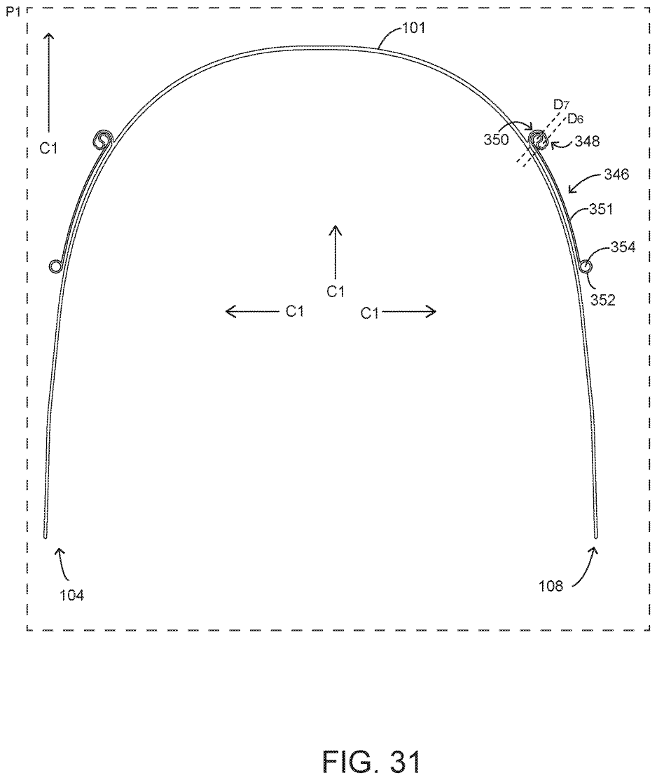

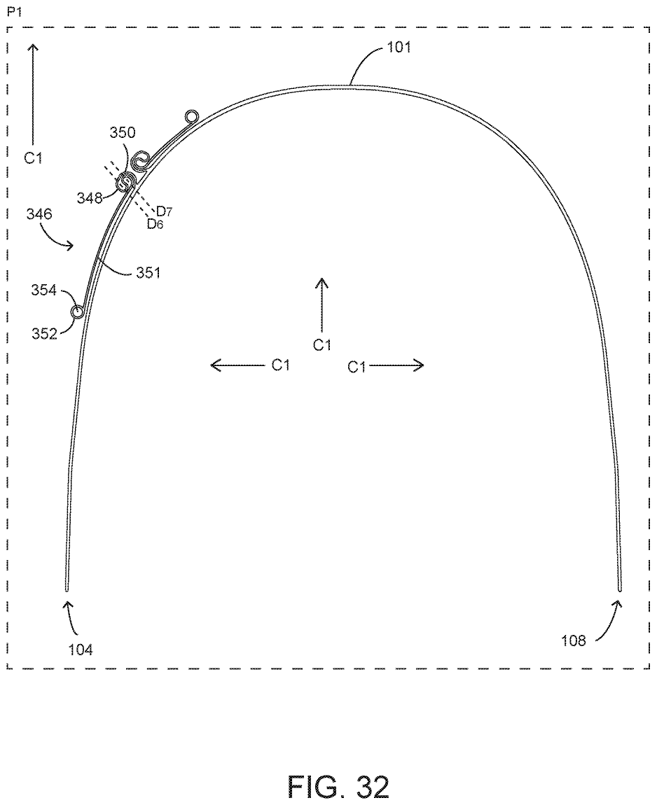

In some embodiments, as seen in FIG. 31, the wire 101 can include a plurality of the closing spring 346. One of the plurality of the closing spring 346 can be located between the first end 104 and the midpoint and another of the plurality of the closing spring 346 can be located between the second end 108 and the midpoint. Each of the plurality of the closing spring 346 can be positioned symmetric to each other along the wire 101. In some embodiments, as seen in FIG. 32, the plurality of the closing spring 346 can be in contact with each other. The first curved portion 348 and the second curved portion 350 of the plurality of the closing spring 346 can be in contact with each other. The plurality of the closing spring 346 can be located either between the first end 104 and the midpoint or between the second end 108 and the midpoint. A length of one of the plurality of the closing spring 346 can be less than a length of another of the plurality of the closing spring 346. A smaller length may correspond to a smaller force enacted on the tooth. The smaller length may correlate to a smaller distance between teeth compared to the one of the plurality of the closing spring 346 with a greater length.

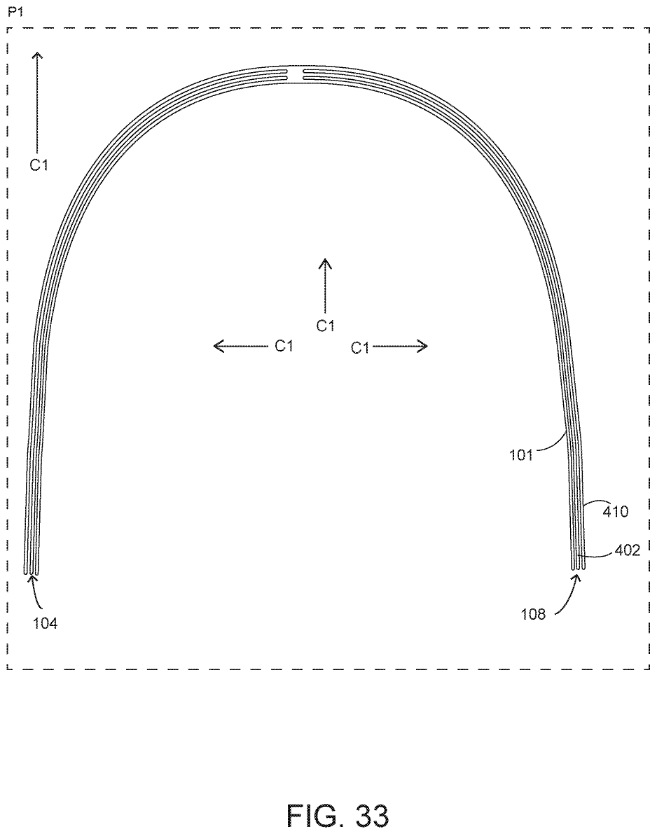

In some embodiments, the system 100 can include a third wire 410 as seen in FIG. 33. The third wire 410 can also be arched-shaped. The third wire 410 can include the material. The material can be a flexible material. The material can be a flexible, metallic material. The material can be nickel titanium (NiTi). The material can also be stainless steel. The material can be a shape memory alloy. The third wire 410 can be coupled to the first wire 101 and the second wire 402. The third wire 410 and the second wire 402 can be coupled at the midpoint of the first wire 101. A length of the third wire 410, the second wire 402 and the first wire 101 can be equal. The first wire 101, the second wire 402 and the third wire 410 may be congruent. An addition of the third wire 410 can impart a greater force to align the teeth. The third wire 410 can also facilitate alignment of the teeth with the dental arch. The addition of the third wire 410 allows for greater variability and capability to adjust the forces. For example, the system 100 including the first wire 101, the second wire 402, and the third wire 410 has a greater variability and capability of force adjustment that the system 100 including the first wire 101 and the second wire 402. The first wire 101, the second wire 402, and the third wire 410 may be coupled at any point along the first wire 101.

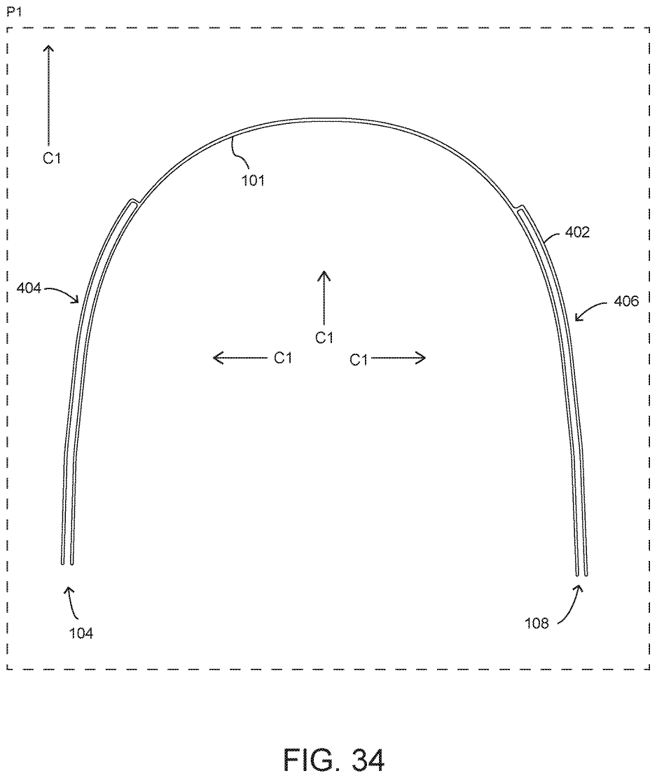

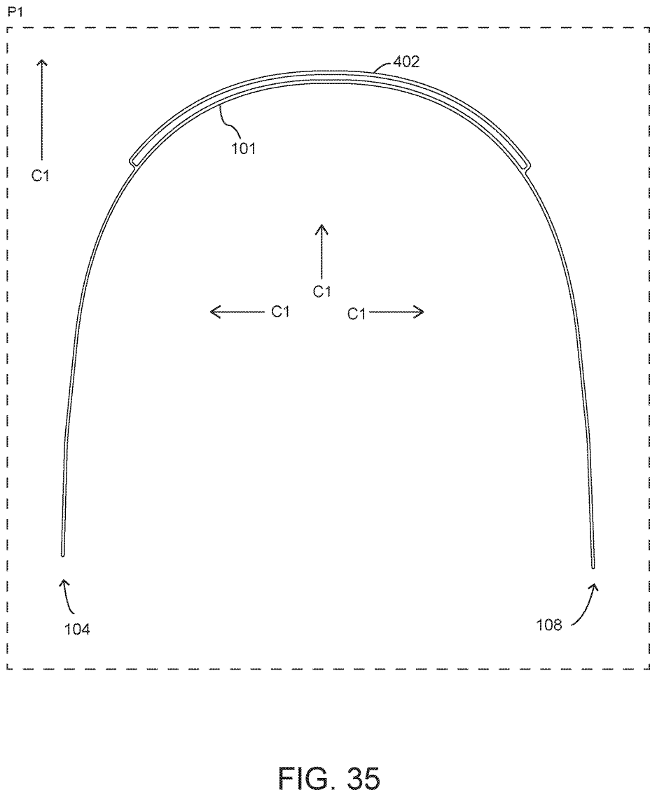

In some embodiments, both the first portion 404 and the second portion 406 are coupled to the first wire 101 as seen in FIG. 34. The first portion 404 can be coupled between the first end 104 and the midpoint and extend towards the first end 104. The second portion 406 can be coupled between the second end 108 and the midpoint and extend towards the second end 108. The second wire 402 and/or the third wire 410 can also extend across the midpoint of the first wire 101. For example, the second wire 402 can be coupled at a point between the first end 104 and the midpoint and at another point between the second end 108 and the midpoint as seen in FIG. 35. In this case, the second wire 402 can extend across the midpoint. The second wire 402 can facilitate alignment of teeth along the front of the upper dental arch and/or the lower dental arch.

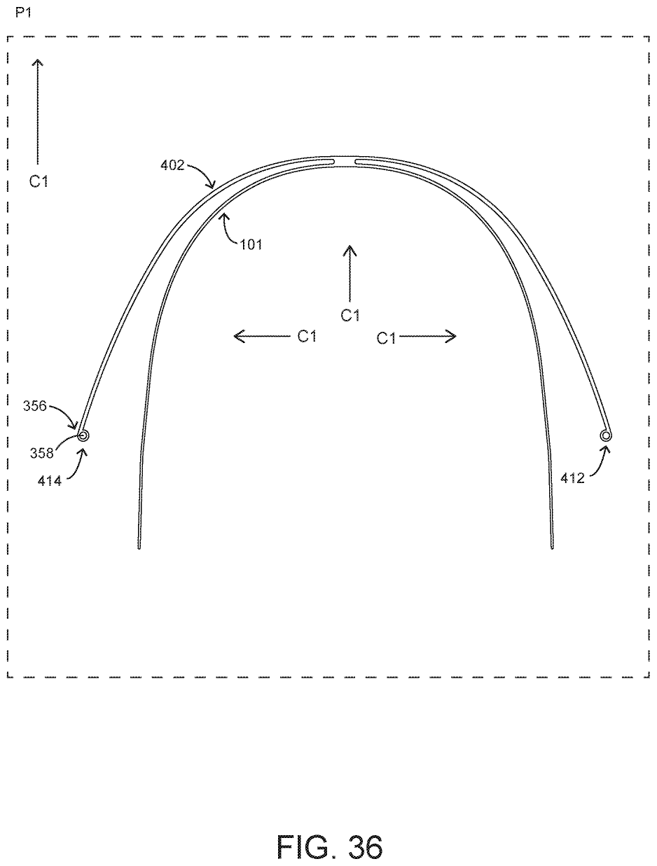

In some embodiments, the plurality of treatment members 103 further includes a plurality of rings 356 as seen in FIG. 36. The plurality of rings 356 can be continuous with at least one of the first wire 101 and/or the second wire 402. The plurality of rings 356 can be located at a first end 412 and a second end 414 of the second wire 402. The plurality of rings 356 extend around an aperture 358. The plurality of rings 356 can be connected to and in contact with at least one of the plurality of brackets 105. The teeth that the at least one of the plurality of brackets 105 is attached to can move buccally (e.g., side of teeth facing inside of cheeks, etc.) and expand due to force enacted by the plurality of rings 356.

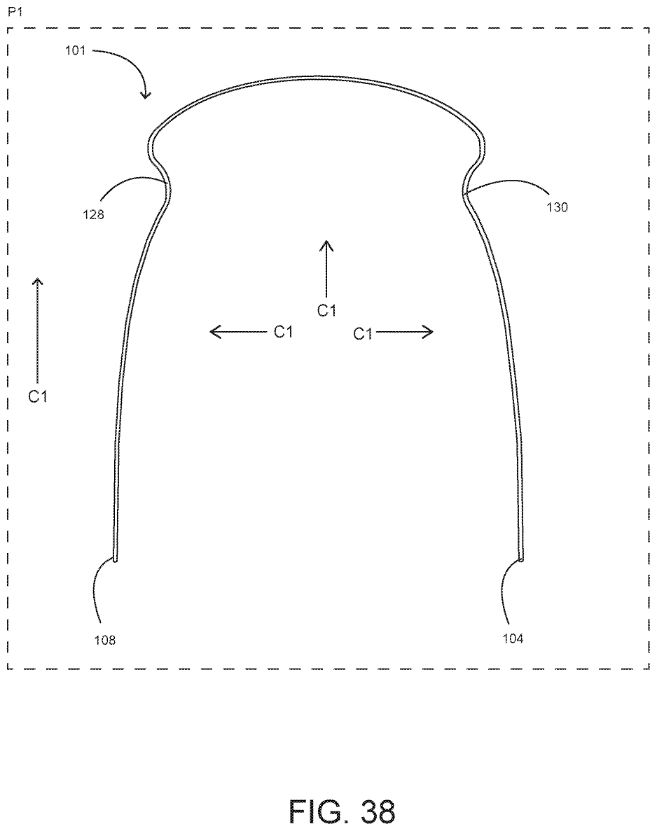

In some embodiments, the wire 101 has a portion with a biconcave shape as seen in FIG. 38. For example, the wire 101 includes a first concave section 128 and a second concave section 130. The first concave section 128 and the second concave section 130 face away from each other in that a section of the wire 101 including the first concave section 128 and the second concave section 130 has a width less than a width of the wire 101 at the first end 104 and the second end 108. The wire 101 has symmetrical convergence and divergence. The first concave section 128 and the second concave section 130 can be located equidistant along the wire 101 from the midpoint. The wire 101 having the biconcave shape may be in contact with a lingual side (e.g., side facing the tongue, etc.) of the plurality of teeth. The wire 101 having the biconcave shape may be used in maxillary expansion (e.g., widening upper jaw, etc.) procedures.

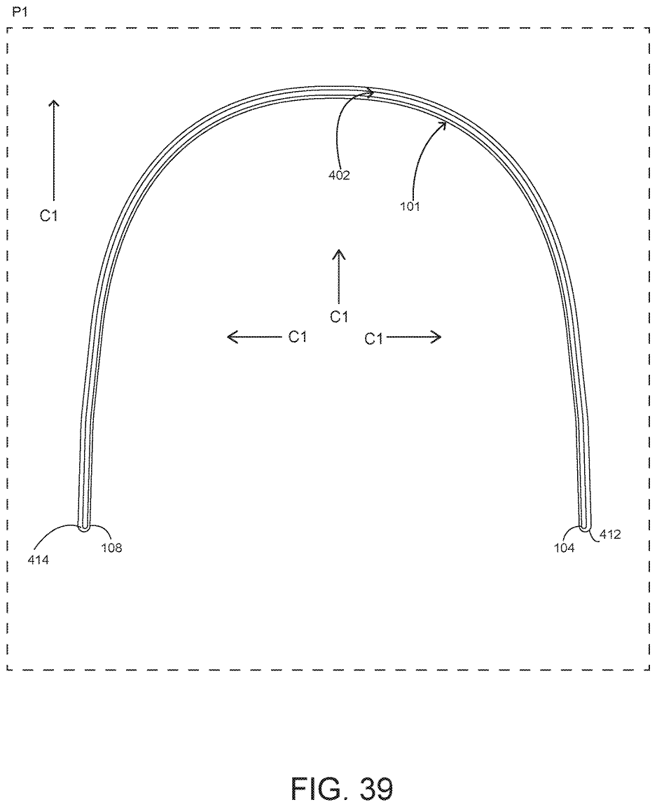

In some embodiments, the first wire 101 and the second wire 402 are coupled at both ends as seen in FIG. 39. For example, the first end 104 is coupled to the first end 412 and the second end 108 is coupled to the second end 414. In some embodiments, the first end 104 is contiguous with the first end 412 and the second end 108 is contiguous with the second end 414. In this case, the second wire 402 is thicker than the first wire 101. The system 100, in these embodiments, may be used to intrude (e.g., move teeth towards a bone socket, etc.) the teeth. The first wire 101 is connected to and in contact with the plurality of brackets 105. The second wire 402 may be located above the plurality of brackets 105.

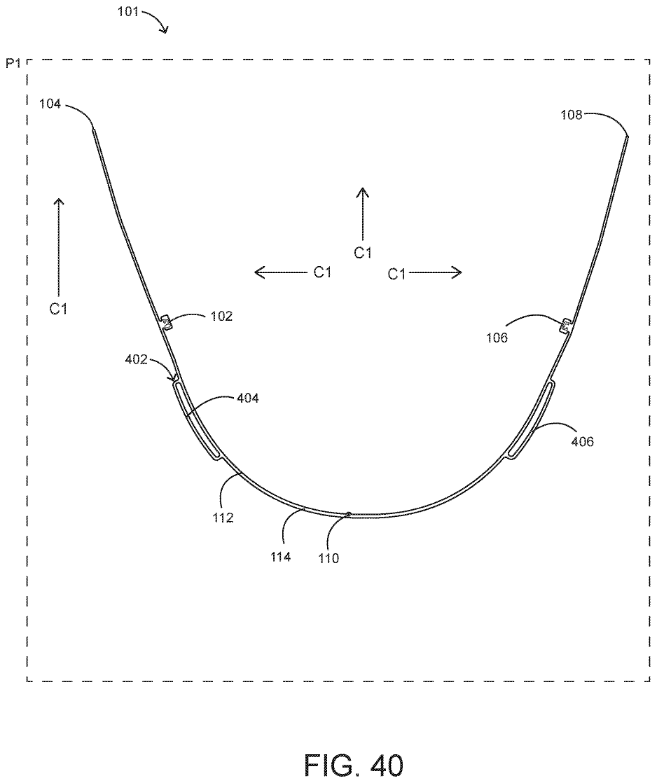

In some embodiments, the first portion 404 has a length less than the wire 101 and is located between the first end 104 and the midpoint as seen in FIG. 40. The second portion 406 has a length less than the wire 101 and is located between the second end 108 and the midpoint. The first portion 404 may have a length equal to the second portion 406. In some embodiments, a length of the first portion 404 is different than a length of the second portion 406. These embodiments of the system 100 may also be used to intrude the teeth, such as specific teeth like the canine.

In some embodiments, the first identifier 102 is not located at the first end 104 and/or the second identifier 106 is not located at the second end 108 as seen in FIG. 40. The first identifier 102 may be located between the first end 104 and the midpoint. The second identifier 106 may be located between the second end 108 and the midpoint. The first identifier 102 and the second identifier 106 may have a square and/or rectangular shape. The first identifier 102 and the second identifier 106 may have a circular shape. The first identifier 102 and the second identifier 106 may extend from the wire 101. The first identifier 102 and the second identifier 106 may identify whether the wire 101 is designed for the upper or lower arch.

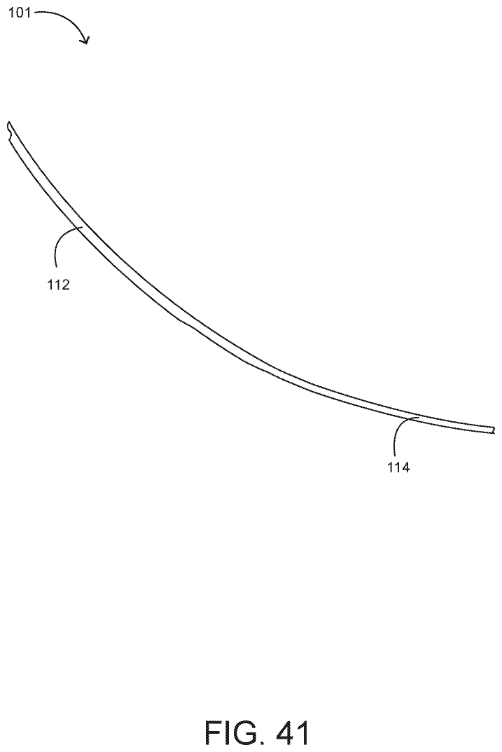

In some embodiments, the varying thickness of the wire 101 is at least one of step wise and/or gradual. For example, as seen in FIG. 41, the changes in thickness between, for example, the first location 112 and the second location 114 occur at an angle between 60 to 100 degrees, inclusive. As seen in FIG. 41, the changes in thickness are gradual over a length of the wire 101.

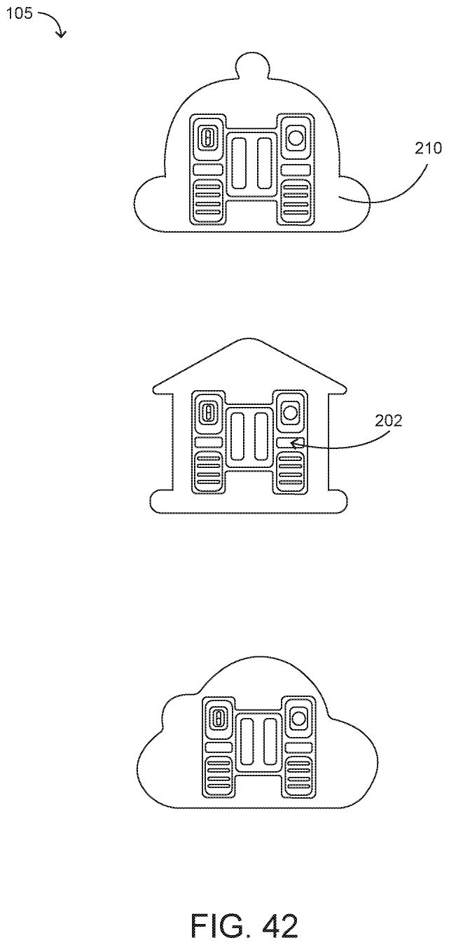

In some embodiments, as seen in FIG. 42, each of the plurality of brackets 105 can include a backing 210. The backing 210 are in direct contact with and coupled to the plurality of teeth. The backing 210 adheres the plurality of brackets 105 to the plurality of teeth. The backing 210 is integrated with each of the plurality of brackets 105. Each of the plurality of brackets 105 may extend from the backing 210. In some embodiments, the backing 210 is coupled to the plurality of brackets 105. The backing 210 can have various shapes. For example, the backing 210 can have a hat, bell, house, star, fish, butterfly, flower, heart, circle, cloud, letter (e.g., “s”, etc.), or state (e.g., Texas, etc.) shape, among others. In some embodiments, the plurality of brackets 105 includes a hook (not shown). The plurality of treatment members 103 may attach to the hook. For example, the hook extends through the aperture 358 of the plurality of rings 356. The hook can also extend through the aperture 354 of the closing spring 346 as well as the aperture 344 of the link 334. The hook may provide enhanced securement compared to the plurality of slots 202 for the aperture 358, the aperture 354, and the aperture 344.

In some embodiments, the plurality of slots 202 can include a first slot and a second slot. The first slot can receive the first wire 101 and the second slot can receive the second wire 402. In some embodiments, the plurality of slots 202 are tubes. In this case, the wire 101 is received in and extends through the tube. The plurality of slots 202 can include one or more tubes. For example, the first wire 101 extends through a first tube, the second wire 402 extends through a second tube, and the third wire 410 extends through a third tube. The plurality of brackets 105 can include any number of slots and/or tubes to receive at least one of the first wire 101, the second wire 402, the third wire 410, and/or the plurality of treatment members 103.

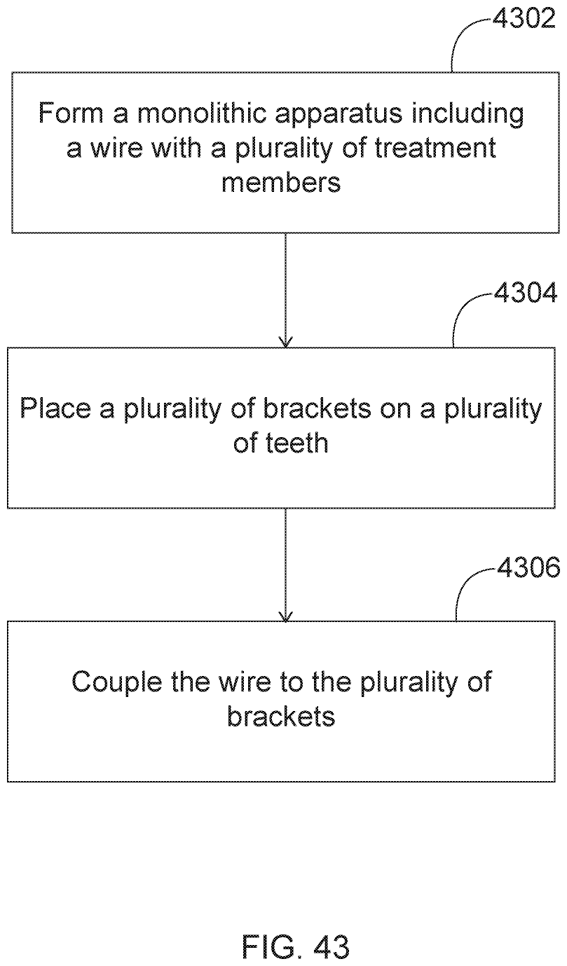

FIG. 43 depicts a method 4300 of forming and applying a wire with treatment members to a patient. At block 4302, a monolithic apparatus is formed. The monolithic apparatus can include a wire (e.g., the wire 101) and the plurality of treatment members 103 (e.g., the hooks 302, the loops 308, the first protrusions 314, the second protrusions 316, the aligners 318, the first markers 328, the second markers 330, and/or the links 334). The monolithic apparatus can be formed on a single plane. The monolithic apparatus can be formed from a sheet including a metallic material. The monolithic apparatus can be formed by at least one of laser cutting, water jet cutting, stamping, and/or electric discharge machining of the sheet. The metallic metal can be NiTi. The monolithic apparatus can also be 3D printed. At block 4304, a plurality of brackets (e.g., the plurality of brackets 105) are placed on a plurality of teeth of a patient. The plurality of brackets can be coupled to the plurality of teeth by, for example, an adhesive. At block 4306, the wire is coupled to the plurality of brackets. The wire can be coupled by, for example, placing the wire in a plurality of slots (e.g., the plurality of slots 202) of the plurality of brackets. The plurality of brackets can be tightened to maintain the wire within the plurality of slots. The wire can also be coupled to the plurality of brackets via the O-rings 107.

In some implementations, the system 100 is designed (e.g., customized, created, etc.) per patient using a machine learning model using a computing system. The machine learning model can translate verbal commands (e.g., words, etc.) from a doctor (e.g., orthodontist, etc.) into the system 100. For example, responsive to the doctor providing verbal commands that a gap between teeth should be closed, the machine learning model can process the verbal command and design the system 100 to include at least one loop 308. The machine learning model can leverage advanced algorithms (e.g., artificial intelligence (AI), machine learning, deep neural networks, etc.) to process verbal commands and convert the verbal commands into the system 100 to achieve a desired teeth arrangement for the patient. The machine learning model can also include patient records and a target alignment of teeth to generate configurations of the system 100 such as locations of the plurality of treatment members 103 or thicknesses of the wire 101. The machine learning model can use supervised learning and receive inputs such as OTA, FTA, images, panoramic radiographs, initial cephalometric radiographs, and facial scans. The machine learning model can use the inputs to generate the configurations of the system 100. The machine learning model can be trained on alignment, sectioning, staging, attachment design, and wire sequencing. The machine learning model can customize the system 100 based on ethnicity, sex, root size (e.g., of the teeth, etc.), and/or periodontal health (e.g., health of gums, bones, etc.). An output of the machine learning model can be used to manufacture (e.g., generate, etc.) the system 100 per patient. The machine learning model can output one or more of the system 100 which can be used iteratively (e.g., over time, etc.) by the patient to correct alignment of their teeth.

In some implementations, the system 100 can include a mesh. In this case, the system 100 does not include the wire 101, the plurality of treatment members 103, or the plurality of brackets 105. The mesh can be composed of a metallic material. The metallic material can include at least one of NiTi, stainless steel, or a shape memory alloy, among others. The mesh can cover the plurality of teeth and align the plurality of teeth. The mesh can be molded (e.g., manufactured, etc.) to fit to the plurality of teeth, and a shape of the mesh can be progressively (e.g., iteratively, over time, etc.) altered to align the plurality of teeth. The mesh can be removable. The mesh can include regions with positive, negative, or zero curvature to target movement of certain teeth. The mesh can also provide uniform force to move the teeth.

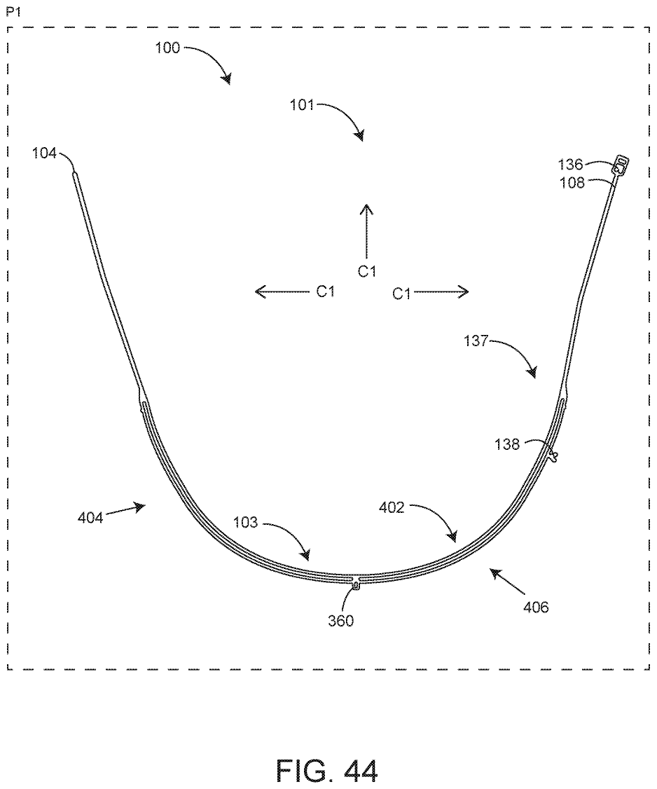

FIGS. 44-48 depict additional examples of the wire 101. Referring now to FIG. 44, the system 100 (e.g., first wire, etc.) can include the second wire 402. The second wire 402 can include the first portion 404 and the second portion 406, and the second wire 402 can extend from a point between the first end 104 and the midpoint of the wire 101, and a point between the second end 108 and the midpoint of the wire 101. Consequently, the second wire 402 may not contact the first end 104 or the second end 108. The point at which the second wire 402 extend from the wire 101 can have a thickness along the first direction C1 that is greater than a thickness of the wire 101. The second wire 402 can be continuous with and coupled to the wire 101.

The system 100 can include treatment members 103 (e.g., first treatment member 103, etc.) including a first tab 360 (e.g., indicator, marker, etc.). In some implementations, the system 100 and/or the wire 101 includes the first tab 360. The first tab 360 can be coupled to and extend from the wire 101, and can indicate that the wire 101 corresponds to an upper or lower row of teeth, and identify the wire 101 as, for example, but not limited to, a first, second, or third wire in a sequence of wires 101. For example, the system 100 can include multiple wires 101 per row of teeth, and the wires 101 can be sequentially coupled to the brackets 105 and taken off over a period of time to align the teeth with the wire 101, each other, the dental arch, and/or the respective upper or lower jaw. Consequently, the first tab 360 can include a number such as “1” indicating the position of a respective wire 101 in a sequence of wires 101. The first tab 360 can extend from a midpoint of the wire 101. In some implementations, the first tab 360 is integral and continuous with the wire 101. The first tab 360 can be integral with the wire 101 and can be continuous with the wire 101. The first tab 360 can be an example of the identifier of the wire 101.

The system 100 can include an identifier 136 removably coupled to the second end 108. The identifier 136 can be formed with the wire 101, and can be configured to snap or otherwise be removed from the second end 108 prior to or after coupling the wire 101 with at least one bracket 105. The identifier 136 can extend along the plane P1 and have a same thickness as the wire 101 and the first treatment members 103 in a second direction C2 perpendicular to the plane P1. The identifier 136 can include an indication identifying the wire 101, such as including a code, numerals, or any other identifier to correspond the wire 101 to, for example, but not limited to, the patient. For example, the identifier 136 can be a patient identifier.

The wire 101 can include a first side 137 which can be defined by a portion of the wire 101 extending between the second end 108 and the midpoint. The system 100 can include a first indicator 138 coupled to and extending from the first side 137 of the wire 101. In some implementations, the first indicator 138 is integral with and continuous with the wire 101. The first indicator 138 can indicate an orientation of the wire 101. For example, the first indicator 138 can indicate that the first side 137 is intended to couple to a left side of a row of teeth (e.g., left from a perspective of the patient, etc.). A clinician can use the first indicator 138 to orient the wire 101 such that features of the wire 101 such as thicknesses and treatment members 103 align with the teeth the wire 101 was formed for to move and align.

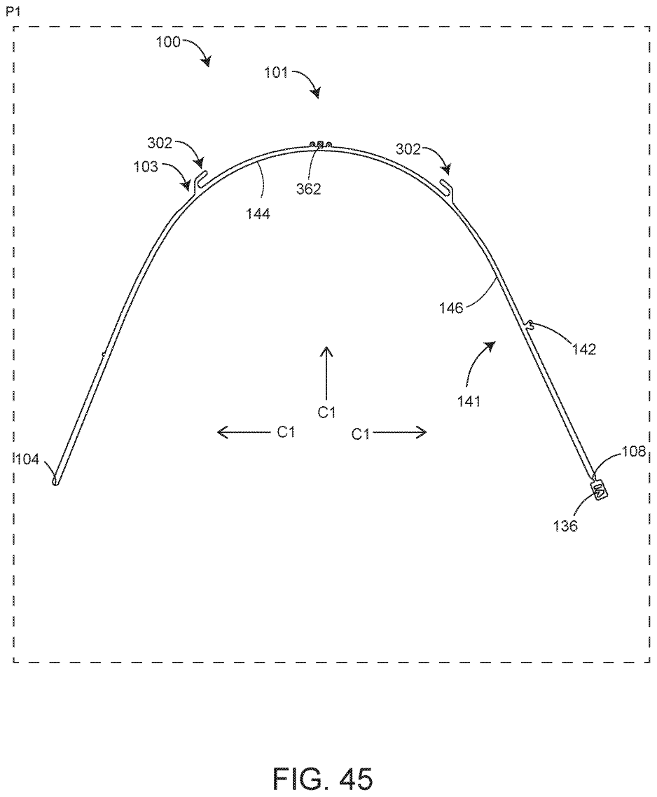

The system 100 can include a first wire 101 and a second wire 101. For example, FIG. 44 depicts the first wire 101, and FIG. 45 depicts the second wire 101. The second wire 101 can extend along a second plane. The second wire 101 can be configured to couple to a set of brackets 105 on row of teeth opposite the first wire 101. For example, the first wire 101 can be configured to couple to the upper or lower row of teeth, and the second wire 101 can be configured to couple to the row of teeth opposite the first wire 101. The second plane can be parallel to the first plane P1 and in some implementations, is angled relative to the first plane P1. The first wire 101 including the first tab 360 can indicate that the first wire 101 is to be coupled to brackets 105 coupled to the lower row of teeth. The system 100 can include second treatment members 103 coupled to and continuous with the second wire 101 and extending along the second plane. The second wire 101 and the second treatment member 103 can have a same thickness in a direction (e.g., third direction, etc.) perpendicular to the second plane.

The second treatment members 103 can include at least two second tabs 362. The second tabs 362 can be coupled to and extend from the second wire 101, and can indicate that the second wire 101 is to be coupled to brackets 105 coupled to an upper row of teeth. In some implementations, the first tab 360 indicates the upper row of teeth and the second tabs 362 indicate the lower row of teeth. The second tabs 362 including at least two second tabs 362 differentiates the second wire 101 from the first wire 101, and can indicate that the second wire 101 is to be coupled to the lower row of teeth via the brackets 105. In some implementations, the second tabs 362 include three second tabs 362. In some implementations, the second tabs 362 are integrated with and continuous with the second wire 101. The second tabs 362 can include an identifier that identifiers the second wire 101 in a sequence of wires. For example, the second tabs 362 can include an identifier such as “1” that indicates that the second wire 101 is a first second wire 101 in a sequence of second wires 101. The second tabs 362 can be an example of an identifier of the second wire 101.

The second wire 101 can include a second side 141. The second side 141 can be aligned with the first side 137. For example, both the second side 141 and the first side 137 can correspond to and are to be coupled to a left hand side of the teeth. The system 100 can include a second indicator 142 coupled to and extending from the second side 141. The second indicator 142 can have a same shape as the first indicator 138, and the second indicator 142 and the first indicator 138 can both indicate that the respective second side 141 and first side 137 are to be coupled to a left hand side of the teeth of the patient. The system 100 can include the identifier 136 coupled to the second end 108 of the second wire 101, and the identifier 136 can identify the patient corresponding to the second wire 101 (e.g., patient for which the second wire 101 was formed for, etc.).

The system 100 of FIG. 45 can include one or more hooks 302 continuous with the second wire 101, such as a first hook 302 and a second hook 302. The second wire 101 can include one or more portions, including a first portion 144 and a second portion 146. The first portion 144 can include the first location 112 and the second portion 146 can include the second location 114. The first portion 144 can have a first thickness along the first direction C1 and the second portion 146 can have a second thickness along the first direction C1. The second thickness can be greater than the first thickness. The first portion 144 can be directly coupled to and in contact with a bracket 105 different from the bracket 105 the second portion 146 is directly coupled to and in contact with. As a result, the second portion 146 can impart a different amount of force onto the tooth the respective bracket 105 is coupled to compared to the first portion 144, such as a greater amount of force. Different portions of the wire 101 with different thickness can impart different forces onto teeth to align the teeth with the wire 101, each other, or with a respective arch.

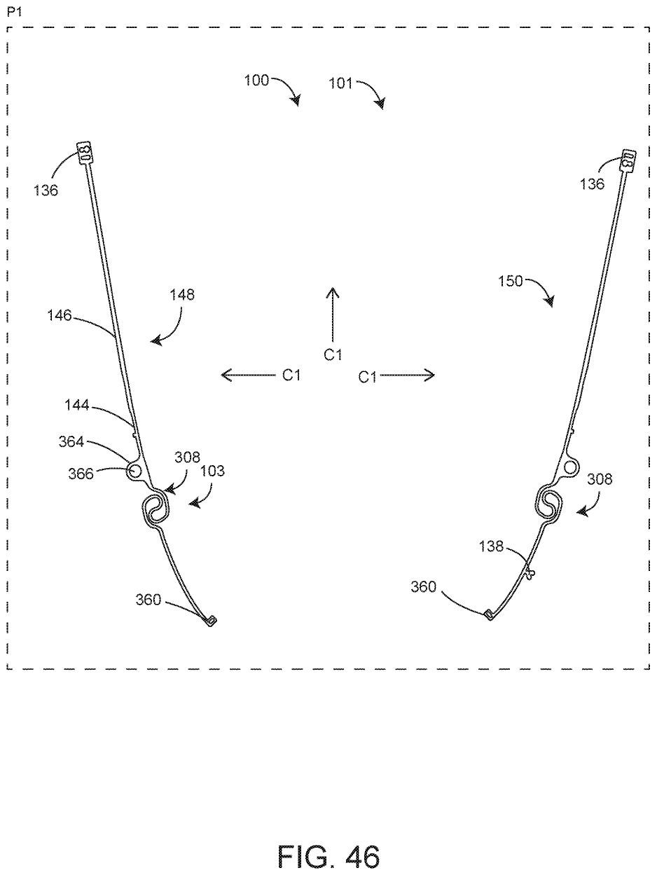

In some implementations, as shown in FIG. 46, the wire 101 may not extend around an entire arch. In other implementations, the wire 101 can extend along an arch. For example, the wire 101 includes first portion 148 and a second portion 150. The second portion 150 can be separate from the first portion 148. The identifier 136 can be removably coupled to both the first portion 148 and the second portion 150. Both the first portion 148 and the second portion 150 can include the treatment members 103 including the loop 308. At least the first portion 148 can include the first portion 144 and the second portion 146 where a thickness of the second portion 150 along the plane P1 is greater than a thickness of the first portion 148. The system 100 can include the first indicator 138 extending from and coupled to the second portion 150. Consequently, the second portion 150 can be intended to couple to brackets 105 on a left hand side of a mouth of the patient.

The system 100 of FIG. 46 can include the first tabs 360. For example, the first tabs 360 can be coupled to both the first portion 148 and the second portion 150, and can indicate that the first portion 148 and the second portion 150 are a first wire 101 in a series of wires for the lower row of teeth of the patient for alignment. The first tabs 360 can be coupled to an end of the first portion 148 and the second portion 150, respectively, opposite an end that the identifiers 136 are removably coupled to. The treatment members 103 can also include an extension 364 defining an aperture 366. The extension 364 can extend from the wire 101, and can be used as an attachment point for an elastic or power chain, as a stop or retaining feature to mitigate the wire 101 from sliding out of the brackets 105, as an adjustment feature to adjust or otherwise change a shape of the loop 308, or to engage with another component of the system 100, such as the bracket 105, a tube, or any other component.

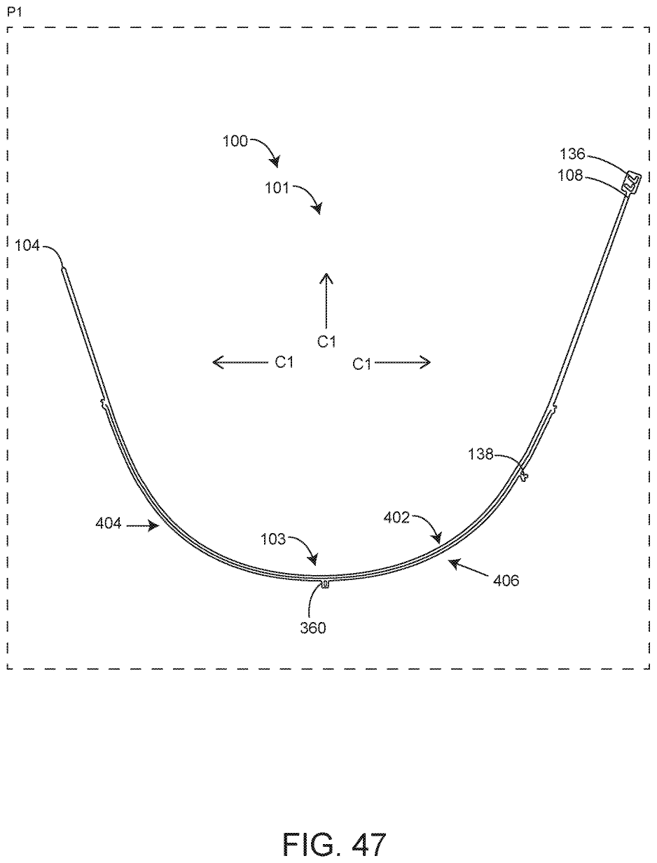

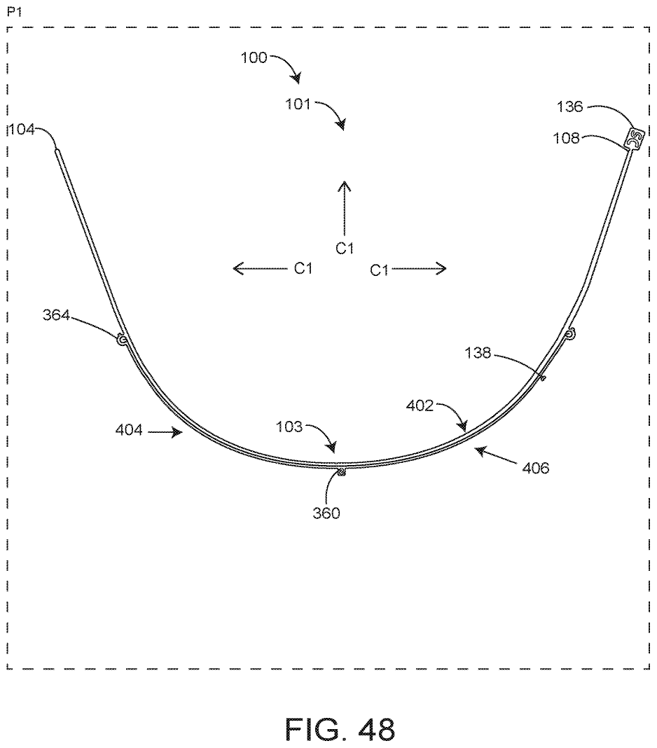

Referring now to FIGS. 47-48, the system 100 can include multiple wires 101 with a first wire 101 shown in FIG. 47 and a second wire 101 shown in FIG. 48. The treatment members 103 of the first wire 101 includes the first tab 360 which can indicate that the first wire 101 is a first wire 101 in a series of wires 101. For example, the system 100 can include a plurality of wires 101 that are to be attached in sequence to brackets 105 on an upper row of teeth to progressively align the teeth of the patient over time. The treatment members 103 of the second wire 101 can include the first tab 360 that indicates that the second wire 101 is a second wire 101 in the series of wires 101.

The second wire 101 can be different from the first wire 101. For example, the extension 364 extends from the second wire 101 but may not extend from the first wire 101. In addition, a length of the second wire 101 may be different from a length of the first wire 101. Both the first wire 101 and the second wire 101 can include the second wire 402, but a length of the second wire 402 may differ between the first wire 101 and the second wire 101. The second wire 101 can apply different forces and manipulate the teeth of the patient different from the first wire 101 to iteratively and progressively align the teeth of the patient.

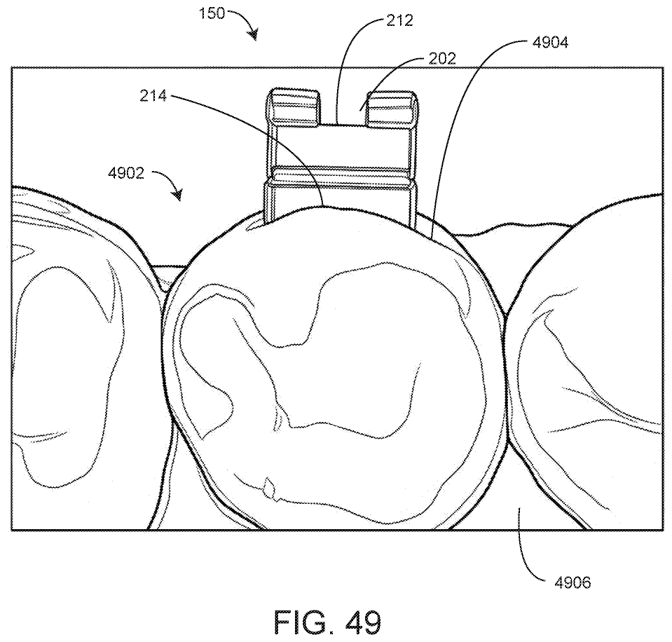

Referring now to FIG. 49, the brackets 105 can include a first surface 212 and a second surface 214 opposite the first surface 212. In implementations where the brackets 105 include the backing 210, the second surface 214 can include the backing 210. The second surface 214 can be directly coupled to and directly in contact with at least one tooth 4902 of the patient. As shown in FIG. 49, the second surface 214 can have a shape matching an outer surface 4904 of the tooth 4902. The outer surface 4904 can be at least one of a labial or lingual side of the tooth 4902. The bracket 105 can be formed based on a shape of the outer surface 4904 of a respective tooth 4902 such that the second surface 214 has a shape that mates with and matches the outer surface 4904 such that the second surface 214 conforms to and fits with the respective tooth 4902. The first surface 212 can include or otherwise define the slot 202. The wire 101 can extend along the first surface 212, such as by extending through the slot 202.

For example, the bracket 105 can be formed via additive manufacturing and can be formed from a material including a metallic material. To contour and shape the second surface 214 to the outer surface 4904, the bracket 105 can be formed using data of the patient. For example, a 3D or other scan can be taken of the teeth of the patient, and the data can be used to form the wire 101, the treatment members 103, and the brackets 105. In some implementations, a computing system receives data corresponding to the teeth 4902 of the patient. For example, the computing system can receive a three-dimensional scan, radiographic scan, or any other scan of the teeth 4902 of the patient where the data indicates shapes of and positions of the teeth 4902. The computing system can generate a model of the bracket 105 and the wire 101 using the data such that the bracket 105 has the shape that matches and mates with a respective tooth 4902. The model can be used to form the bracket 105, the wire 101, and the treatment members 103 for the patient.

The second surface 214 having a contour and shape that matches the outer surface 4904 of the respective tooth 4902 the bracket 105 is to couple to reduces micro movements of the bracket 105 while the wire 101 is applying force, makes force application more predictable in response to force transferring from the wire 101 to the tooth 4902, reduces adhesive failure and improves bond strength, and reduces stress concentrations.

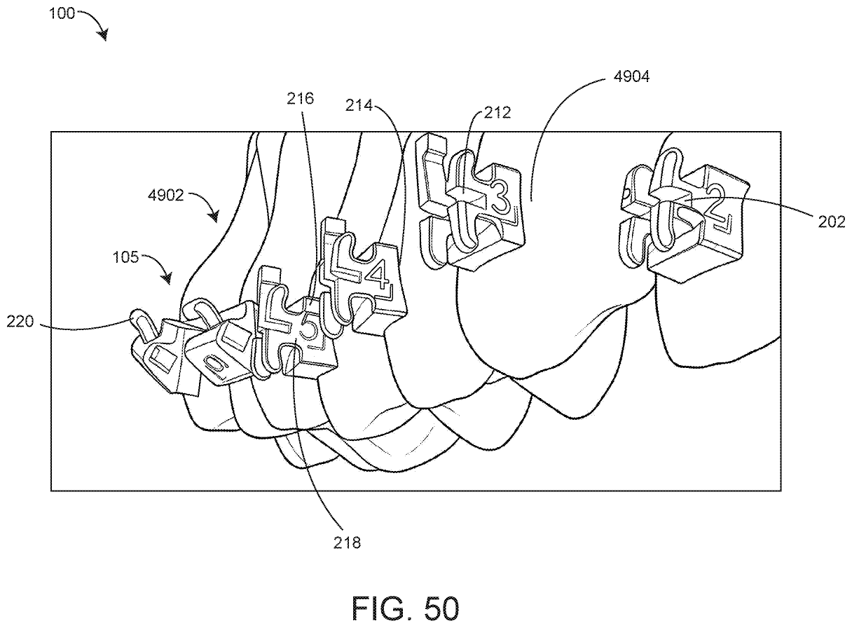

The brackets 105 can include a third surface 216 contiguous with the first surface 212 and the second surface 214. For example, the third surface 216 can extend between and connect the first surface 212 and the second surface 214. In some implementations, the third surface 216 can at least partially face a distal surface (e.g., away from center of mouth or teeth 4902, etc.) of the tooth 4902 and gingiva 4906 (e.g., gums, etc.). For example, the third surface 216 can be a disto-gingival surface of the bracket 105. The bracket 105 can include a label 218 corresponding to the tooth 4902 for the respective bracket 105 to be coupled to. The label 218 can be located, such as etched into or otherwise attached to the third surface 216. For example, as shown in FIG. 50, each of the brackets 105 coupled to respective teeth 4902 can include a respective label 218 with a numerical indicator indicating which tooth 4902 the bracket 105 is to be coupled to. In addition, as shown in at least FIG. 50, the brackets 105 can include tubes 220 instead of slots 202. In some implementations, the back most teeth 4902, such as L5s can include brackets 105 including tubes 220. In some implementations, at least a subset of the brackets 105 can include hooks, such as hooks that can allow for elastic bands to attach to.

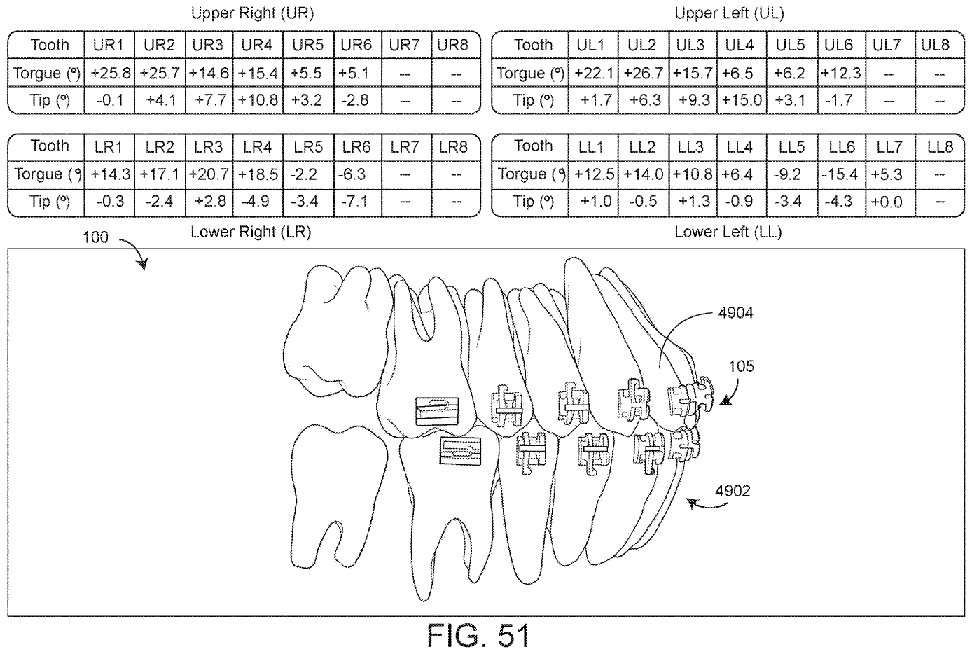

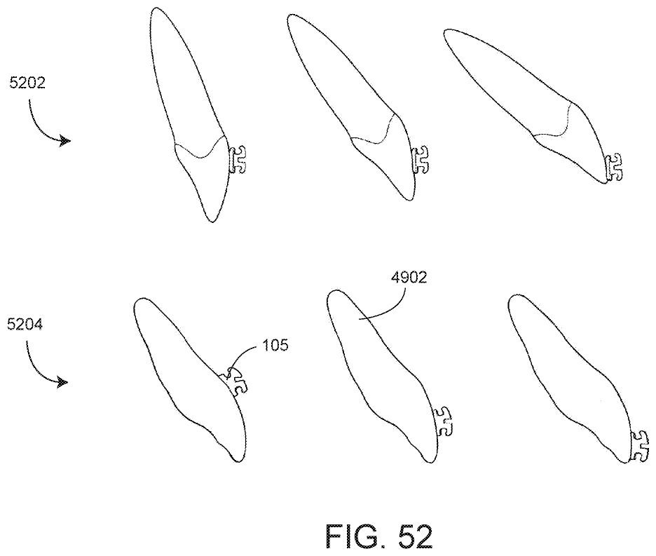

As shown in FIGS. 51-53, each tooth 4902 can be assigned and determined a degree of torque (e.g., labiolingual or buccolingual inclination, etc.) and a degree of tip (e.g., mesiodistal angulation, etc.) according to at least the data. Based at least on the torque and tip, one or more models, a user, or any other entity can determine a placement of the brackets 105 on each respective tooth 4902 and a thickness of the wires 101 as well as placement of treatment members 103. The torque and tip can be used to determine the placement of brackets 105 to mitigate the brackets 105 from contacting each other during the course of teeth 4902 alignment. In some implementations, a computing system can receive the data and determine the placement of the brackets 105 based at least on the torque and tip using one or more models.

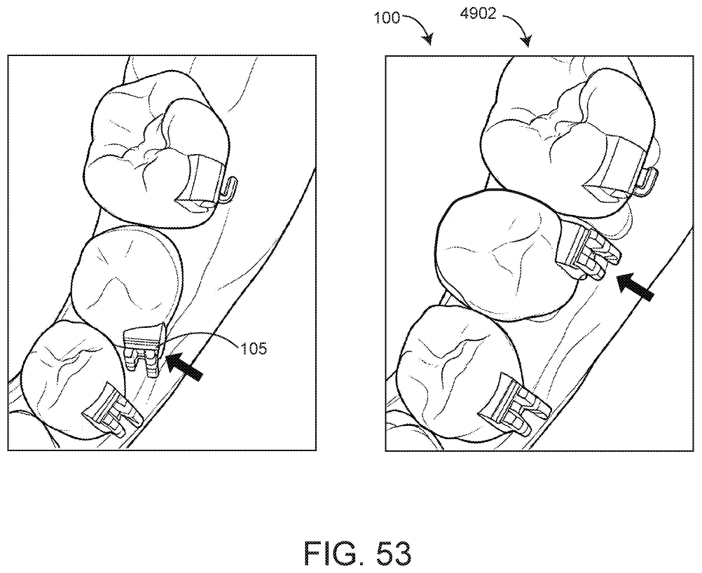

In some systems such as those shown in row 5202, torque control is dictated by bracket placement. As shown, placing the bracket more towards an end of a tooth may cause greater angular force to be applied. In contrast, the force applied by the bracket 105 is not dependent on a position of the bracket 105 on the tooth 4902, which can allow for greater flexibility and granularity of control and force application. For example, the bracket 105 can be placed on a number of positions of the tooth 4902 without affecting the applied force, thereby allowing for greater customization and mitigating brackets 105 from contacting each other. For example, as shown in FIG. 53, the bracket 105 can be repositioned to mitigate collision with an adjacent tooth 4902 which may cause damage to the bracket 105 or wire. The bracket 105 can thus be moved along the outer surface 4904 to mitigate collision of the bracket 105 with other brackets 105 or with teeth 4902.

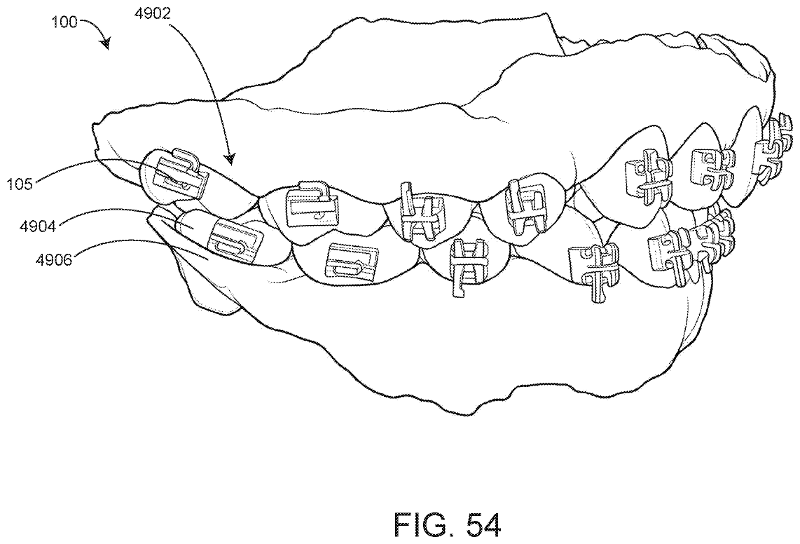

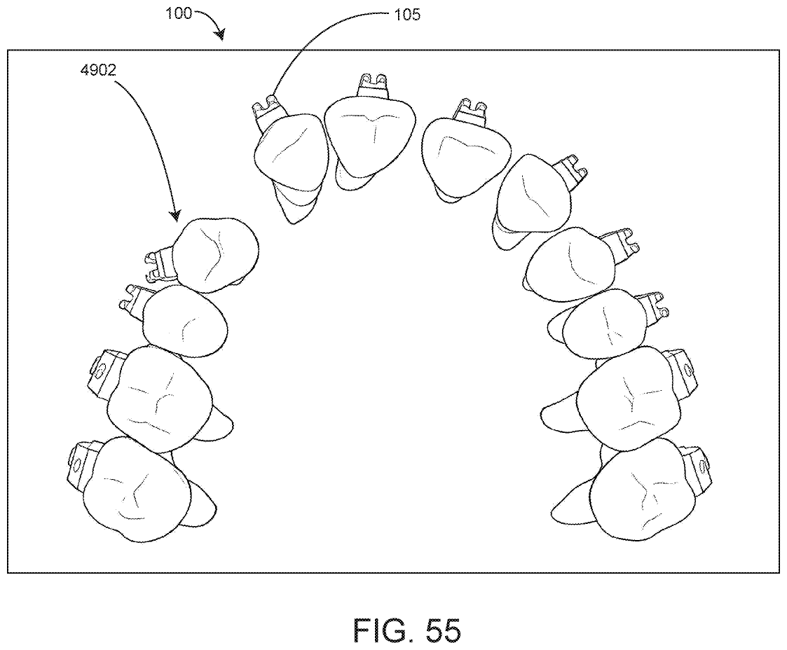

In addition, as shown in FIG. 54, a height of the brackets 105 with either tubes 220 or slots 202 can have a height that mitigates contact with and irritation of the gingiva 4906. In some implementations, a canine may be moved into a position where a lateral incisor would typically be located, such as in situations where a lateral incisor is missing or removed. In such implementations, such as those shown in FIG. 55, the bracket 105 to attach to the canine can be formed such that the slot 202 or the tube 220 configures the wire 101, once attached to the bracket 105 to move the canine like a lateral incisor since torque applied on a canine tooth 4902 may be different from a lateral incisor tooth 4902. The second surface 214 of the bracket 105 can be formed to match the outer surface 4904 of the canine while having a position and slot 202 or tube 220 configuration that allows the wire 101 to apply a force corresponding to a lateral incisor. In some implementations, elastic bands or other devices can hook onto the tube 220.

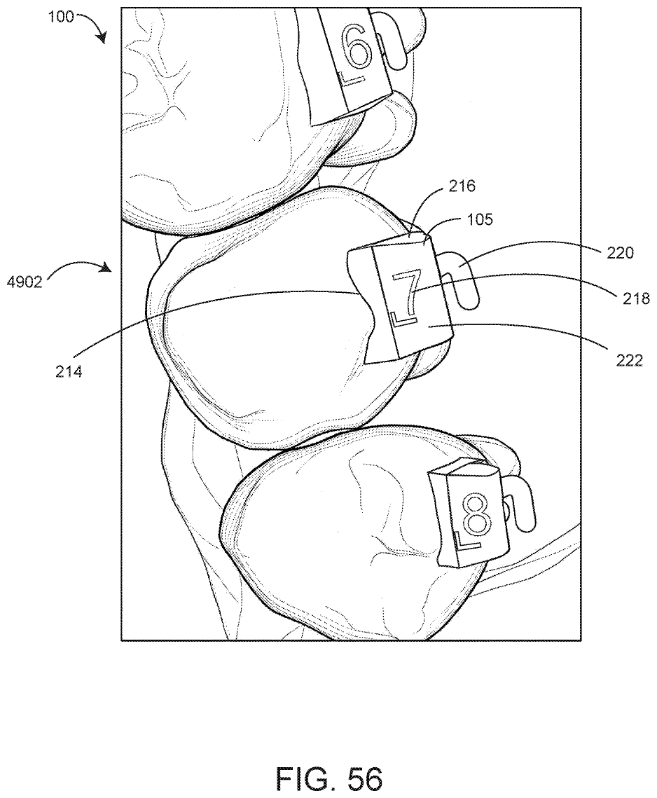

In some implementations, such as those shown in FIG. 56, the bracket 105 includes the tube 220. In such implementations, the label 218 can be located on a surface other than the third surface 216. For example, the bracket 105 can include a fourth surface 222 contiguous with the first surface 212, the second surface 214, and the third surface 216. The fourth surface 222 can face away from or towards the gingiva 4906. The label 218 can be located on the fourth surface 222.

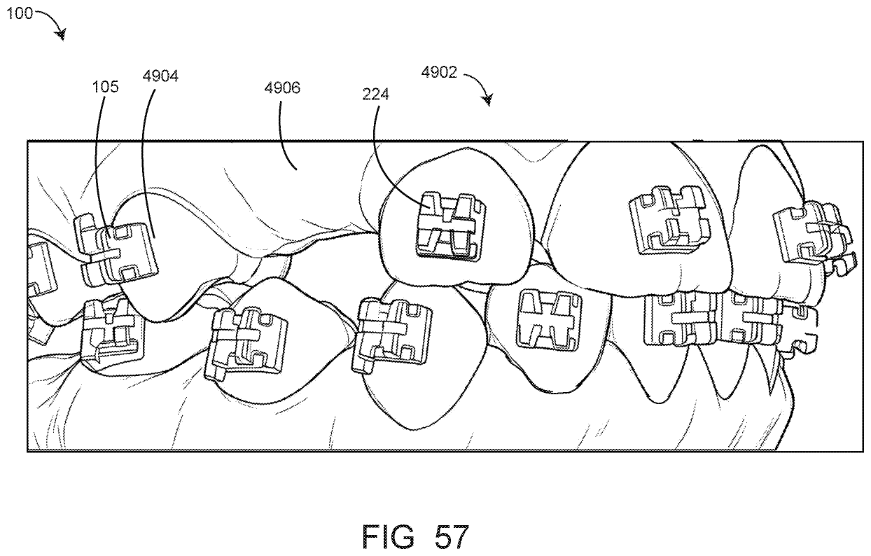

In some implementations, the brackets 105 can include a marker 224 on the first surface 212 as shown in FIG. 57. For example, the marker 224 can be engraved or otherwise coupled to the first surface 212. The marker 224 can be located on a distogingival side of the first surface 212, such as a position adjacent to the third surface 216. The marker 224 can indicate the distogingival side of the first surface 212 to facilitate orientation and coupling of the bracket 105 to the tooth 4902.

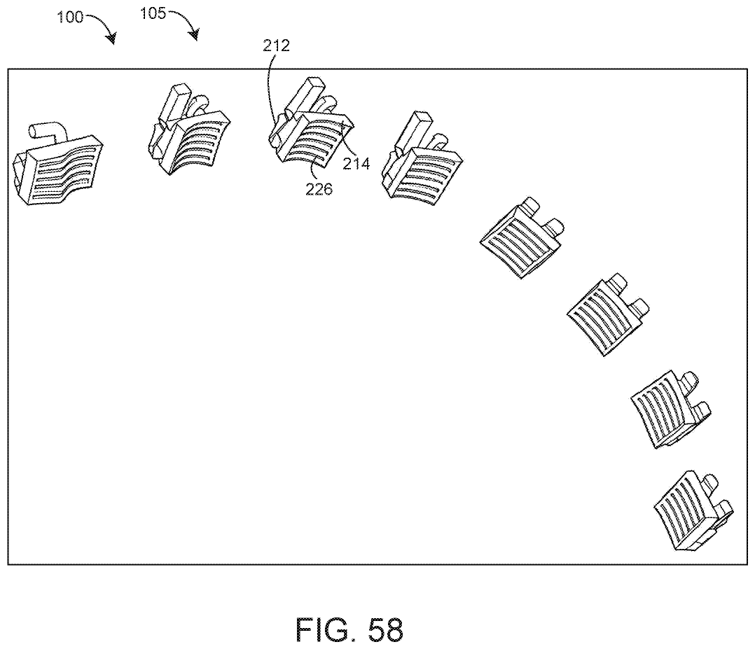

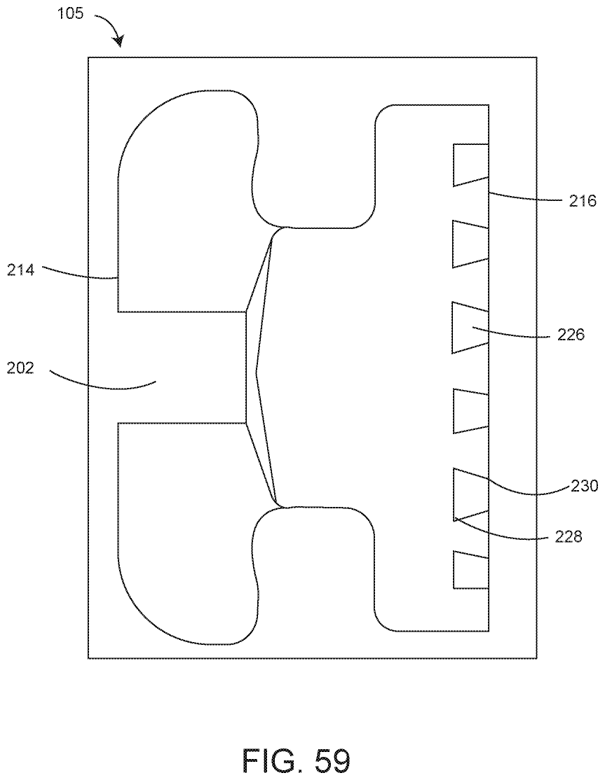

As shown in FIGS. 58-59, in some implementations, to improve bond strength between the bracket 105 and the tooth 4902, the second surface 214 can define a plurality of grooves 226. The grooves 226 can enhance the coupling and bond between the bracket 105 and the tooth 4902 by improving resistance to shear and peel forces, providing a retention feature, increasing surface area of the second surface 214, and/or distributing stress across the second surface 214. The grooves 226 can be defined by a first dimension 228 and a second dimension 230. The first dimension 228 can be defined at a location closer to the first surface 212 than the second dimension 230. The first dimension 228 can be greater than the second dimension 230. A base of the grooves 226 can have a greater surface area or dimension than an opening of the grooves 226, as shown in FIG. 59 to improve retention and adhesion.

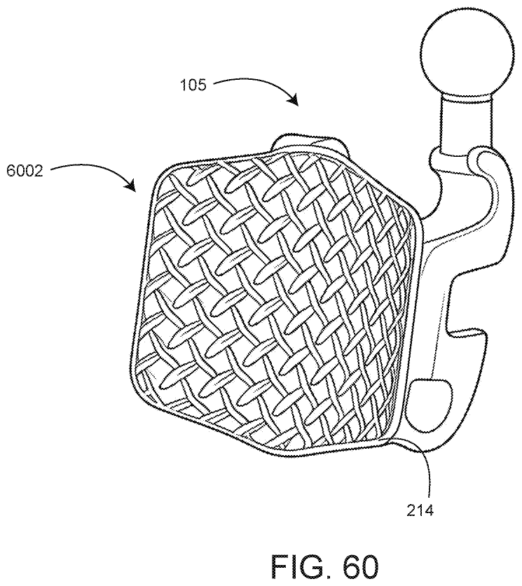

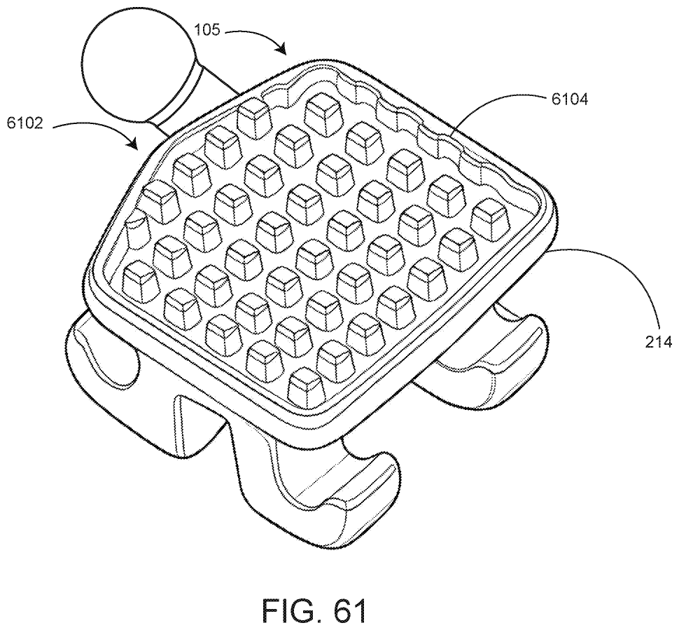

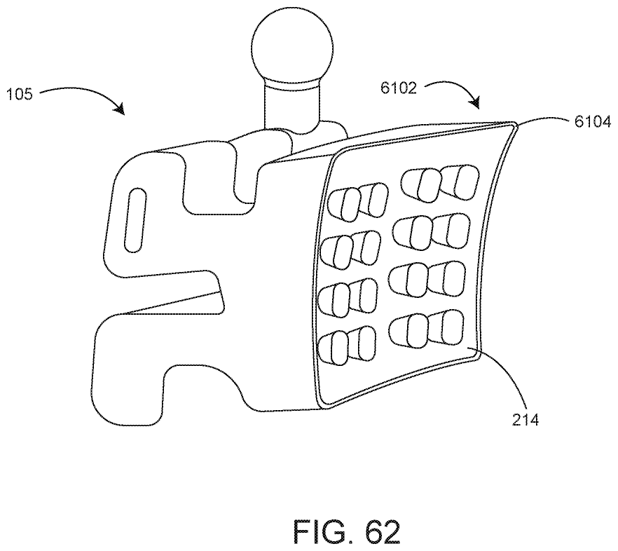

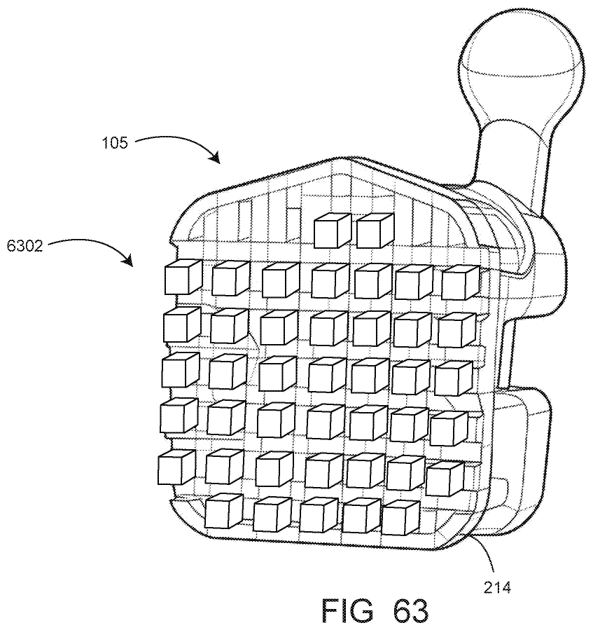

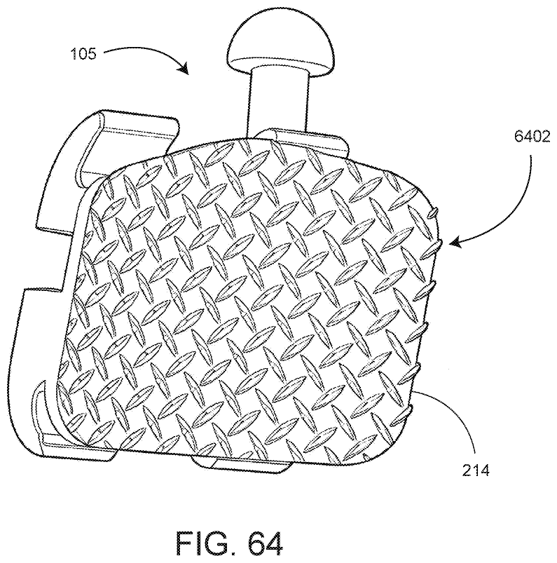

In some implementations as shown in FIGS. 60-64, the second surface 214 defines or the bracket 105 otherwise includes at least one of the plurality of grooves 226, a mesh 6002, a plurality of protrusions 6102, a wall 6104 extending around a periphery of the second surface 214, a grid 6302, or a pattern 6402 among others, to improve the bond strength between the bracket 105 and the tooth 4902. For example, the second surface 214 includes one or more features, such as the mesh 6002 that improve adhesion and bond of the bracket 105 to the outer surface 4904. In some implementations, the bracket 105 can be clear.

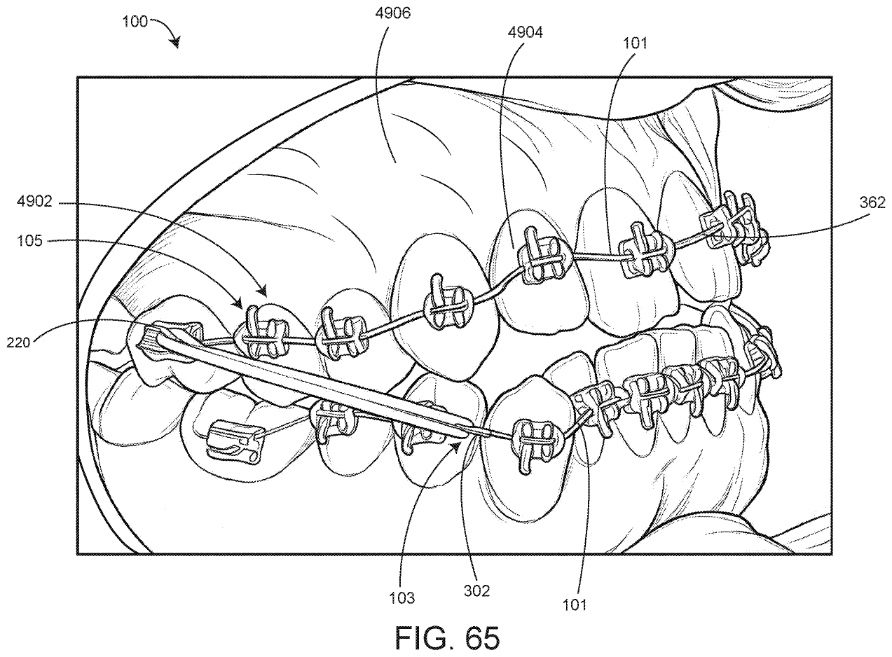

FIG. 65 depicts an example of the system 100. The system 100 can include the first wire 101 and the second wire 101. The first wire 101 can include the treatment members 103 including at least the hook 302. The system 100 can include the second tabs 362 extending from the second wire 101, indicating that the second wire 101 is to be coupled to the upper row of teeth. The bracket 105 coupled to a tooth 4902 along the upper row can include a hook which an elastic band can couple to the hook 302. For example, in some implementations, the brackets 105 can include hooks. Portions of the first wire 101 and the second wire 101 can be directly coupled to and in contact with the bracket 105 along the first surface 212 (e.g., extending through the slot 202 or tube 220, etc.), and portions of the first wire 101 and the second wire 101 can extend between the brackets 105.

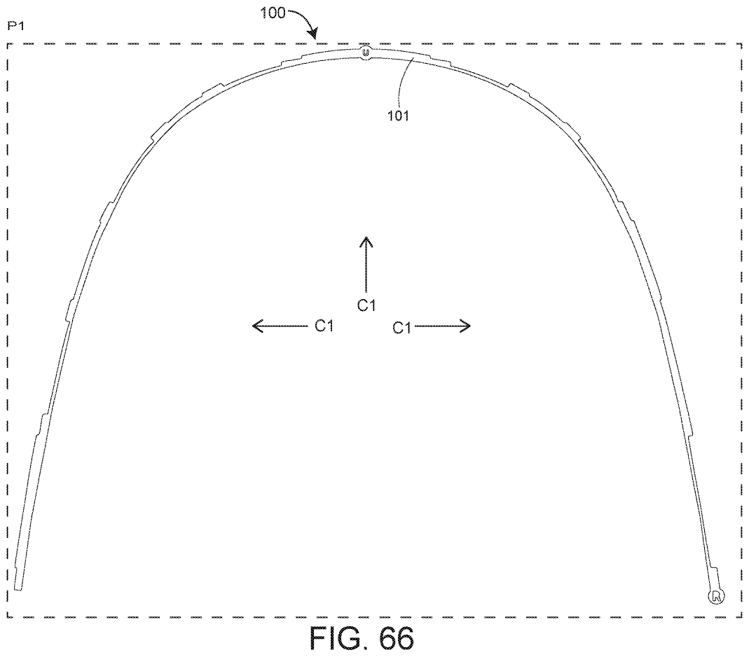

In some implementations, the wire 101 can be formed such that a thickness of the wire 101 is customized and configured to apply a force per tooth 4902. For example, as shown in FIG. 66, the wire 101 can include a number of portions (e.g., first portion 144, second portion 146, etc.) corresponding to a number of the brackets 105 to couple to the teeth 4902, and each portion of the wire 101 can have a thickness corresponding to a desired force to apply to the respective tooth 4902 to align the teeth 4902 with the dental arch.

In some implementations, a computing system can receive the data, and generate at least one of a force map or force profile, and determine thicknesses of the wire 101 accordingly. For example, the computing system can use the degree of torque and tip to determine the forces for the wire 101 to apply to the teeth 4902 to align the teeth 4902 along the dental arch and with each other, and can form data for input into, for example, a 3D printer to form the wire 101 with the determined thicknesses corresponding to the forces. Thus, the force the wire 101 applies on the teeth 4902 can be determined prior to installation on the brackets 105, and may not rely on manual bending or bending following installation on the brackets 105, thereby mitigating variability caused by manual bending and allowing for tooth-specific forces to be applied without bending again. The variations in thickness can be at least one of stepwise, gradient, polynomial, or spline-based, among others, to achieve the variations in force application as formed by, for example, but not limited to, a 3D printer.

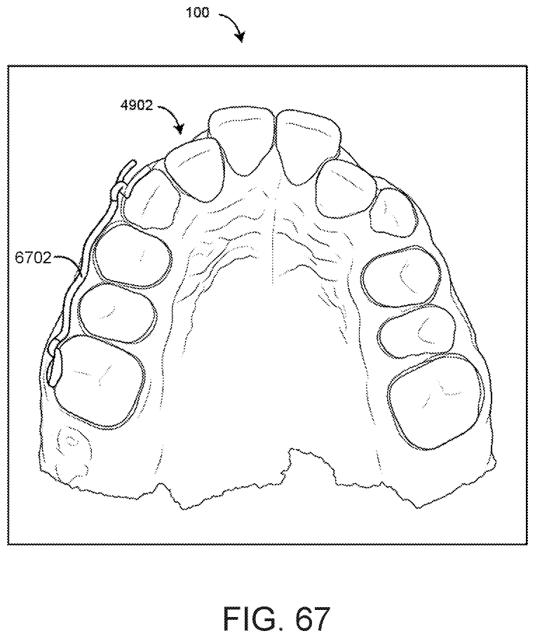

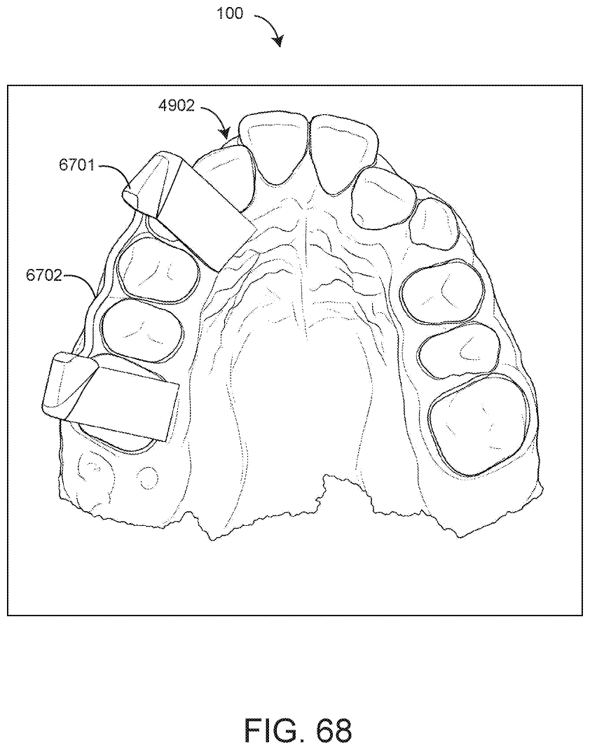

Referring now to FIGS. 67-68, in some implementations, the system 100 can include a corrector 6702. The corrector 6702 can be formed based on the data, and can be configured to correct an anteroposterior bite relationship. For example, the corrector 6702 can be coupled to the teeth 4902 and can apply a directional force for a Class II or III correction of the teeth 4902. The corrector 6702 can be coupled to the teeth 4902 using a bonding tray 6701 as shown in FIG. 68. The bonding tray 6701 can be formed based on the data and can be used to attach the corrector 6702 to the teeth 4902. For example, both the corrector 6702 and the bonding tray 6701 can be fabricated from additive manufacturing, such as 3D printing, according to the data collected from a patient such that each corrector 6702 and bonding tray 6701 is unique and customized per patient.

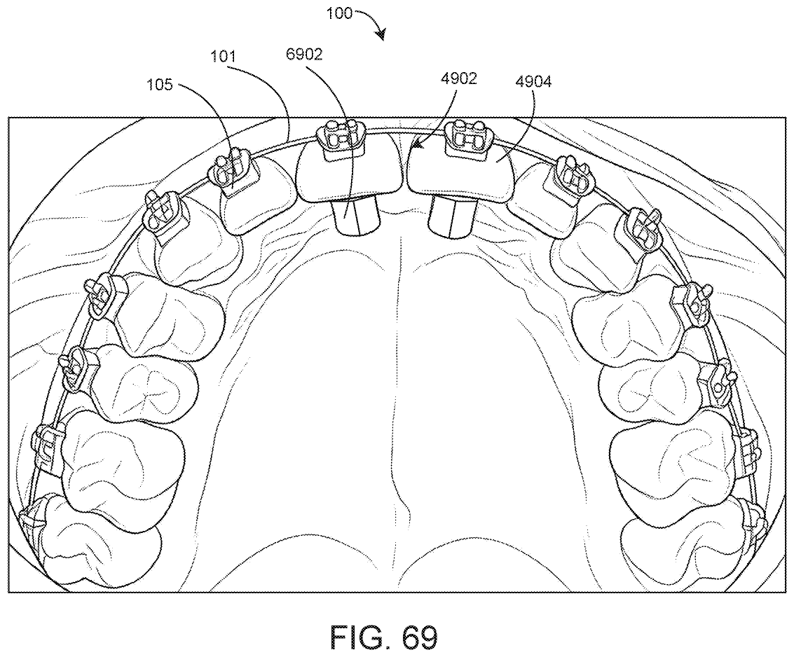

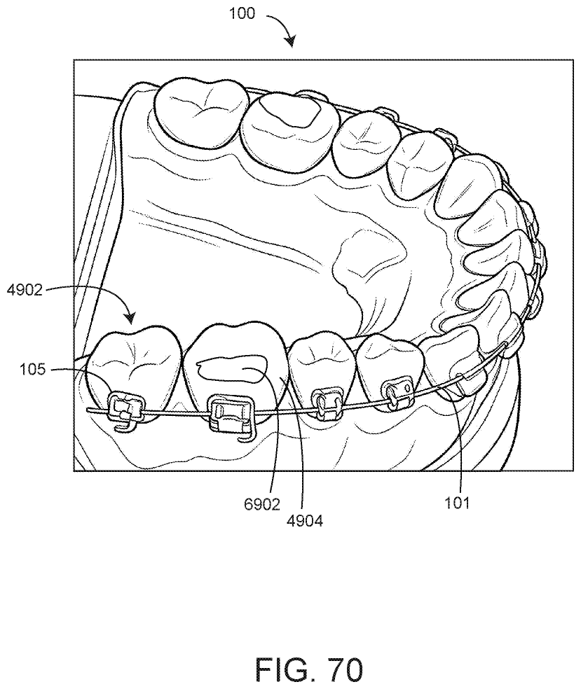

In some implementations, as shown in FIGS. 69-70, the system 100 can include one or more bite blocks 6902. The bite blocks 6902 can mitigate opposing teeth (e.g., teeth 4902 directly above another tooth 4902, etc.) from contacting the brackets 105 and causing breakage or damage to the brackets 105 by creating and providing clearance between opposing teeth. The bite blocks 6902 can be formed from a material including a metallic material, composite, ceramic, polymer, or any other biocompatible material. For example, the bite blocks 6902 can be formed from a mold including a composite or other curable material, and the mold can be placed directly on selected teeth 4902 to form the bite blocks 6902. In some implementations, the bite block 6902 can be formed by additive manufacturing, such as 3D printing in metal or any other biocompatible material and bonded to the teeth 4902.

The bite blocks 6902 can be placed on any tooth 4902 and positioned on any surface of the tooth 4902, such as the outer surface 4904, occlusal surface, or any other surface depending on the treatment and anatomy of the teeth 4902 of the patient. The bite blocks 6902 and/or the mold can be fabricated using the data of the teeth 4902 of the patient.

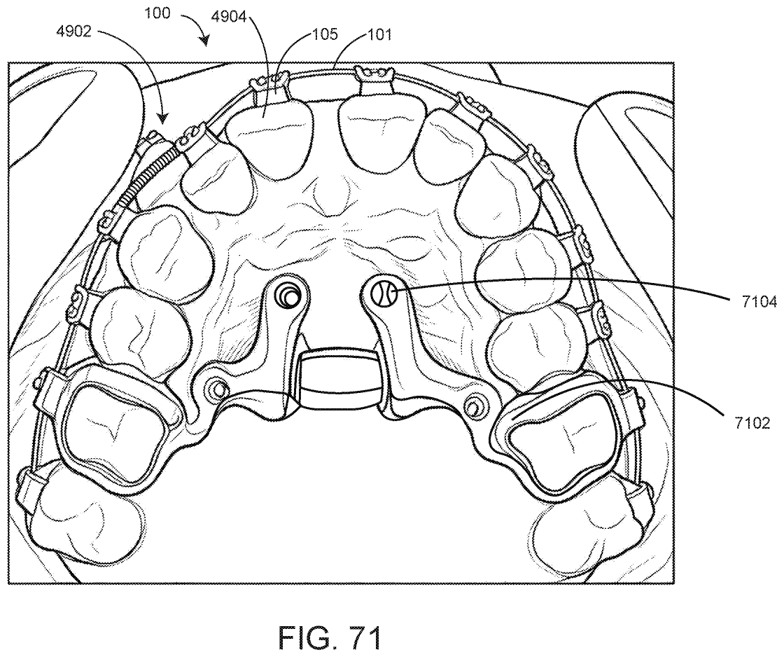

In some implementations, the system 100 can include a jaw expander 7102 as shown in FIG. 71. The jaw expander 7102 can extend around and be coupled to at least two teeth 4902 and in some implementations, coupled to the brackets 105. The jaw expander 7102 can include one or more fasteners 7104 that extend into the palate, and can be turned such that the force applied by the jaw expander 7102 onto the teeth 4902 and subsequently the respective jaw increases to expand the jaw.

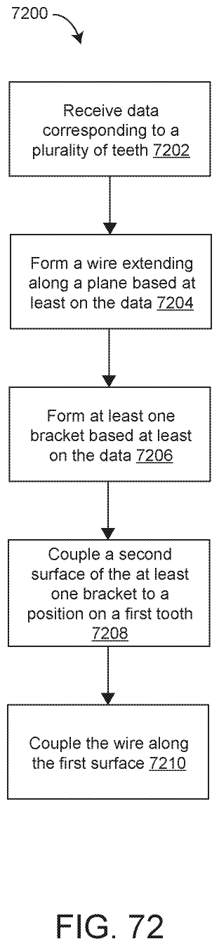

FIG. 72 is a flow diagram showing a method 7200 for forming and applying an orthodontic wire (e.g., wire 101) and bracket (e.g., bracket 105) system based on data corresponding to a plurality of teeth (e.g., teeth 4902), in accordance with some implementations of the present disclosure. The method 7200, at block 7202, can include receiving data corresponding to a plurality of teeth of a patient. The data can be collected from a clinician, such as being received by a clinician. For example, the clinician can determine data associated with the teeth, such as by taking a mold of the teeth, 3D scanning the teeth, or manually entering data. The clinician can provide the data and the data can be received by, for example, but not limited to, one or more processors.

The method 7200, at block 7204, can include forming, based at least on the data, a wire extending along a plane. In some implementations, the method 7200 can include forming at least one treatment member coupled to and continuous with the wire and extending along the plane, where the wire and the at least one treatment members have a same thickness in a direction perpendicular to the plane. In some implementations, the method 7200 can include forming the wire and the at least one treatment members as a monolithic apparatus.

In some implementations, the method 7200 can include forming the wire and the at least one treatment members from a sheet including a metallic material or formed via additive manufacturing. For example, the data can be formatted and input into 3D printer, and the wire along with the treatment members can be formed by 3D printing a metallic material.

In some implementations, the method 7200 can include determining, based at least on the data, respective forces applied to each of the plurality of teeth to align the plurality of teeth with each other. For example, the data can indicate at least one of a degree of torque or a degree of tip for each teeth of the patient, and the method 7200 can include determining a force to apply to each tooth according to the degree of torque and/or degree of tip to align the teeth with each other and the dental arch by one or more processors. In some implementations, the method 7200 can include forming the wire to include thicknesses corresponding to the respective forces, where a thickness of the wire at a first location corresponding to a first tooth is different from a thickness of the wire at a second location corresponding to a second tooth. For example, in response to determining the forces and determining the forces per tooth being different, the wire can be formed, for example, by 3D printing, with different thicknesses corresponding to the different teeth such that the wire applies force corresponding to the determined forces to align the teeth.

The method 7200, at block 7206, can include forming, based at least on the data, at least one bracket including a first surface (e.g., first surface 212) and a second surface (e.g., second surface 214) opposite the first surface, the second surface having a shape matching a shape of a first tooth of the plurality of teeth of the patient, where the at least one bracket is formed from a metallic material. In some implementations, the method 7200 can include forming the at least one bracket via additive manufacturing. For example, the data can be input into a 3D printer such that each bracket is formed to mate with and match a shape of a respective outer surface (e.g., outer surface 4904) of each respective tooth. In addition, the bracket can be formed according to the desired force application. For example, a slot (e.g., slot 202) of the bracket can be adjusted to adjust the degree of force applied to a respective tooth.

The method 7200, at block 7208, can include coupling the second surface of the at least one bracket at a position on the first tooth based at least on the data. The position can be determined such that the bracket does not contact an adjacent tooth or bracket, and can also be selected based on a direction or amount of force desired for the wire to apply.

The method 7200, at block 7210, can include coupling the wire along the first surface of the at least one bracket while the wire extends along the plane. The wire can extend along the plane prior to and after coupling the wire to the bracket. The wire can extend along the first surface by extending through at least one of a slot or tube (e.g., tube 220) of the bracket. The wire can be in direct contact with the first surface of the bracket.

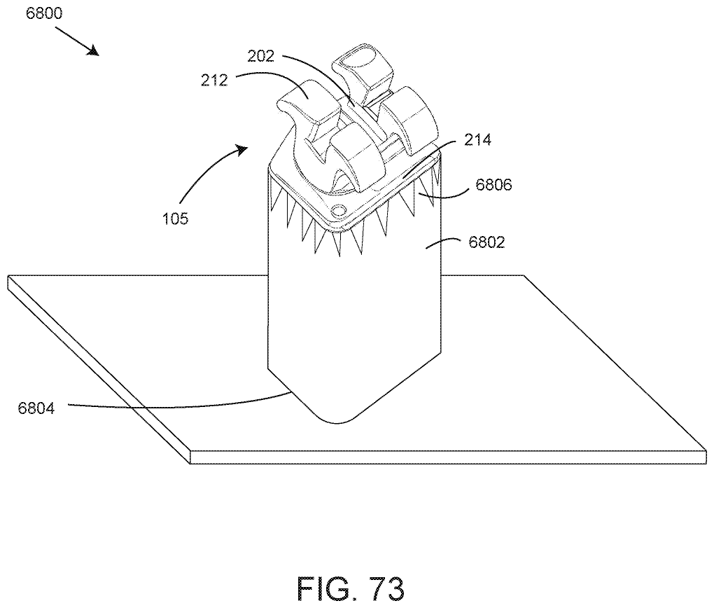

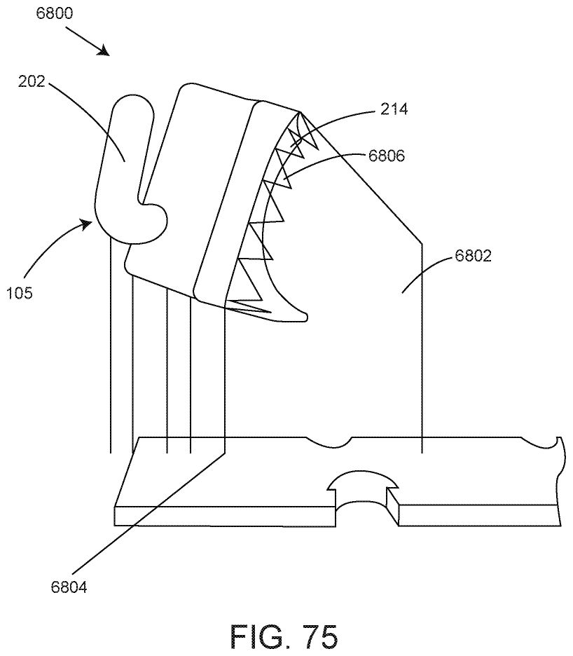

Referring now to FIGS. 73-75, in some implementations, the bracket 105 can be formed using a structure 6800 (e.g., system, apparatus, etc.). The structure 6800 can be formed via additive manufacturing, such as 3D printing. For example, the structure 6800 can be formed by 3D printing a metallic material, such as, but not limited to, stainless steel, titanium, surgical steel, or any other metallic material. A material of the structure 6800 can be same as the material used to form the brackets 105. The structure 6800 can include the bracket 105, and the bracket 105 can be formed via 3D printing using the structure 6800.

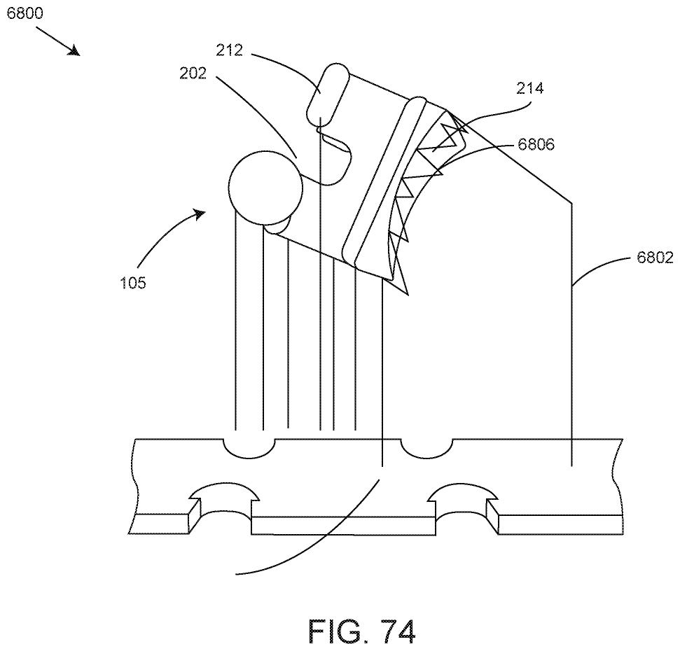

The structure 6800 can include a base 6802. The base 6802 can have a first surface 6804 and a second surface 6806 opposite the first surface 6804. The bracket 105 can be removably coupled to the second surface 6806. The brackets 105 can extend from the second surface 6806. In some implementations, the brackets 105 extend at least partially perpendicular to the second surface 6806. In some implementations, the bracket 105 extend at an angle from the second surface 6806, as shown in at least FIG. 74. The bracket 105 can be printed such that the second surface 214 of the brackets 105 match an outer surface of the teeth of the patient. For example, the structure 6800 can be printed using the data received corresponding to a patient, such as a 3D scan. Consequently, the brackets 105 can be printed according to the data such that the second surface 214 matches and mates with the outer surface of a respective tooth of the patient. For example, each of the brackets 105 can be formed to couple to a different tooth, and thus each of the second surfaces 214 may have different shapes that match and mate with an outer surface of a respective tooth.

The structure 6800 can be 3D printed onto a base plate. For example, the structure 6800 can include support structures directly in contact with the base plate, and can be used to form and 3D print the base 6802 and the brackets 105. The base plate can extend along a first plane that can be a horizontal plane. The structure 6800 can be at least partially located on and extend along a second plane perpendicular to the first plane such that the structure 6800 is formed vertically relative to the base plate. For example, the structure 6800 can be 3D printed along the second plane and moving away from the base plate.

In some implementations, the support structures to support formation of at least the brackets 105 can extend at least partially at an angle relative to the base plate. For example, the support structure can extend partially along the second plane and prior to the 3D printer depositing metallic material to form the brackets 105, at least one of the support structures or the base 6802 can extend at an angle relative to the second plane. In some implementations, the structure 6800 can be formed at least partially parallel to the base plate. For example, the support structures can extend along the second plane, and the structure 6800 can be formed along a third plane parallel to and offset from the first plane. In some implementations, the structure 6800 can include support structures directly in contact with an entirety of the second surface 214 and a plurality of support structures directly in contact and supporting the first surface 212 without contacting an entirety of the first surface 212.

The first surface 6804 can define a plurality of recesses. The recesses can extend towards the second surface 6806 without contacting the second surface 6806. Each of the recesses can extend along a respective recess axes which can be parallel and offset from each other. For example, a first recess extends along or is otherwise centered on a first recess axis and a second recess extends along or is otherwise centered on a second recess axis. Each of the brackets 105 while coupled to the base 6802 can extend along a respective bracket axes which can be parallel and offset from each other. For example, a first bracket 105 extends along or is otherwise centered on a first bracket axis and a second bracket 105 extends along or is otherwise centered on a second bracket axis that is parallel to and offset from the first bracket axis. The respective recess axes can be parallel to and offset from the bracket axes. The recess axes can extend between the bracket axes such that the recesses are defined on the first surface 6804 between positions at which the brackets 105 extend from the second surface 6806. In some implementations, in response to the recess being centered on a respective recess axis, the recess axis is equidistant from adjacent bracket axes such that the recess is defined on the first surface 6804 at a position at a midpoint between adjacent brackets 105.

The first surface 6804 defining the recesses facilitates bending of the structure 6800. For example, after completion of the formation of the structure 6800 via metallic material 3D printing, the structure 6800 can be bent along a length of the structure 6800 via at least the recesses. The recesses create weak points along the structure 6800 such that the structure 6800 can be bent at least at the recesses thereby forming a curved shape. In some implementations, the structure 6800 is bent without the recesses. The structure 6800 being bent can allow for a greater surface area of the structure 6800 to be polished compared to the structure 6800 remaining unbent. For example, bending the structure 6800 can increase the surface area of the structure 6800 exposed during a polishing process, such as, but not limited to, tumbling. The greater surface area of the structure 6800 being polished while bent compared to unbent can improve smoothing and deburring, increase polishing efficiency, and improve surface quality of the brackets 105. In some implementations, the structure 6800 can include a plurality of structures 6800, and each of the structures 6800 can be bent prior to being polished. The structures 6800 can be polished together in a batch, such as within a tumbler.

To facilitate polishing multiple structures 6800 within one system, such as a tumbler, the structure 6800 can include one or more indicators. The base 6802 can include a first end and a second end opposite the first end. The structure 6800 can include a first indicator located (e.g., engraved, disposed, etc.) on the first end that indicates a row and side of teeth the brackets 105 coupled to the base 6802 of the respective structure 6800 are to couple to. The structure 6800 can include a second indicator located on the second end that indicates the patient. For example, the second indicator can indicate the patient whose data was used to form the structure 6800, and thus the teeth that the brackets 105 were formed for and are to couple to. The first indicator and the second indicator can differentiate the structure 6800 from other structures 6800, such as following polishing, and can facilitate coupling of the brackets 105 to the teeth of the respective patient as well.

The brackets 105 can be removed from the base 6802 following polishing. For example, the structure 6800 can be removed from the base plate via at least one of wire electrical discharge machining (EDM), bandsaw, milling, or any other process, and the brackets 105 can be removed from the support structures and the base 6802 via at least one of grinding, pliers, rotary tools, or any other tools. In some implementations, the first surface 212, the second surface 214, and other outer surfaces of the brackets 105 can be further polished, ground, electropolished, or otherwise machined. In some implementations, a coating can be applied to the brackets 105 following removal from the base 6802. Following removal from the base 6802, the brackets 105 can be coupled to teeth of the patient via an adhesive such as a light-cured adhesive, composite resin adhesive, or any other bio-compatible adhesive. The grooves 226 can facilitate and improve attachment of the brackets 105 to the teeth.

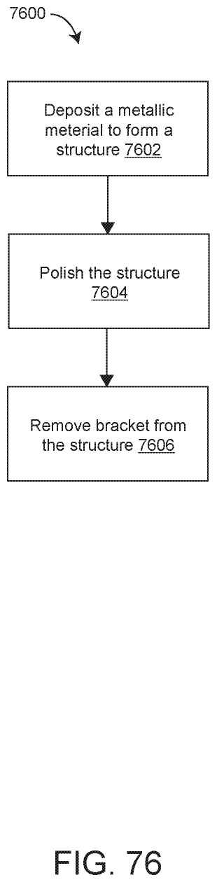

FIG. 76 is a flow diagram showing a method 7600 for forming brackets using a 3D printer. The method 7600 includes, at block 7602, depositing, using a 3D printer, a metallic material to form a structure (e.g., structure 6800) including a base (e.g., base 6802) having a first surface and a second surface opposite the first surface) and a bracket (e.g., bracket 105) removably coupled to the second surface, the plurality of brackets having a first surface and a second surface opposite the first surface, the second surface having a shape that matches an outer surface of a respective tooth of a patient. The structure can be formed according to data received associated with a patient, such as a 3D scan of the teeth of the patient.

In some implementations, the base has a first end and a second end opposite the first end, the structure including a first indicator located on the first end indicating a row and side of teeth the plurality of brackets are to couple to and a second indicator located on the second end indicating the patient.

The method 7600 includes, at block 7604, polishing the structure. In some implementations, the structure includes a plurality of structures, and the method can include polishing the plurality of structures after bending the plurality of structures. The method 7600 includes, at block 7606, removing the bracket from the structure.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically matable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

References herein to the positions of elements (e.g., “top,” “bottom,” “above,” “below”) are merely used to describe the orientation of various elements in the FIGURES. It should be noted that the orientation of various elements may differ according to other example arrangements, and that such variations are intended to be encompassed by the present disclosure.

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

What is claimed is:

1. A system, comprising:
at least one bracket comprising a first surface and a second surface opposite the first surface, the second surface to be directly coupled to at least one tooth of a patient, the second surface having a shape matching an outer surface of the at least one tooth of the patient, wherein the at least one bracket is formed from a metallic material via additive manufacturing;
a wire extending along a plane, the wire to directly couple to the at least one bracket along the first surface, wherein a portion of the wire in direct contact with the at least one bracket has a first thickness in a first direction along the plane corresponding to a force applied by the wire onto the at least one tooth to align the at least one tooth with the wire, wherein other portions of the wire have thicknesses different from the first thickness; and
at least one treatment member coupled to and continuous with the wire and extending along the plane, wherein the wire and the at least one treatment member have a same thickness in a second direction perpendicular to the plane.

2. The system of claim 1, wherein the outer surface is at least one of a labial or lingual side of the at least one tooth.

3. The system of claim 1, wherein the wire is a first wire to couple to the at least one bracket coupled to at least one upper tooth on an upper row of teeth of the patient, the plane is a first plane, and the at least one treatment member is at least one first treatment member, the system further comprising:
a second wire extending along a second plane, the second wire to directly couple to the at least one bracket coupled to at least one lower tooth on a lower row of teeth of the patient; and
at least one second treatment member coupled to and continuous with the second wire and extending along the second plane, wherein the second wire and the at least one second treatment member have a same thickness in a third direction perpendicular to the second plane,
wherein the at least one first treatment member comprises at least one first tab extending from the first wire and the at least one second treatment member comprises at least two second tabs extending from the second wire.

4. The system of claim 3, further comprising:
a first indicator coupled to and extending from a first side of the first wire; and
a second indicator coupled to and extending from a second side of the second wire, wherein the first side and the second side are aligned.

5. The system of claim 1, wherein the wire comprises a first end and a second end opposite the first end, the system further comprising an identifier removably coupled to the second end, the identifier extending along the plane and having a same thickness as the wire and the at least one treatment member in the second direction perpendicular to the plane.

6. The system of claim 1, wherein the at least one bracket comprises a third surface contiguous with the first surface and the second surface, the third surface at least partially facing a distal surface of the at least one tooth and gingiva, the at least one bracket comprising a label corresponding to the at least one tooth located on the third surface.

7. The system of claim 1, wherein the wire continues to extend along the plane prior to and after being coupled to the at least one bracket.

8. The system of claim 1, wherein the at least one bracket is a plurality of brackets and the at least one tooth is a plurality of teeth, the plurality of brackets to couple to at least a subset of the plurality of teeth, wherein the wire includes a plurality of thicknesses in the first direction, each of the thicknesses corresponding to a respective force to align at least the subset of the plurality of teeth with the wire.

9. The system of claim 1, wherein the wire and the at least one treatment member are a monolithic apparatus.

10. The system of claim 1, wherein the second surface defines a plurality of grooves.

11. A system, comprising:
a plurality of brackets each comprising a first surface and a second surface opposite the first surface, the second surface to be directly coupled to a respective tooth of a plurality of teeth of a patient, the second surface having a shape matching an outer surface of the respective tooth of the patient, wherein the plurality of brackets are formed from a metallic material;
a wire extending along a plane, the wire to directly couple to at least a subset of the plurality of brackets along the first surface, the wire having a same thickness in a direction perpendicular to the plane,
wherein the wire comprises a first thickness in a first direction along the plane at a first location corresponding to a first tooth of the plurality of teeth and a second thickness in the direction along the plane at a second location corresponding to a second tooth of the plurality of teeth, the first thickness corresponding to a first force to align the first tooth with the wire and the second thickness corresponding to a second force to align the second tooth with the wire, the first thickness and the second thickness being different.

12. The system of claim 11, further comprising:
at least one treatment member coupled to and continuous with the wire and extending along the plane, wherein the wire and the at least one treatment member have the same thickness in a second direction perpendicular to the plane.

13. The system of claim 12, wherein the wire comprises a first end and a second end opposite the first end, the system further comprising an identifier removably coupled to the second end, the identifier extending along the plane and having a same thickness as the wire and the at least one treatment member in the second direction perpendicular to the plane.

14. The system of claim 11, wherein the plurality of brackets are formed via additive manufacturing and the outer surface is at least one of a labial or lingual side of the respective tooth.

15. The system of claim 11, wherein the wire continues to extend along the plane prior to and after being coupled to at least the subset of the plurality of brackets.

16. The system of claim 11, wherein the second surface defines a plurality of grooves.

17. The system of claim 11, wherein each of the plurality of brackets comprises a third surface contiguous with the first surface and the second surface, the third surface at least partially facing a distal surface of the respective tooth and gingiva, each of the plurality of brackets comprising a label corresponding to the respective tooth located on the third surface.

18. A method, comprising:
depositing, using a three-dimensional (3D) printer, a metallic material to form a structure comprising:
a base having a first surface and a second surface opposite the first surface; and
a bracket removably coupled to the second surface, the bracket having a first surface and a second surface opposite the first surface, the second surface having a shape that matches an outer surface of a respective tooth of a patient;
bending the structure;
polishing the structure; and
removing the bracket from the structure.

19. The method of claim 18, wherein the base has a first end and a second end opposite the first end, the structure comprising a first indicator located on the first end indicating a row and side of teeth the bracket is to couple to and a second indicator located on the second end indicating the patient.

20. The method of claim 18, wherein the structure comprises a plurality of structures, the method further comprising polishing the plurality of structures after bending the plurality of structures.
